(19) United States
(12) Patent Application Publication
(10) Pub. No.: US 2018/0361327 A1
(43) Pub. Date: Dec. 20, 2018

(54) GAS SEPARATION MEMBRANE, GAS SEPARATION MODULE, GAS SEPARATOR, GAS SEPARATION METHOD, COMPOSITION FOR FORMING GAS SEPARATION LAYER, METHOD OF PRODUCING GAS SEPARATION MEMBRANE, POLYIMIDE COMPOUND, AND DIAMINE MONOMER

(71) Applicant: FUJIFILM Corporation, Tokyo (JP)

(72) Inventors: Keisuke KODAMA, Kanagawa (JP); Makoto SAWADA, Kanagawa (JP); Kenji WADA, Kanagawa (JP)

(73) Assignee: FUJIFILM Corporation, Tokyo (JP)

(21) Appl. No.: 16/109,681

(22) Filed: Aug. 22, 2018

Related U.S. Application Data
(63) Continuation of application No. PCT/JP2016/079205, filed on Oct. 3, 2016.

(30) Foreign Application Priority Data
Feb. 26, 2016 (JP) 2016-036423

(51) Int. Cl. B01D 71/64; C08L 79/08

(52) U.S. Cl. CPC B01D 71/64; C08L 79/08; B01D 53/229; B01D 2257/504; B01D 2256/245

(57) ABSTRACT

A gas separation membrane including a gas separation layer contains a crosslinked polyimide compound. In the gas separation membrane, and a gas separation module, a gas separator, and a gas separation method obtained by using the gas separation membrane, the crosslinked polyimide compound has a specific structural portion. A composition for forming a gas separation layer suitable for forming a gas separation layer of the gas separation membrane; a method of producing a gas separation membrane obtained by using this composition; a polyimide compound suitable as a raw material of a gas separation layer of the gas separation membrane; and a diamine monomer suitable for synthesis of this polyimide compound are provided.

### CROSS-REFERENCE TO RELATED APPLICATIONS

This application is a Continuation of PCT International Application No. PCT/JP2016/079205, filed on Oct. 3, 2016, which claims priority under 35 U.S.C. § 119(a) to Japanese Patent Application No. 2016-036423, filed on Feb. 26, 2016. Each of the above application(s) is hereby expressly incorporated by reference, in its entirety, into the present application.

### BACKGROUND OF THE INVENTION

### 1. Field of the Invention

The present invention relates to a gas separation membrane and a gas separation module, a gas separator, and a gas separation method obtained by using this gas separation membrane. Further, the present invention relates to a composition for forming a gas separation layer suitable for forming a gas separation layer of a gas separation membrane and a method of producing a gas separation membrane using this composition. Further, the present invention relates to a polyimide compound suitable as a raw material of the gas separation layer of the gas separation membrane. Further, the present invention relates to a diamine monomer used for synthesis of the polyimide compound.

### 2. Description of the Related Art

A material formed of a polymer compound has a gas permeability specific to the material. Based on this property, it is possible to cause selective permeation and separation out of a target gas component using a membrane formed of a specific polymer compound. As an industrial application for this gas separation membrane related to the problem of global warming, separation and recovery of carbon dioxide from large-scale carbon dioxide sources using this gas separation membrane has been examined in thermal power plants, cement plants, or ironworks blast furnaces. Further, this membrane separation technique has been attracting attention as means for solving environmental issues which can be performed with relatively little energy. In addition, natural gas or biogas (gas generated due to fermentation or anaerobic digestion, for example, biological excrement, organic fertilizers, biodegradable substances, sewage, garbage, or energy crops) is a mixed gas mainly containing methane and carbon dioxide, and a membrane separation method has been examined as means for removing impurities such as carbon dioxide and the like.

In purification of natural gas using a membrane separation method, excellent gas permeability and gas separation selectivity are required in order to more efficiently separate gas. Various membrane materials have been examined for the purpose of realizing excellent gas permeability and gas separation selectivity, and a gas separation membrane obtained by using a polyimide compound has been examined as part of examination of membrane materials. For example, JP1991-127616A (JP-H03-127616A) describes separation of oxygen from nitrogen using a crosslinked polyimide film formed by crosslinking a polyimide compound obtained by introducing an allyl group into a diamine component.

### SUMMARY OF THE INVENTION

In order to obtain a practical gas separation membrane, it is necessary to ensure sufficient gas permeability and to realize improved gas separation selectivity. However, gas permeability and gas separation selectivity have a so-called trade-off relationship. Therefore, by adjusting a copolymerization component of a polyimide compound used for a gas separation layer, any of the gas permeability and the gas separation selectivity of the gas separation layer can be improved, but it is considered to be difficult to achieve both properties at high levels.

Further, in an actual plant, a membrane is plasticized due to the influence of impurity components (such as benzene, toluene, and xylene) present in natural gas and this results in a problem of degradation in gas separation selectivity. Accordingly, a gas separation membrane is also required to have plasticity resistance that enables desired gas separation selectivity to be maintained and exhibited in the presence of the impurity components.

However, a polyimide compound typically has degraded plasticity resistance, and the gas separation performance thereof is likely to be degraded in the coexistence of impurity components such as toluene. Particularly in a case where a polyimide compound having a high gas permeability is used for a gas separation layer, the gas separation layer is easily affected by the impurity components, and thus swelling of the gas separation layer is promoted. Therefore, in the gas separation layer obtained by using a polyimide compound, it is difficult to achieve both of the gas permeability and the plasticity resistance at desired levels.

An object of the present invention is to provide a gas separation membrane which is capable of achieving both of excellent gas permeability and excellent gas separation selectivity at high levels and enables gas separation with a high speed and high selectivity even in a case of being used under a high pressure condition. Further, an object of the present invention is to provide a gas separation membrane which is capable of satisfactorily maintaining gas separation performance even in a case of being brought into contact with impurity components such as toluene. Further, an object of the present invention is to provide a gas separation module, a gas separator, and a gas separation method obtained by using the gas separation membrane. Further, an object of the present invention is to provide a composition for forming a gas separation layer suitable for forming a gas separation layer of the gas separation membrane and a method of producing a gas separation membrane obtained by using this composition. Further, an object of the present invention is to provide a polyimide compound suitable as a raw material of a gas separation layer of the gas separation membrane and a diamine monomer used for synthesis of this polyimide compound.

As the result of intensive examination repeatedly conducted by the present inventors in consideration of the above-described problems, it was found that reaction efficiency is excellent and a crosslinked structure can be introduced at a higher density in a case where a polyimide compound into which a styrene structure has been introduced is allowed to react with a crosslinking agent having a specific structure and containing a group reactive with an ethylenically unsaturated bond in the styrene structure. Further, it was found that a gas separation membrane formed by using a crosslinked polyimide compound, obtained by performing the above-described reaction, for a gas separation layer exhibits excellent gas permeability and also exhibits excellent gas separation selectivity. Further, it was found that this gas separation membrane is unlikely to be affected by impurity components such as toluene and has excellent plasticity resistance. The present invention has been completed after repeated examination based on these findings.

In other words, the above-described problems are solved by the following means.

[1] A gas separation membrane comprising: a gas separation layer which contains a crosslinked polyimide compound, in which the crosslinked polyimide compound has a structural portion represented by Formula (I),

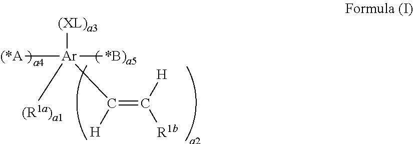

in Formula (I), Ar represents an aromatic ring or a structure formed by two or more aromatic rings being linked through a single bond or a divalent group,

R^{1a} represents a substituent other than —CH═CHR^{1b}, a1 represents an integer of 0 to 20, R^{1b} represents a hydrogen atom or a substituent, a2 represents an integer of 0 to 20, R^{1a} and —CH═CHR^{1b} are directly bonded to a ring-constituting atom of an aromatic ring in Ar,

*A and *B represent a linking site for being incorporated in a polyimide chain constituting the crosslinked polyimide compound, a4 represents an integer of 0 to 2, a5 represents 1 or 2, and

XL represents a crosslinked structure that links polyimide chains represented by Formula (I-a) or (I-b) to one another, a3 represents an integer of 1 to 20, and XL is directly bonded to a ring-constituting atom of an aromatic ring in Ar,

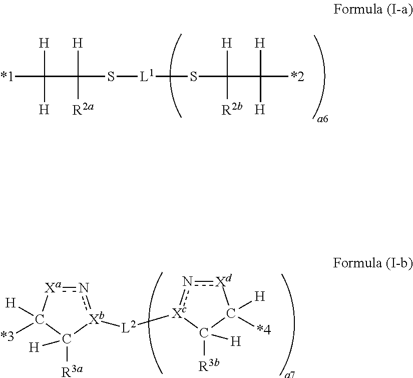

in Formula (I-a), R^{2a} and R^{2b} represent a hydrogen atom, a substituent, or a polyimide residue,

L¹ represents an (a6+1)-valent linking group, a6 represents an integer of 1 or greater, and *1 and *2 represent a site directly bonded to a ring-constituting atom of an aromatic ring in Ar represented by Formula (I), and

in Formula (I-b), R^{3a} and R^{3b} represent a hydrogen atom, a substituent, or a polyimide residue, L² represents an (a7+1)-valent linking group, a7 represents an integer of 1 or greater, X^{a} and X^{d} represent O or N, X^{b} and X^{c} represent N or C, and *3 and *4 represent a site directly bonded to a ring-constituting atom of an aromatic ring in Ar represented by Formula (I).

[2] The gas separation membrane according to [1], in which the polyimide chain constituting the crosslinked polyimide compound has a repeating unit represented by Formula (II),

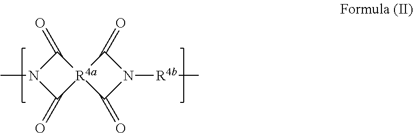

in Formula (II), R^{4a} represents a tetravalent linking group, and R^{4b} represents a divalent linking group, where R^{4a} and/or R^{4b} has a structural portion represented by Formula (I).

[3] The gas separation membrane according to [2], in which both of a4 and a5 in Formula (I) represent 1, and the structural portion represented by Formula (I) is present as R^{4b} in Formula (II).

[4] The gas separation membrane according to [2] or [3], in which R^{4a} in Formula (II) is represented by any of Formulae (I-1) to (I-28),

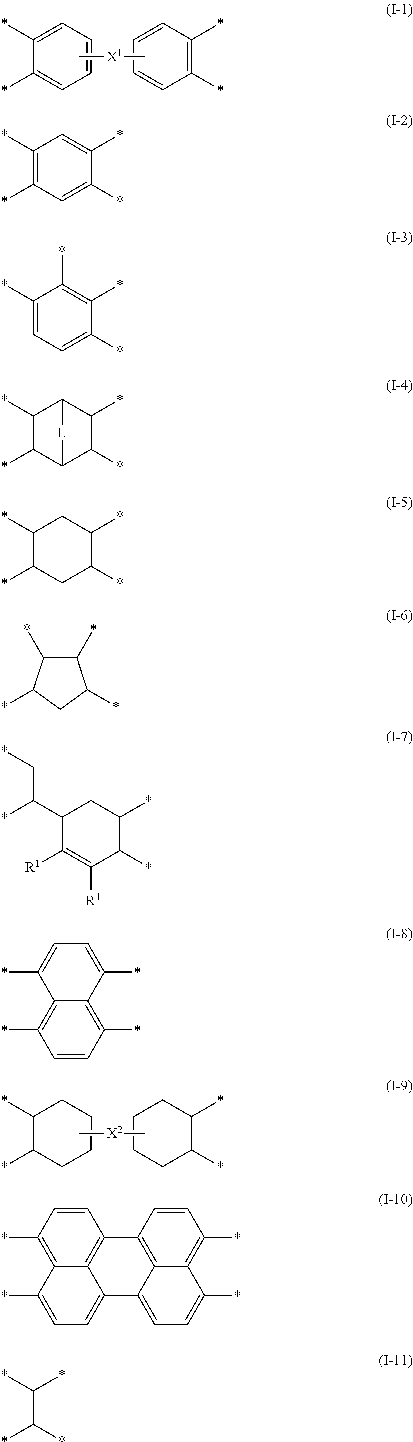

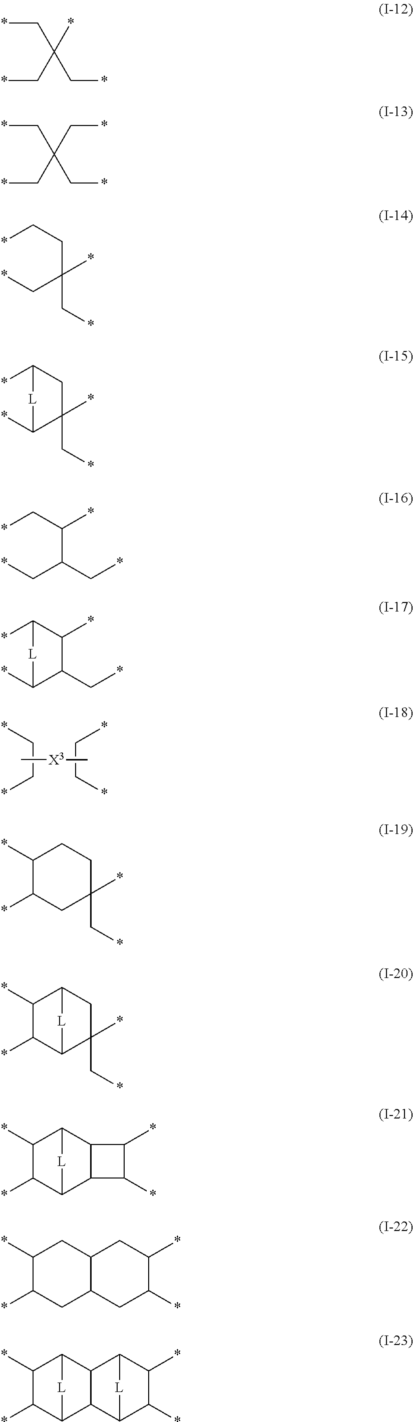

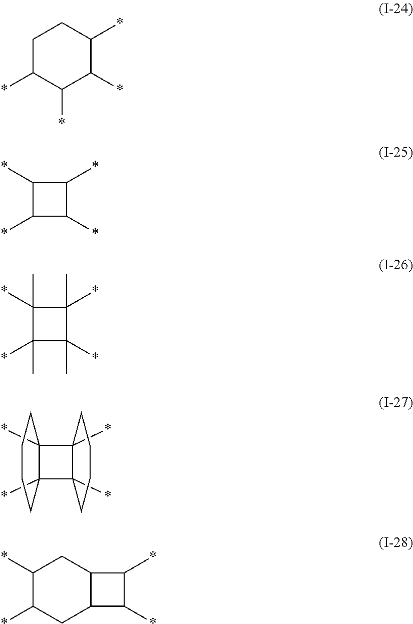

X¹ to X³ represent a single bond or a divalent linking group, L represents —CH═CH— or —CH₂—, R¹ and R² represent a hydrogen atom or a substituent that does not have an ethylenically unsaturated bond, and * represents a bonding site with respect to a carbonyl group in Formula (II).

[5] The gas separation membrane according to any one of [1] to [4], in which Ar in Formula (I) represents a benzene ring or a structure formed by two benzene rings being linked through a single bond or a divalent group.

[6] The gas separation membrane according to any one of [1] to [5], in which a density of a crosslinking point in the crosslinked polyimide compound is 0.5 mmol/g or greater.

[7] The gas separation membrane according to any one of [1] to [6], in which a toluene swelling ratio of the crosslinked polyimide compound is 35% or less.

[8] The gas separation membrane according to any one of [1] to [7], in which the gas separation membrane is a gas separation composite membrane which includes a support layer having a gas permeability and the gas separation layer provided on the support layer.

[9] The gas separation membrane according to [8], in which the support layer includes a porous layer and a non-woven fabric layer, and the gas separation layer, the porous layer, and the non-woven fabric layer are provided in this order.

[10] The gas separation membrane according to any one of [1] to [9], in which carbon dioxide is allowed to permeate from gas containing carbon dioxide and methane.

[11] A gas separation module comprising: the gas separation membrane according to any one of [1] to [10].

[12] A gas separator comprising: the gas separation module according to [11].

[13] A gas separation method which is performed by using the gas separation membrane according to any one of [1] to [10].

[14] A composition for forming a gas separation layer which is formed by containing (A) and (B) shown below, the composition comprising: a polyimide compound (A) which has a structural portion represented by Formula (III),

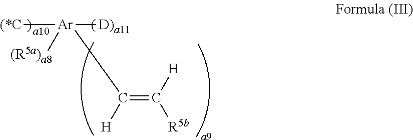

in Formula (III), Ar represents an aromatic ring or a structure formed by two or more aromatic rings being linked through a single bond or a divalent group,

R^{5a} represents a substituent other than —CH═CHR^{5b}, a8 represents an integer of 0 to 20, R^{5b} represents a hydrogen atom, a substituent, or a linking site for being incorporated in a polyimide compound, a9 represents an integer of 1 to 20, R^{5a} and —CH═CHR^{5b} are directly bonded to a ring-constituting atom of an aromatic ring in Ar,

*C and *D represent a linking site for being incorporated in a polyimide compound, a10 represents an integer of 0 to 2, and a11 represents 1 or 2; and

a crosslinking agent (B) which contains two or more groups selected from a mercapto group, a nitrile N oxide group, and an azide group, in a molecule.

[15] The composition for forming a gas separation layer according to [14], in which the polyimide compound has a repeating unit represented by Formula (IV),

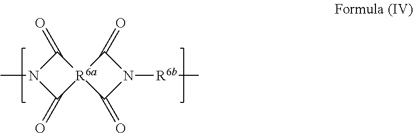

in Formula (IV), R^{6a} represents a tetravalent linking group, and R^{6b} represents a divalent linking group, where R^{6a} and/or R^{6b} has a structural portion represented by Formula (III).

[16] The composition for forming a gas separation layer according to [15], in which both of a10 and a11 in Formula (III) represent 1, R^{5b} represents a hydrogen atom or a substituent, and the structural portion represented by Formula (III) is present as R^{6b} in Formula (IV).

[17] The composition for forming a gas separation layer according to [15] or [16], in which R^{6a} in formula (IV) is represented by any of Formulae (I-1) to (I-28),

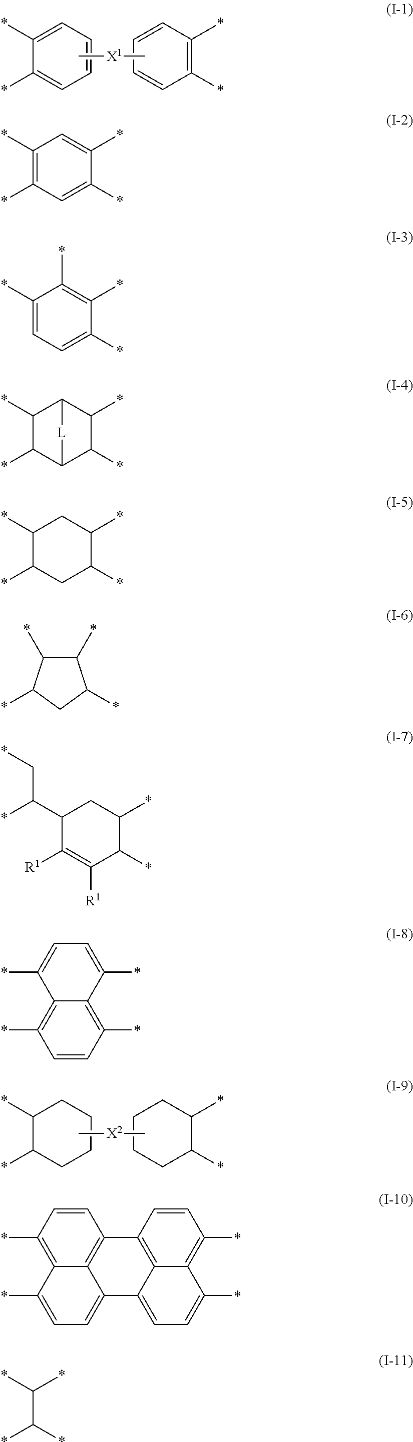

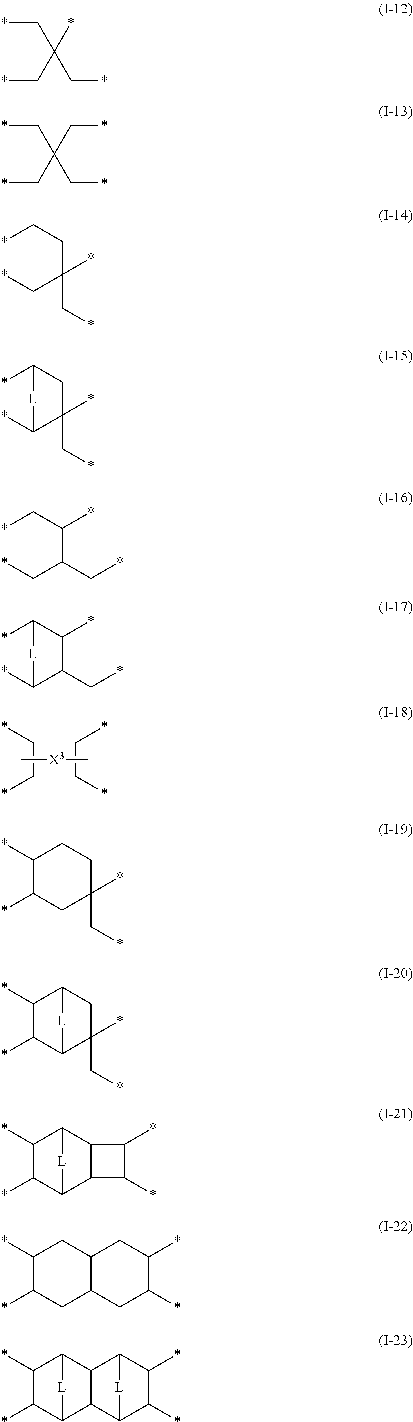

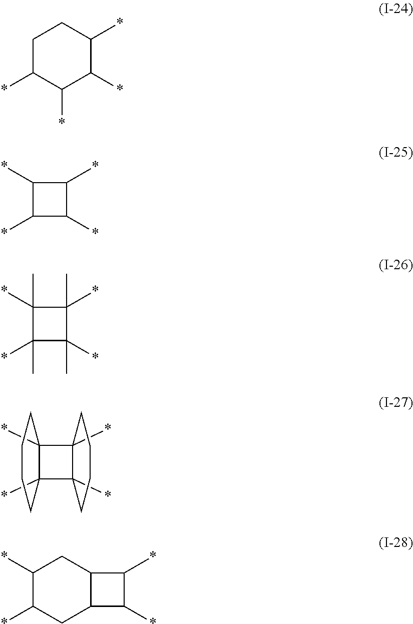

X¹ to X³ represent a single bond or a divalent linking group, L represents —CH═CH— or —CH₂—, R¹ and R² represent a hydrogen atom or a substituent that does not have an ethylenically unsaturated bond, and * represents a bonding site with respect to a carbonyl group in Formula (IV).

[18] The composition for forming a gas separation layer according to any one of [14] to [17], in which the crosslinking agent is at least one compound represented by Formulae (V) to (VII),

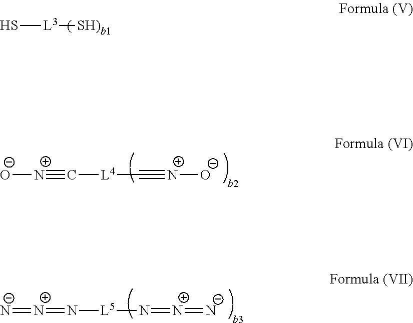

in Formulae (V) to (VII), L³ represents a (b1+1)-valent linking group, L⁴ represents a (b2+1)-valent linking group, L⁵ represents a (b3+1)-valent linking group, and b1 to b3 represent an integer of 1 or greater.

[19] A method of producing a gas separation membrane comprising: applying the composition for forming a gas separation layer according to any one of [14] to [18] to form a membrane; and performing a heat treatment, irradiation with ultraviolet rays, a plasma treatment, an ozone treatment, or a corona treatment on the composition for forming a gas separation layer which has been applied to the coated membrane to form a crosslinked structure.

[20] A polyimide compound comprising: a repeating unit represented by Formula (VIII),

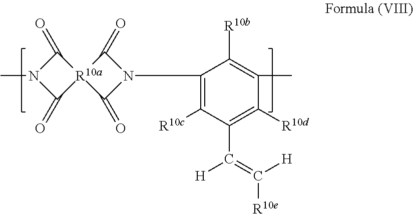

in Formula (VIII), R^{10b}, R^{10c}, and R^{10d} represent a substituent other than —CH═CHR^{10e}, R^{10e} represents a hydrogen atom or a substituent, and

R^{10a} represents a tetravalent group represented by any of Formulae (I-1) to (I-28).

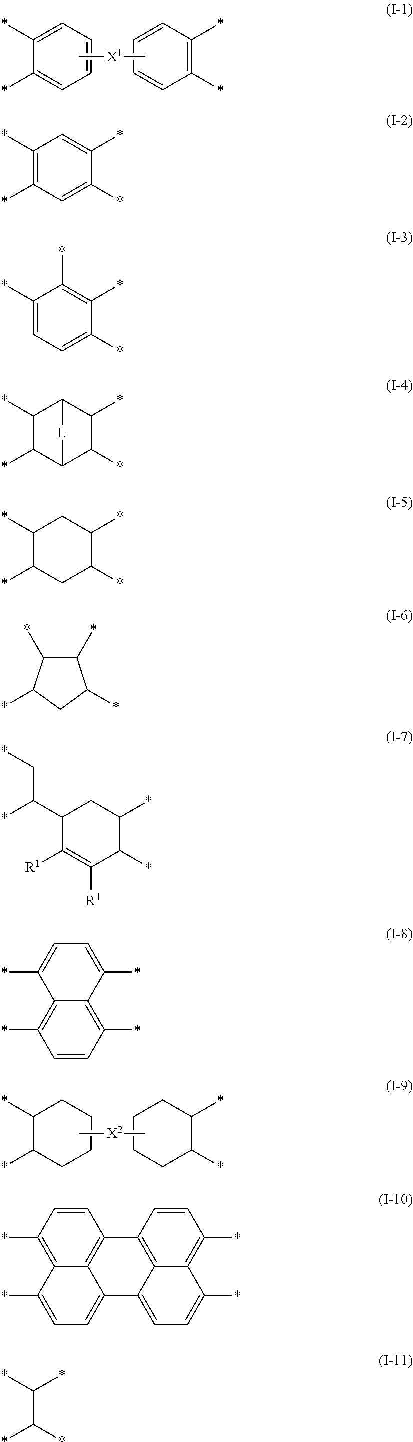

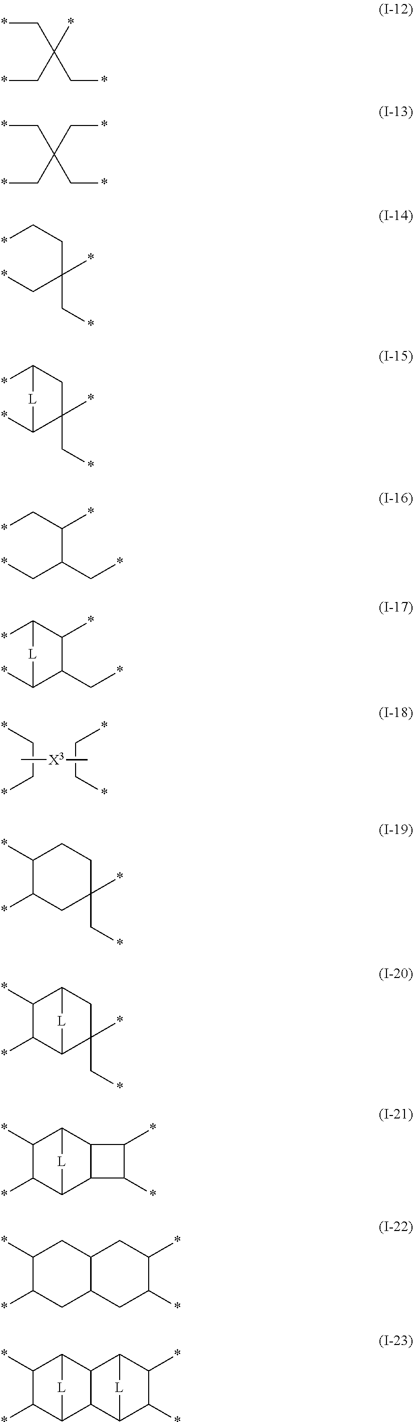

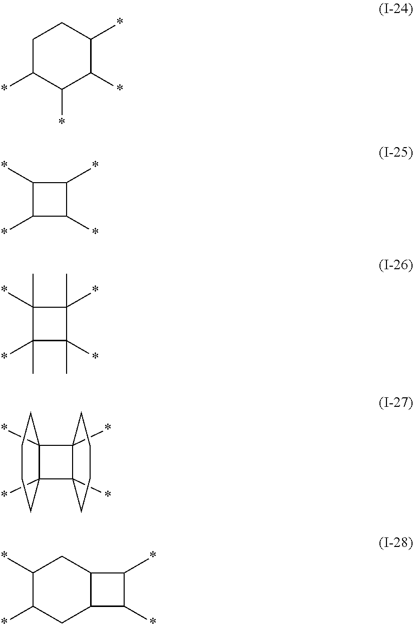

X¹ to X³ represent a single bond or a divalent linking group, L represents —CH═CH— or —CH₂—, R¹ and R² represent a hydrogen atom or a substituent that does not have an ethylenically unsaturated bond, and * represents a bonding site with respect to a carbonyl group in Formula (VIII).

[21] A polyimide compound comprising: a structural unit represented by Formula (IX),

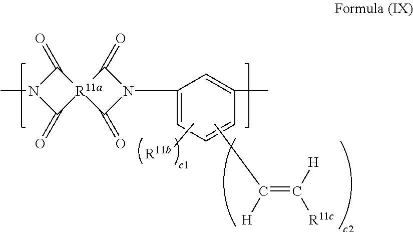

in Formula (IX), R^{11b} represents a substituent other than —CH═CHR^{11c},

R^{11c} represents a hydrogen atom or a substituent,

c1 represents an integer of 0 to 2, and c2 represents 2 or 3, where the total value of c1 and c2 is an integer of 2 to 4, and

R^{11a} represents a tetravalent group represented by any of Formulae (I-1) to (I-28),

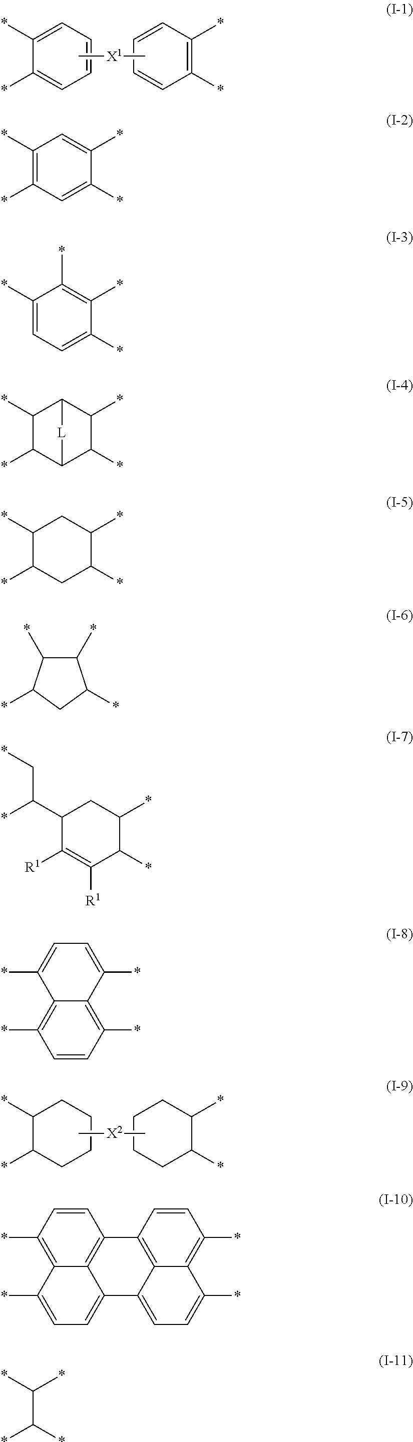

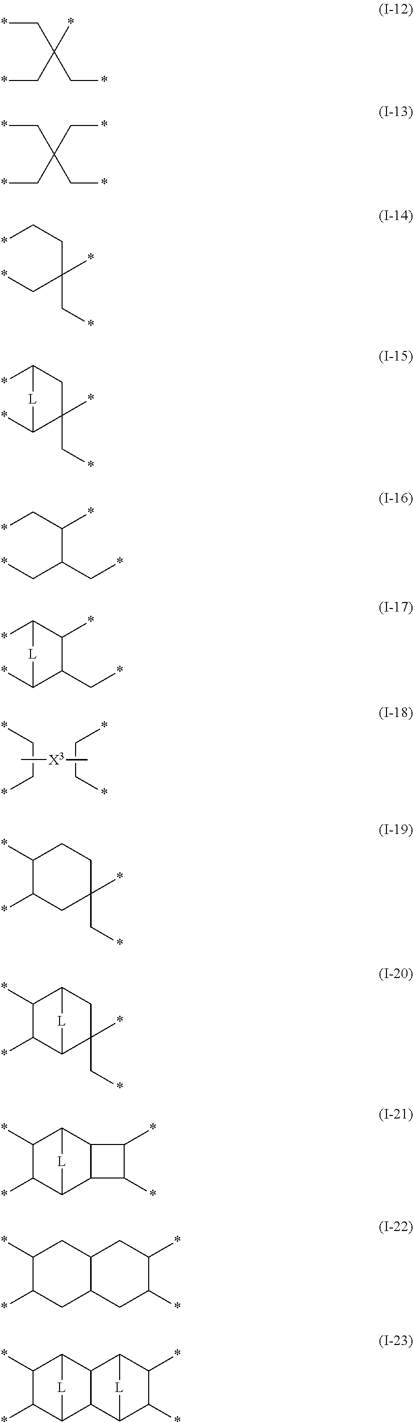

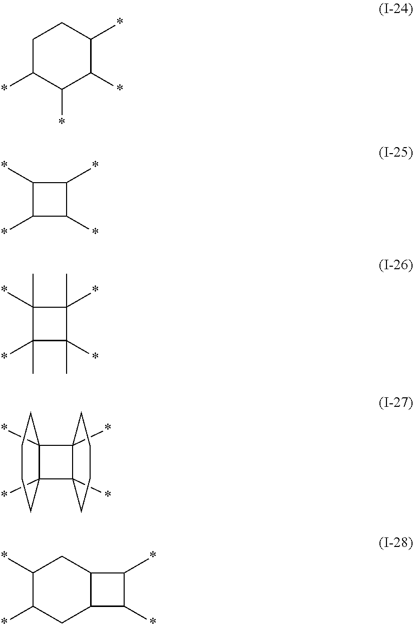

X¹ to X³ represent a single bond or a divalent linking group, L represents —CH═CH— or —CH₂—, R¹ and R² represent a hydrogen atom or a substituent that does not have an ethylenically unsaturated bond, and * represents a bonding site with respect to a carbonyl group in Formula (IX).

[22] A crosslinkable diamine monomer which is represented by Formula (X),

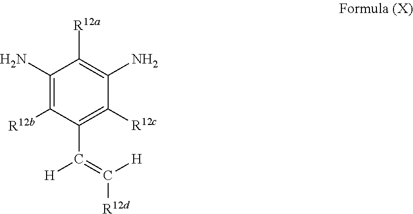

in Formula (X), R^{12a}, R^{12b}, and R^{12c} represent a substituent other than —CH═CHR^{12d} and R^{12d} represents a hydrogen atom or a substituent.

[23] A crosslinkable diamine monomer which is represented by Formula (XI),

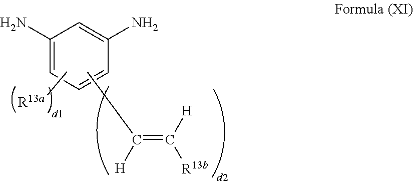

in Formula (XI), R^{13a} represents a substituent other than —CH═CHR^{13b}, R^{13b} represents a hydrogen atom or a substituent, d1 represents an integer of 0 to 2, and d2 represents 2 or 3, where the total value of d1 and d2 is an integer of 2 to 4.

The numerical ranges shown using “to” in the present specification indicate ranges including the numerical values described before and after “to” as the lower limits and the upper limits.

In the present specification, in a case where a plurality of substituents or linking groups (hereinafter, referred to as substituents or the like) shown by specific symbols are present or a plurality of substituents are defined simultaneously or alternatively, this means that the respective substituents may be the same as or different from each other. The same applies to the definition of the number of substituents or the like. Moreover, in a case where there is a repetition of a plurality of partial structures shown by means of the same display in the formula, the respective partial structures or repeating units may be the same as or different from each other.

In regard to compounds or groups described in the present specification, the description includes salts thereof and ions thereof in addition to the compounds or the groups. Further, the description includes those obtained by changing a part of the structure thereof within the range in which the effects of the purpose are exhibited.

A substituent (the same applies to a linking group) in which substitution or unsubstitution is not specified in the present specification may include an optional substituent of the group within a range in which desired effects are exhibited. The same applies to a compound in which substitution or unsubstitution is not specified.

A preferable range of a substituent group Z described below is set as a preferable range of a substituent in the present specification unless otherwise specified.

In the present specification, the term “styrene structure” is used in a broader sense than usual. In other words, the concept of the “styrene structure” in the present specification includes the form formed by two or more —CH═CHR^{ST} (R^{ST} represents a hydrogen atom or a substituent) being directly bonded to a ring-constituting atom of a benzene ring and the form formed by one or two or more —CH═CHR^{ST} being directly bonded to a ring-constituting atom of an aromatic ring other than a benzene ring in addition to the form formed by one —CH═CHR^{ST} being directly bonded to a ring-constituting atom of a benzene ring.

The gas separation membrane, the gas separation module, the gas separator, and the gas separation method of the present invention enable achievement both of excellent gas permeability and excellent gas separation selectivity at high levels, enable gas separation with a high speed and high selectivity even in a case of being used under a high pressure condition, and enable satisfactory maintenance of gas separation performance even in a case of being brought into contact with impurity components such as toluene.

The composition for forming a gas separation layer of the present invention and the method of producing a gas separation membrane obtained by using this composition are suitable for preparing the gas separation membrane of the present invention. Further, the polyimide compound of the present invention is suitable as a raw material of the gas separation layer of the gas separation membrane of the present invention. Further, the diamine monomer of the present invention is used as a raw material for synthesizing the polyimide compound of the present invention.

### BRIEF DESCRIPTION OF THE DRAWINGS

FIG. 1 is a diagram showing the result of 1H NMR (deuterated solvent: DMSO-d6) of a diamine 1 in a synthesis example of an example.

FIG. 2 is a diagram showing the result of 1H NMR (deuterated solvent: DMSO-d6) of a polyimide P-101 in a synthesis example of an example.

FIG. 3 is a diagram showing the result of 1H NMR (deuterated solvent: DMSO-d6) of a diamine 2 in a synthesis example of an example.

FIG. 4 is a diagram showing the result of 1H NMR (deuterated solvent: DMSO-d6) of a polyimide P-201 in a synthesis example of an example.

FIG. 5 is a diagram showing the result of 1H NMR (deuterated solvent: DMSO-d6) of a diamine 3 in a synthesis example of an example.

FIG. 6 is a cross-sectional view schematically illustrating an embodiment of a gas separation composite membrane of the present invention.

FIG. 7 is a cross-sectional view schematically illustrating another embodiment of a gas separation composite membrane of the present invention.

### DESCRIPTION OF THE PREFERRED EMBODIMENTS

Hereinafter, preferred embodiments of the present invention will be described.

In a gas separation membrane of the present invention, a gas separation layer thereof contains a crosslinked polyimide compound formed by crosslinking a polyimide compound and the crosslinked polyimide compound has a specific structural portion.

[Crosslinked Polyimide Compound]

The crosslinked polyimide compound used in the present invention has a structural portion represented by Formula (I) in the structure thereof.

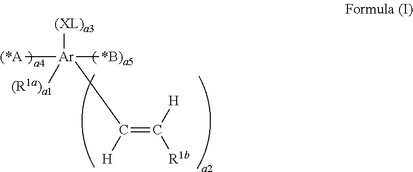

In Formula (I), Ar represents an aromatic ring or a structure formed by two or more aromatic rings being linked through a single bond or a divalent group.

In a case where Ar represents an aromatic ring, the aromatic ring may be an aromatic hydrocarbon ring or an aromatic heterocycle. Further, the aromatic ring may be a monocycle or a fused ring. In the case where Ar represents an aromatic ring, it is more preferable that the aromatic ring is a monocycle (preferably a 5-membered ring or a 6-membered ring). Examples of the aromatic ring as Ar include a benzene ring, a naphthalene ring, an anthracene ring, a fluorene ring, an indene ring, an indane ring, a triptycene ring, a xanthene ring, a furan ring, a thiophene ring, a pyrrole ring, a pyrazole ring, an imidazole ring, a pyridine ring, and a pyrimidine ring. Among these, a benzene ring, a fluorene ring, or a xanthene ring is preferable, and a benzene ring is more preferable.

The structural portion represented by Formula (I) indicates a residue obtained by removing y hydrogen atoms from the compound represented by Formula (I), and y represents an integer of preferably 1 to 10 and more preferably 1 to 4.

In a case where Ar represents a structure formed by two or more aromatic rings being linked through a single bond or a divalent group, the aromatic rings which can be employed as Ar described above may be exemplified as two or more aromatic rings constituting such Ar and the preferred forms of two or more aromatic rings constituting Ar are the same as the preferred forms of the aromatic rings which can be employed as Ar described above.

In a case where Ar represents a structure formed by two or more aromatic rings being linked through a single bond or a divalent group, two or more aromatic rings constituting Ar may be the same as or different from each other, but it is preferable that two or more aromatic rings constituting Ar are the same as each other. Further, in the case where Ar represents a structure formed by two or more aromatic rings being linked through a single bond or a divalent group, the number of two or more aromatic rings is preferably in a range of 2 to 5, more preferably in a range of 2 to 4, still more preferably 2 or 3, and even still more preferably 2.

In the case where Ar represents a structure formed by two or more aromatic rings being linked through a single bond or a divalent group, a structure formed by two benzene rings being linked through a single bond or a divalent group is particularly preferable.

As the divalent group in the case where Ar represents a structure formed by two or more aromatic rings being linked through a single bond or a divalent group, —C(R^{X})₂— (R^{X} represents a hydrogen atom or a substituent, and in a case where R^{X} represents a substituent, the substituents may be linked to each other to form a ring), —O—, —SO₂—, —C(═O)—, —S—, —NR^{Y}— (R^{Y} represents a hydrogen atom or an alkyl group (preferably a methyl group or an ethyl group)), or an aryl group (preferably a phenyl group), —C₆H₄— (a phenylene group), or a combination of these is preferable, and —C(R^{X})₂— is more preferable. In a case where R^{X} represents a substituent, specific examples thereof include groups selected from the following substituent group Z. Among these, an alkyl group (the preferable range is the same as the preferable range of the alkyl group described in the section of the substituent group Z below) is preferable, an alkyl group having a halogen atom as a substituent is more preferable, and trifluoromethyl is particularly preferable. The molecular weight of such a divalent linking group is preferably in a range of 10 to 500 and more preferably in a range of 10 to 200.

R^{1a} represents a substituent other than —CH═CHR^{1b}. As the substituent which can be employed as R^{1a}, among groups selected from the following substituent group Z, a group that does not have an ethylenically unsaturated bond is preferable. Among examples of such a group, an alkyl group, a halogen atom (such as a fluorine atom, a chlorine atom, a bromine atom, or an iodine atom), a carboxy group, a carbamoyl group, an acyloxy group, a sulfo group, a sulfamoyl group, an alkylsulfonyloxy group, or an aryl group is preferable, an alkyl group, a carboxy group, or a sulfamoyl group is more preferable, and an alkyl group is particularly preferable.

The alkyl group which can be employed as R^{1a} may be linear or branched. The number of carbon atoms of the alkyl group which can be employed as R^{1a} is preferably in a range of 1 to 10, more preferably in a range of 1 to 6, and still more preferably in a range of 1 to 3. Further, methyl or ethyl is even still more preferable as the alkyl group.

The number of carbon atoms of the carbamoyl group which can be employed as R^{1a} is preferably in a range of 1 to 10, more preferably in a range of 1 to 6, and still more preferably in a range of 1 to 3. Further, an unsubstituted carbamoyl group is even still more preferable as the carbamoyl group. In a case where the carbamoyl group includes a substituent, an alkyl group is preferable as such a substituent.

The number of carbon atoms of the acyloxy group which can be employed as R^{1a} is preferably in a range of 2 to 10, more preferably in a range of 2 to 6, still more preferably in a range of 2 to 4, and particularly preferably 2 or 3. Further, an alkylcarbonyloxy group is preferable as the acyloxy group.

The number of carbon atoms of the sulfamoyl group which can be employed as R^{1a} is preferably in a range of 0 to 10, more preferably in a range of 0 to 6, and still more preferably in a range of 0 to 3. Further, an unsubstituted sulfamoyl group is even still more preferable as the carbamoyl group. In a case where the sulfamoyl group includes a substituent, an alkyl group is preferable as such a substituent.

The alkyl group constituting the alkylsulfonyloxy group which can be employed as R^{1a} may be linear or branched. The number of carbon atoms of the alkylsulfonyloxy group is preferably in a range of 1 to 10, more preferably in a range of 1 to 6, still more preferably in a range of 1 to 4, and particularly preferably in a range of 1 to 3.

The number of carbon atoms of the aryl group which can be employed as R^{1a} is preferably in a range of 6 to 20, more preferably in a range of 6 to 15, and still more preferably in a range of 6 to 12. Further, a phenyl group is even still more preferable as the aryl group.

R^{1a} is directly bonded to a ring-constituting atom of an aromatic ring in Ar.

a1 showing the number of R^{1a} represents an integer of 0 to 20, preferably an integer of 0 to 10, more preferably an integer of 0 to 5, and still more preferably an integer of 0 to 4, and may be an integer of 0 to 3 or an integer of 0 to 2.

R^{1b} represents a hydrogen atom or a substituent.

Examples of the substituent which can be employed as R^{1b} include groups selected from the following substituent group Z. Among these, an alkyl group, a halogen atom (such as a fluorine atom, a chlorine atom, a bromine atom, or an iodine atom), a carboxy group, a carbamoyl group, an acyloxy group, a sulfo group, a sulfamoyl group, an alkylsulfonyloxy group, or an aryl group is preferable, and an alkyl group is more preferable.

The preferred forms of the alkyl group, the carbamoyl group, the acyloxy group, the sulfamoyl group, the alkylsulfonyloxy group, and the aryl group which can be employed as R^{1b} are respectively the same as the preferred forms of the alkyl group, the carbamoyl group, the acyloxy group, the sulfamoyl group, the alkylsulfonyloxy group, and the aryl group which can be employed as R^{1a}.

It is particularly preferable that R^{1b} represents a hydrogen atom.

a2 represents an integer of 0 to 20, preferably an integer of 0 to 10, more preferably an integer of 0 to 5, and still more preferably an integer of 0 to 3, and may be an integer of 0 to 2.

*A and *B represent a linking site for being incorporated in a polyimide chain constituting the crosslinked polyimide compound.

In the present specification, the polyimide chain constituting the crosslinked polyimide compound indicates a polyimide unit constituting the crosslinked polyimide compound. In other words, the form in which polyimide chains are crosslinked and linked is a crosslinked polyimide compound. Further, the concept of “being incorporated in a polyimide chain” includes both forms, which are, the form for incorporation so as to constitute a main chain structure of a polyimide chain and the form for incorporation in a side chain of a polyimide chain.

a4 represents an integer of 0 to 2 and a5 represents 1 or 2. It is preferable that both of a4 and a5 represent 1 or 2.

XL represents a linking group for forming a crosslinked structure by linking polyimide chains represented by Formula (I-a) or (I-b). a3 represents an integer of 1 to 20, preferably an integer of 1 to 10, more preferably an integer of 1 to 5, still more preferably an integer of 1 to 3, and particularly preferably 1 or 2.

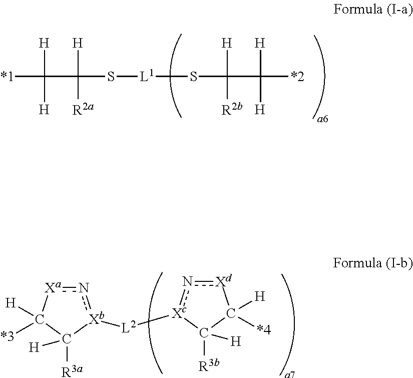

In Formula (I-a), R^{2a} and R^{2b} represent a hydrogen atom, a substituent, or a polyimide residue. The substituents which can be employed as R^{2a} and R^{2b} are the same as the substituents which can be employed as R^{1b} and the preferred forms thereof are the same as described above.

L¹ represents an (a6+1)-valent linking group. a6 represents an integer of 1 or greater, preferably an integer of 1 to 20, more preferably an integer of 1 to 10, and still more preferably an integer of 1 to 4.

The molecular weight of L¹ is preferably in a range of 10 to 2000, more preferably in a range of 10 to 500, and still more preferably in a range of 10 to 200.

It is preferable that L¹ represents a group formed by combining atoms selected from a carbon atom, an oxygen atom, a sulfur atom, a nitrogen atom, and a hydrogen atom or a salt thereof.

The preferred form of L¹ is the same as the preferred form of L³ in Formula (V) described below.

*1 and *2 represent a site directly bonded to a ring-constituting atom of an aromatic ring in Ar in Formula (I). Here, the expression “*1 and *2 represent a site directly bonded to a ring-constituting atom of an aromatic ring in Ar in Formula (I)” means that *2 represents a site linked to a ring-constituting atom of an aromatic ring in Ar, in a structural portion represented by Formula (I) which is different from the structural portion represented by Formula (I) to which * 1 is linked, in the crosslinked polyimide compound.

The linking group represented by Formula (I-a) is formed by reacting a compound (crosslinking agent A) that contains two or more mercapto groups in one molecule with an ethylenically unsaturated group in a styrene structure contained in the polyimide compound. The reaction formula of this crosslinking reaction is shown below by focusing one mercapto group in such a crosslinking agent A.

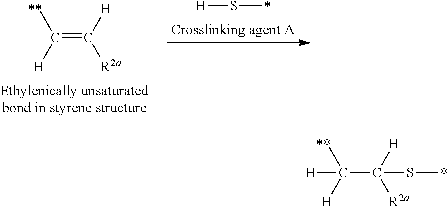

In the reaction formula, the symbol “**in” represents a linking site with respect to a benzene ring constituting the styrene structure in the polyimide compound.

R^{2a} represents a hydrogen atom, a substituent, or a polyimide residue.

The symbol “*” represents a linking site.

Here, R^{2a} represents a polyimide residue in a case where the ethylenically unsaturated group in the styrene structure is present as a main chain structure of the polyimide compound. For example, in a case where the “ethylenically unsaturated bond in the styrene structure” shown in the reaction formula is present in the structure of a diamine component or an acid anhydride component of the polyimide compound as shown below, R^{2a} represents a polyimide residue.

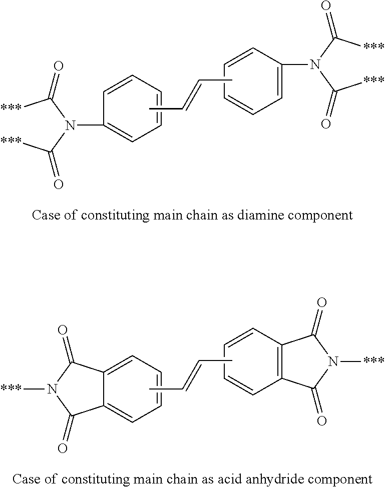

In the formula shown above, the symbol “***” represents a linking site for being incorporated in the polyimide main chain.

In Formula (I-b), in two adjacent linked structures formed by interposing a nitrogen atom shown by the combination of a dashed line and a solid line in the same ring structure, one structure indicates a double bond and the other indicates a single bond.

R^{3a} and R^{3b} represent a hydrogen atom, a substituent, and a polyimide residue. The substituents which can be employed as R^{3a} and R^{3b} are the same as the substituents which can be employed as R^{1b} described above, and the preferred forms thereof are the same as described above.

L² represents an (a7+1)-valent linking group. a7 represents an integer of 1 or greater, preferably an integer of 1 to 20, more preferably an integer of 1 to 10, and still more preferably an integer of 1 to 4.

The molecular weight of L² is preferably in a range of 10 to 2000, more preferably in a range of 10 to 500, and still more preferably in a range of 10 to 200.

It is preferable that L² represents a group formed by combining atoms selected from a carbon atom, an oxygen atom, a sulfur atom, a nitrogen atom, and a hydrogen atom or a salt thereof.

The preferred form of L² is the same as the preferred form of L⁴ in Formula (VI) described below.

X^{a} and X^{d} represent O or N, and X^{b} and X^{c} represent N or C. In a case where X^{a} represents O, it is preferable that X^{b} represents C. In a case where X^{a} represents N, it is preferable that X^{b} represents N. Similarly, in a case where X^{d} represents O, it is preferable that X^{c} represents C. In a case where X^{d} represents N, it is preferable that X^{b} represents N. It is more preferable that X^{a} and X^{d} represent O and X^{b} and X^{c} represent C.

*3 and *4 represent a site directly bonded to a ring-constituting atom of an aromatic ring in Ar in Formula (I). Here, the expression “*3 and *4 represent a site directly bonded to a ring-constituting atom of an aromatic ring in Ar in Formula (I)” means that *4 represents a site linked to a ring-constituting atom of an aromatic ring in Ar, in a structural portion represented by Formula (I) which is different from the structural portion represented by Formula (I) to which *3 is linked, in the crosslinked polyimide compound.

The linking group represented by Formula (I-b) is formed by reacting a compound (crosslinking agent B) that contains two or more nitrile N oxide groups in one molecule with an ethylenically unsaturated group in the styrene structure contained in the polyimide compound or reacting a compound (crosslinking agent C) that contains two or more azide groups (—N₃) in one molecule with an ethylenically unsaturated group in the styrene structure contained in the polyimide compound. Here, a group obtained by removing one hydrogen atom from a nitrile oxide compound is preferable as the nitrile N oxide group.

The reaction formula of the crosslinking reaction is shown below by focusing one nitrile N oxide group in the crosslinking agent B.

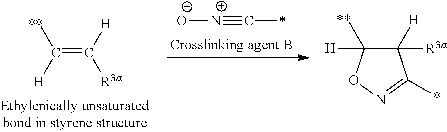

In the reaction formula, the symbol “**” represents a linking site with respect to a benzene ring constituting the styrene structure in the polyimide compound.

R^{3a} represents a hydrogen atom, a substituent, or a polyimide residue.

The symbol “*” represents a linking site.

Here, R^{3a} represents a polyimide residue in a case where the ethylenically unsaturated group in the styrene structure is present as a main chain structure of the polyimide compound as described in the reaction using the crosslinking agent A described above.

The reaction formula of the crosslinking reaction is shown below by focusing one azide group in the crosslinking agent C.

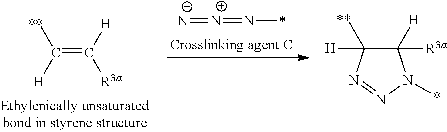

In the reaction formula, the symbol “**” represents a linking site with respect to a benzene ring constituting the styrene structure in the polyimide compound.

R^{3a} represents a hydrogen atom, a substituent, or a polyimide residue.

The symbol “*” represents a linking site.

Here, R^{3a} represents a polyimide residue in a case where the ethylenically unsaturated group in the styrene structure is present as a main chain structure of the polyimide compound as described in the reaction using the crosslinking agent A described above.

In Formula (I), the upper limit of the total value of a1 to a5 varies depending on the structure of Ar and is the total value of the number of substituents which can be employed as Ar (for example, in a case where Ar represents a benzene ring, the upper limit of the total value of a1 to a5 is 6).

It is preferable that the polyimide chain constituting the crosslinked polyimide compound has a repeating unit represented by Formula (II).

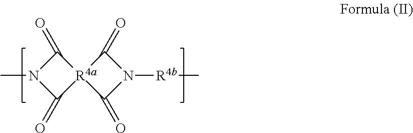

In Formula (II), R^{4a} represents a tetravalent linking group, and R^{4b} represents a divalent linking group, where R^{4a} and/or R^{4b} has a structural portion represented by Formula (I).

In a case where R^{4a} has a structural portion represented by Formula (I), the structural portion represented by Formula (I) may be present in the form of a substituent in R^{4a} (in other words, only one in the total number of *A's and *B's becomes a linking site for being incorporated in a polyimide chain constituting the crosslinked polyimide compound and may be in the form incorporated in R^{4a}) and it is preferable that R^{4a} represents a structural portion represented by Formula (I).

In a case where R^{4a} represents a structural portion represented by Formula (I), both of *A and *B represent a linking site for being incorporated in a polyimide chain and both of a4 and a5 represent 2.

Further, in a case where R^{4b} has a structural portion represented by Formula (I), the structural portion represented by Formula (I) may be present in the form of a substituent in R^{4b} (in other words, only one in the total number of *A's and *B's becomes a linking site for being incorporated in a polyimide chain constituting the crosslinked polyimide compound and may be in the form incorporated in R^{4b}) and it is preferable that R^{4b} represents a structural portion represented by Formula (I).

In a case where R^{4b} represents a structural portion represented by Formula (I), both of *A and *B represent a linking site for being incorporated in a polyimide chain and both of a4 and a5 represent 1.

In the repeating unit represented by Formula (II), it is preferable that R^{4b} represents a structural portion represented by Formula (I).

In the repeating unit represented by Formula (II), it is preferable that R^{4a} represents a tetravalent group represented by any of Formulae (I-1) to (I-28) in a case where R^{4a} does not have a structural portion represented by Formula (I).

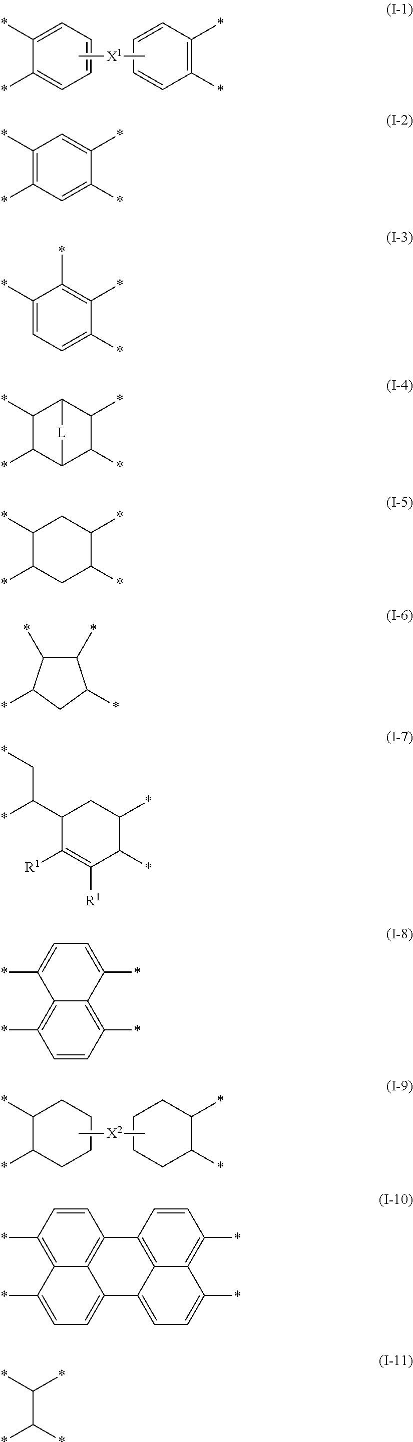

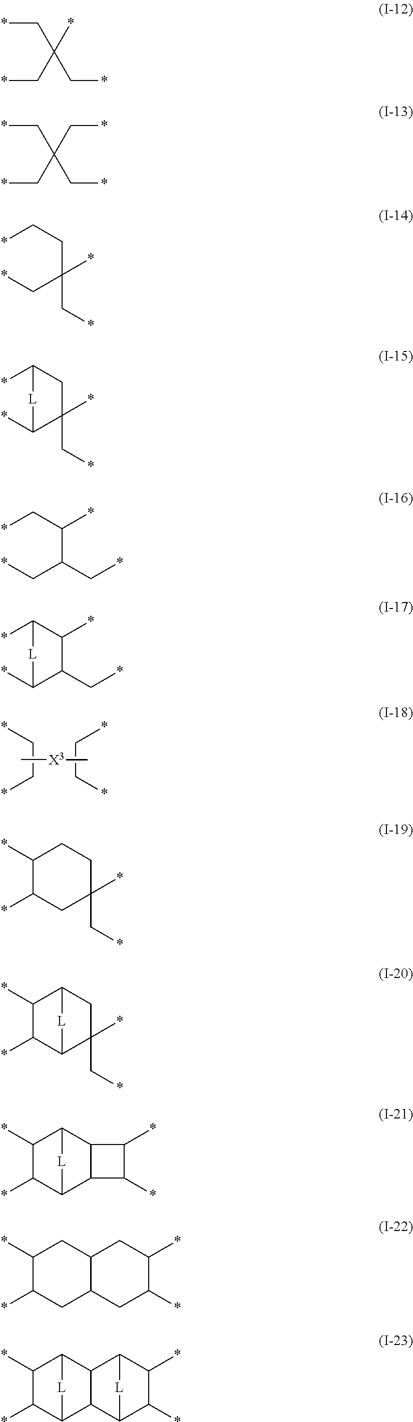

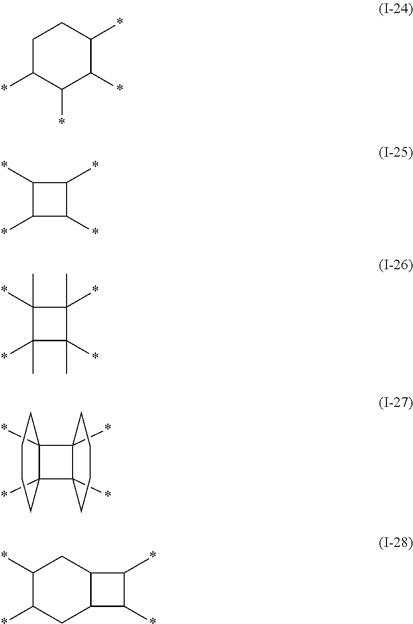

R^{4a} represents preferably a group represented by Formula (I-1) (I-2), or (I-4), more preferably a group represented by Formula (I-1) or (I-4), and particularly preferably a group represented by Formula (I-1).

In Formulae (I-1), (I-9), and (I-18), X¹ to X³ represent a single bond or a divalent linking group. As the divalent linking group, —C(R^{x})₂— (R^{x} represents a hydrogen atom or a substituent, and in a case where R^{x} represents a substituent, R^{x}'s may be linked to each other to form a ring), —O—, —SO₂—, —C(═O)—, —S—, —NR^{Y}— (R^{Y} represents a hydrogen atom, an alkyl group (preferably a methyl group or an ethyl group), an aryl group (preferably a phenyl group)), —C₆H₄— (a phenylene group), or a combination of these is preferable. It is more preferable that X¹ to X³ represent a single bond or —C(R^{x})₂₋. In a case where R^{x} represents a substituent, specific examples thereof include groups selected from the following substituent group Z. Among these, an alkyl group (the preferable range is the same as that of the alkyl group in the substituent group Z described below) is preferable, an alkyl group having a halogen atom as a substituent is more preferable, and trifluoromethyl is particularly preferable. Moreover, in Formula (I-18), X³ is linked to any one of two carbon atoms shown on the left side thereof and any one of two carbon atoms shown on the right side thereof.

In a case where X¹ to X³ represent a divalent linking group, the molecular weight thereof is preferably in a range of 10 to 500 and more preferably in a range of 10 to 200.

In Formulae (I-4), (I-15), (I-17), (I-20), (I-21), and (I-23), L represents —CH═CH— or —CH₂—.

In Formula (I-7), R¹ and R² represent a hydrogen atom or a substituent that does not have an ethylenically unsaturated bond. Examples of such a substituent include groups that do not have an ethylenically unsaturated bond from among groups selected from the following substituent group Z. R¹ and R² may be bonded to each other to form a ring.

R¹ and R² represent preferably a hydrogen atom or an alkyl group, more preferably a hydrogen atom, a methyl group, or an ethyl group, and still more preferably a hydrogen atom.

The carbon atoms shown in Formulae (I-1) to (I-28) may further include a substituent. Specific examples of the substituent include groups that do not have an ethylenically unsaturated bond from among groups selected from the following substituent group Z. Among these, an alkyl group or an aryl group is preferable.

In the repeating unit represented by Formula (II), it is preferable that R^{4b} is represented by Formula (II-a) or (II-b) in a case where R^{4b} does not have a structural portion represented by Formula (I).

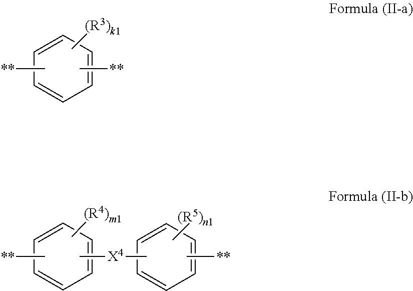

In Formula (II-a), R³ represents a substituent that does not have an ethylenically unsaturated bond and examples of such a substituent include groups that do not have an ethylenically unsaturated bond from among groups selected from the following substituent group Z. Among these, an alkyl group, a halogen atom (such as a fluorine atom, a chlorine atom, a bromine atom, or an iodine atom), a carboxy group, a carbamoyl group, an acyloxy group, a sulfo group, a sulfamoyl group, an alkylsulfonyloxy group, or an aryl group is preferable, and an alkyl group, a carboxy group, or a sulfamoyl group is more preferable.

The preferred forms of the alkyl group, the carbamoyl group, an acyloxy group, the sulfamoyl group, the alkylsulfonyloxy group, and the aryl group which can be employed as R³ are respectively the same as the preferred forms of the alkyl group, the carbamoyl group, the acyloxy group, the sulfamoyl group, the alkylsulfonyloxy group, and the aryl group which can be employed as R^{1a}

k1 showing the number of R³ represents an integer of 0 to 4.

In a case where R³ represents an alkyl group, k1 represents preferably 1 to 4, more preferably 2 to 4, and still more preferably 3 or 4.

In a case where R³ represents a carboxy group, k1 represents preferably 1 or 2 and more preferably 1.

In a case where R³ represents an alkyl group, methyl, ethyl, or trifluoromethyl is more preferable as the alkyl group.

In Formula (II-a), it is preferable that two linking sites for being incorporated in the polyimide compound of the diamine component (that is, a phenylene group which can contain R³) are positioned in the meta position or the para position.

In Formula (II-b), R⁴ and R⁵ represent a substituent that does not have an ethylenically unsaturated bond, and examples of such a substituent include groups free from an ethylenically unsaturated bond, which are selected from the following substituent group Z. It is preferable that R⁴ and R⁵ represent an alkyl group, a halogen atom (such as a fluorine atom, a chlorine atom, a bromine atom, or an iodine atom), a carboxy group, a carbamoyl group, an acyloxy group, a sulfo group, a sulfamoyl group, an alkylsulfonyloxy group, or an aryl group or a group formed by being linked to each other to form a ring together with X⁴. Further, the form formed by two R⁴'s being linked to each other to form a ring or the form formed by two R⁵'s being linked to each other to form a ring is also preferable. The structure in which R⁴ and R⁵ are linked to each other is not particularly limited, but a single bond, —O—, or —S— is preferable.

m1 and n1 respectively showing the number of R⁴ and the number of R⁵ represent an integer of 0 to 4, preferably 1 to 4, more preferably 2 to 4, and still more preferably 3 or 4.

In a case where R⁴ and R⁵ represent an alkyl group, methyl, ethyl, or trifluoromethyl is preferable as this alkyl group.

In Formula (II-b), it is preferable that two linking sites for being incorporated in the polyimide compound of two phenylene groups (that is, two phenylene groups which can contain R⁴ and R⁵) in the diamine component are positioned in the meta position or the para position with respect to the linking site as X⁴.

X⁴ has the same definition as that for X¹ in Formula (I-1) and the preferred forms thereof are the same as each other.

It is preferable that a part or the entire of the repeating unit represented by Formula (II) in the polyimide chain is a repeating unit represented by Formula (VIII) or (IX).

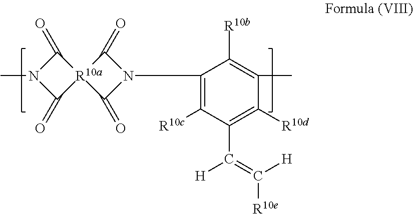

In Formula (VIII), R^{10b}, R^{10c}, and R^{10d} represent a substituent other than —CH═CHR^{10e}. R^{10e} represents a hydrogen atom or a substituent.

As the substituent which can be employed as R^{10b}, R^{10c}, and R^{10d}, substituents that do not contain an ethylenically unsaturated bond from among groups selected from the following substituent group Z are preferable, an alkyl group, a halogen atom (such as a fluorine atom, a chlorine atom, a bromine atom, or an iodine atom), a carboxy group, a carbamoyl group, an acyloxy group, a sulfo group, a sulfamoyl group, an alkylsulfonyloxy group, or an aryl group is more preferable, and an alkyl group is particularly preferable.

The preferred forms of the alkyl group, the carbamoyl group, the acyloxy group, the sulfamoyl group, the alkylsulfonyloxy group, and the aryl group which can be employed as R^{10b}, R^{10c}, and R^{10d} are respectively the same as the preferred forms of the alkyl group, the carbamoyl group, the acyloxy group, the sulfamoyl group, the alkylsulfonyloxy group, and the aryl group which can be employed as R^{1a}

The substituent which can be employed as R^{10e} has the same definition as that for the substituent which can be employed as R^{1b} in Formula (I), and the preferred forms thereof are the same as described above. It is more preferable that R^{10e} represents a hydrogen atom.

R^{10a} represents a tetravalent group represented by any of Formulae (I-1) to (I-28), and the preferred forms thereof are the same as the preferred forms described above in Formulae (I-1) to (I-28).

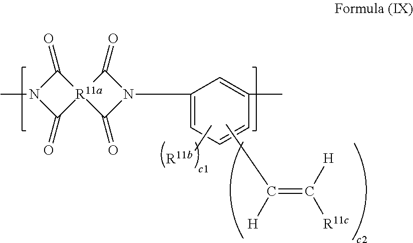

In Formula (IX), R11b represents a substituent other than —CH═CHR^{11r}. R^{11e} represents a hydrogen atom or a substituent.

As the substituent which can be employed as R^{11b}, a substituent that does not contain an ethylenically unsaturated bond from among groups selected from the following substituent group Z is preferable, an alkyl group, a halogen atom (such as a fluorine atom, a chlorine atom, a bromine atom, or an iodine atom), a carboxy group, a carbamoyl group, an acyloxy group, a sulfo group, a sulfamoyl group, an alkylsulfonyloxy group, or an aryl group is more preferable, and an alkyl group is particularly preferable.

The preferred forms of the alkyl group, the carbamoyl group, the acyloxy group, the sulfamoyl group, the alkylsulfonyloxy group, and the aryl group which can be employed as R^{11b} are respectively the same as the preferred forms of the alkyl group, the carbamoyl group, the acyloxy group, the sulfamoyl group, the alkylsulfonyloxy group, and the aryl group which can be employed as R^{1a}

R^{11c} has the same definition as that for R^{1b} in Formula (I), and the preferred forms thereof are the same as described above.

c1 represents an integer of 0 to 2, and c2 represents 2 or 3. Here, the total value of c1 and c2 is an integer of 2 to 4.

R^{11a} represents a tetravalent group represented by any of Formulae (I-1) to (I-28), and the preferred forms thereof are the same as the preferred forms described above in Formulae (I-1) to (I-28).

The polyimide chain constituting the crosslinked polyimide compound used in the present invention may have a repeating unit represented by Formula (II-c) which does not have a structural portion represented by Formula (I), in addition to the repeating unit represented by Formula (II).

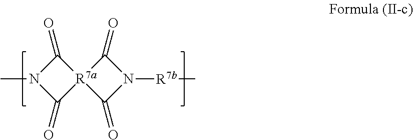

In Formula (II-c), R^{7a} represents a tetravalent group represented by any of Formulae (I-1) to (I-28), and the preferred forms thereof are the same as the preferred forms described above in Formulae (I-1) to (I-28).

R^{7b} represents a structure represented by Formula (II-a) or (II-b), and the preferred forms thereof are the same as the preferred forms described above in Formula (II-a) or (II-b).

In the structure of the polyimide chain constituting the crosslinked polyimide compound used in the present invention, the ratio of the molar amount of the repeating unit represented by Formula (II) to the total molar amount of the repeating unit represented by Formula (II) and the repeating unit represented by Formula (II-c) is preferably in a range of 30% to 100% by mole, more preferably in a range of 40% to 100% by mole, still more preferably in a range of 50% to 100% by mole, even still more preferably in a range of 60% to 100% by mole, even still more preferably in a range of 70% to 100% by mole, even still more preferably in a range of 80% to 100% by mole, and particularly preferably in a range of 90% to 100% by mole. Further, the expression “the ratio of the molar amount of the repeating unit represented by Formula (II) to the total molar amount of the repeating unit represented by Formula (II) and the repeating unit represented by Formula (II-c) is 100% by mole” means that the polyimide compound does not have the repeating unit represented by Formula (II-c).

It is more preferable that the polyimide chain constituting the crosslinked polyimide compound used in the present invention has a structure formed of the repeating unit represented by Formula (II) or a structure formed of the repeating unit represented by Formula (II) or the repeating unit represented by Formula (II-c).

The density of the crosslinking point in the crosslinked polyimide compound is preferably 0.50 mmol/g or greater, more preferably 0.70 mmol/g or greater, and still more preferably 1.00 mmol/g or greater from the viewpoint of plasticity resistance.

Further, the upper limit of the density of the crosslinking point in the crosslinked polyimide is not particularly limited, and is practically 20 mmol/g or less and typically 5 mmol/g or less.

The density of the crosslinking point in the crosslinked polyimide compound indicates the total molar amount of the following structures (a) to (d) which are present in 1 g of the crosslinked polyimide compound and is measured according to the method described in the example described below.

Structure (a):

Structure represented by ****—CH₂—CHR^{2a}—S—*

Structure (b):

Structure represented by *—S—CHR^{2b}—CH₂—****

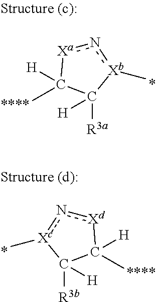

In the structures (a) to (d), the symbol “****” represents a site directly bonded to a ring-constituting atom of an aromatic ring, and the symbol “*” represents a linking site. R^{2a} and R^{2b} each have the same definition as that for R^{2a} and R^{2b} in Formula (I-a), and X^{a} to X^{d}, R^{3a}, and R^{3b} each have the same definition as that for X^{a} to X^{d}, R^{3a}, and R^{3b} in Formula (I-b).

It is preferable that the crosslinked polyimide compound used in the present invention does not have structures from among the structures (a) to (d) in the form in which **** is not directly bonded to the ring-constituting atom of the aromatic ring.

It is preferable that the crosslinked polyimide compound has a toluene swelling ratio of 35% or less. Here, in a case where a polyimide single membrane formed of a polyimide compound is exposed to saturated toluene vapor, the toluene swelling ratio is an increase ratio of the mass of the exposed polyimide single membrane to the mass of the polyimide single membrane before the exposure and is measured according to the method described in the example below.

From the viewpoint of the plasticity resistance, the toluene swelling ratio thereof is more preferably less than 20% and still more preferably less than 10%. Further, the toluene swelling ratio is considered to be excellent as the value is as low as possible, but the toluene swelling ratio thereof is unlikely to set to 0% and is typically 2% or greater.

The toluene swelling ratio of the crosslinked polyimide compound can be measured according to the method described in the example below.

Examples of the substituent group Z include:

an alkyl group (the number of carbon atoms of the alkyl group is preferably in a range of 1 to 30, more preferably in a range of 1 to 20, and particularly preferably in a range of 1 to 10, and examples thereof include methyl, ethyl, isopropyl, tert-butyl, n-octyl, n-decyl, and n-hexadecyl), a cycloalkyl group (the number of carbon atoms of the cycloalkyl group is preferably in a range of 3 to 30, more preferably in a range of 3 to 20, and particularly preferably in a range of 3 to 10, and examples thereof include cyclopropyl, cyclopentyl, and cyclohexyl), an alkenyl group (the number of carbon atoms of the alkenyl group is preferably in a range of 2 to 30, more preferably in a range of 2 to 20, and particularly preferably in a range of 2 to 10, and examples thereof include vinyl, allyl, 2-butenyl, and 3-pentenyl), an alkynyl group (the number of carbon atoms of the alkynyl group is preferably in a range of 2 to 30, more preferably in a range of 2 to 20, and particularly preferably in a range of 2 to 10, and examples thereof include propargyl and 3-pentynyl), an aryl group (the number of carbon atoms of the aryl group is preferably in a range of 6 to 30, more preferably in a range of 6 to 20, and particularly preferably in a range of 6 to 12, and examples thereof include phenyl, p-methylphenyl, naphthyl, and anthranyl), an amino group (such as an amino group, an alkylamino group, an arylamino group, or a heterocyclic amino group; the number of carbon atoms of the amino group is preferably in a range of 0 to 30, more preferably in a range of 0 to 20, and particularly preferably in a range of 0 to 10 and examples thereof include amino, methylamino, dimethylamino, diethylamino, dibenzylamino, diphenylamino, and ditolylamino), an alkoxy group (the number of carbon atoms of the alkoxy group is preferably in a range of 1 to 30, more preferably in a range of 1 to 20, and particularly preferably in a range of 1 to 10, and examples thereof include methoxy, ethoxy, butoxy, and 2-ethylhexyloxy), an aryloxy group (the number of carbon atoms of the aryloxy group is preferably in a range of 6 to 30, more preferably in a range of 6 to 20, and particularly preferably in a range of 6 to 12, and examples thereof include phenyloxy, 1-naphthyloxy, and 2-naphthyloxy), a heterocyclic oxy group (the number of carbon atoms of the heterocyclic oxy group is preferably in a range of 1 to 30, more preferably in a range of 1 to 20, and particularly preferably in a range of 1 to 12, and examples thereof include pyridyloxy, pyrazyloxy, pyrimidyloxy, and quinolyloxy),

an acyl group (the number of carbon atoms of the acyl group is preferably in a range of 1 to 30, more preferably in a range of 1 to 20, and particularly preferably in a range of 1 to 12, and examples thereof include acetyl, benzoyl, formyl, and pivaloyl), an alkoxycarbonyl group (the number of carbon atoms of the alkoxycarbonyl group is preferably in a range of 2 to 30, more preferably in a range of 2 to 20, and particularly preferably in a range of 2 to 12, and examples thereof include methoxycarbonyl and ethoxycarbonyl), an aryloxycarbonyl group (the number of carbon atoms of the aryloxycarbonyl group is preferably in a range of 7 to 30, more preferably in a range of 7 to 20, and particularly preferably in a range of 7 to 12, and examples thereof include phenyloxycarbonyl), an acyloxy group (the number of carbon atoms of the acyloxy group is preferably in a range of 2 to 30, more preferably in a range of 2 to 20, and particularly preferably in a range of 2 to 10, and examples thereof include acetoxy and benzoyloxy), an acylamino group (the number of carbon atoms of the acylamino group is preferably in a range of 2 to 30, more preferably in a range of 2 to 20, and particularly preferably in a range of 2 to 10, and examples thereof include acetylamino and benzoylamino),

an alkoxycarbonylamino group (the number of carbon atoms of the alkoxycarbonylamino group is preferably in a range of 2 to 30, more preferably in a range of 2 to 20, and particularly preferably in a range of 2 to 12, and examples thereof include methoxycarbonylamino), an aryloxycarbonylamino group (the number of carbon atoms of the aryloxycarbonylamino group is preferably in a range of 7 to 30, more preferably in a range of 7 to 20, and particularly preferably in a range of 7 to 12, and examples thereof include phenyloxycarbonylamino), a sulfonylamino group (the number of carbon atoms of the sulfonylamino group is preferably in a range of 1 to 30, more preferably in a range of 1 to 20, and particularly preferably in a range of 1 to 12, and examples thereof include methanesulfonylamino and benzenesulfonylamino), a sulfamoyl group (the number of carbon atoms of the sulfamoyl group is preferably in a range of 0 to 30, more preferably in a range of 0 to 20, and particularly preferably in a range of 0 to 12, and examples thereof include sulfamoyl, methylsulfamoyl, dimethylsulfamoyl, and phenylsulfamoyl),

an alkylthio group (the number of carbon atoms of the alkylthio group is preferably in a range of 1 to 30, more preferably in a range of 1 to 20, and particularly preferably in a range of 1 to 12, and examples thereof include methylthio and ethylthio), an arylthio group (the number of carbon atoms of the arylthio group is preferably in a range of 6 to 30, more preferably in a range of 6 to 20, and particularly preferably in a range of 6 to 12, and examples thereof include phenylthio), a heterocyclic thio group (the number of carbon atoms of the heterocyclic thio group is preferably in a range of 1 to 30, more preferably in a range of 1 to 20, and particularly preferably in a range of 1 to 12, and examples thereof include pyridylthio, 2-benzimidazolylthio, 2-benzoxazolylthio, and 2-benzothiazolylthio),

a sulfonyl group (the number of carbon atoms of the sulfonyl group is preferably in a range of 1 to 30, more preferably in a range of 1 to 20, and particularly preferably in a range of 1 to 12, and examples thereof include mesyl and tosyl), a sulfinyl group (the number of carbon atoms of the sulfinyl group is preferably in a range of 1 to 30, more preferably in a range of 1 to 20, and particularly preferably in a range of 1 to 12, and examples thereof include methanesulfinyl and benzenesulfinyl), an ureido group (the number of carbon atoms of the ureido group is preferably in a range of 1 to 30, more preferably in a range of 1 to 20, and particularly preferably in a range of 1 to 12, and examples thereof include ureido, methylureido, and phenylureido), a phosphoric acid amide group (the number of carbon atoms of the phosphoric acid amide group is preferably in a range of 1 to 30, more preferably in a range of 1 to 20, and particularly preferably in a range of 1 to 12, and examples thereof include diethyl phosphoric acid amide and phenyl phosphoric acid amide), a hydroxy group, a mercapto group, a halogen atom (such as a fluorine atom, a chlorine atom, a bromine atom, or an iodine atom, and a fluorine atom is more preferable),

a cyano group, a carboxy group, an oxo group, a nitro group, a hydroxamic acid group, a sulfino group, a hydrazine group, an imino group, a heterocyclic group (a 3- to 7-membered ring heterocyclic group is preferable, the hetero ring may be aromatic or non-aromatic, examples of a heteroatom constituting the hetero ring include a nitrogen atom, an oxygen atom, and a sulfur atom, the number of carbon atoms of the heterocyclic group is preferably in a range of 0 to 30 and more preferably in a range of 1 to 12, and specific examples thereof include imidazolyl, pyridyl, quinolyl, furyl, thienyl, piperidyl, morpholino, benzoxazolyl, benzimidazolyl, benzothiazolyl, carbazolyl, and azepinyl), a silyl group (the number of carbon atoms of the silyl group is preferably in a range of 3 to 40, more preferably in a range of 3 to 30, and particularly preferably in a range of 3 to 24, and examples thereof include trimethylsilyl and triphenylsilyl), and a silyloxy group (the number of carbon atoms of the silyloxy group is preferably in a range of 3 to 40, more preferably in a range of 3 to 30, and particularly preferably in a range of 3 to 24, and examples thereof include trimethylsilyloxy and triphenylsilyloxy). These substituents may be substituted with any one or more substituents selected from the substituent group Z.

Further, in the present invention, in a case where a plurality of substituents are present at one structural site, these substituents may be linked to each other to form a ring or may be condensed with some or entirety of the structural site and form an aromatic ring or an unsaturated hetero ring.

In a case where a compound or a substituent includes an alkyl group or an alkenyl group, these may be linear or branched and may be substituted or unsubstituted. In addition, in a case where a compound or a substituent includes an aryl group or a heterocyclic group, these may be a single ring or a condensed ring and may be substituted or unsubstituted.

In the present specification, in a case where a group is described as only a substituent, the substituent group Z can be used as reference unless otherwise specified. Further, in a case where only the names of the respective groups are described (for example, a group is described as an “alkyl group”), the preferable range and the specific examples of the corresponding group in the substituent group Z are applied.

The molecular weight (the molecular weight of the polyimide compound before the crosslinked structure is formed) of the polyimide chain constituting the crosslinked polyimide compound used in the present invention is preferably in a range of 10,000 to 1,000,000, more preferably in a range of 15,000 to 500,000, and still more preferably in a range of 20,000 to 200,000 as the weight-average molecular weight.

The molecular weight and the dispersity in the present specification are set to values measured using a gel permeation chromatography (GPC) method unless otherwise specified and the molecular weight is set to a weight-average molecular weight in terms of polystyrene. A gel including an aromatic compound as a repeating unit is preferable as a gel filling a column used for the GPC method and examples of the gel include a gel formed of a styrene-divinylbenzene copolymer. It is preferable that two to six columns are linked to each other and used. Examples of a solvent to be used include an ether-based solvent such as tetrahydrofuran and an amide-based solvent such as N-methylpyrrolidinone. It is preferable that measurement is performed at a flow rate of the solvent of 0.1 to 2 mL/min and most preferable that the measurement is performed at a flow rate thereof of 0.5 to 1.5 mL/min. In a case where the measurement is performed in the above-described range, a load is not applied to the apparatus and the measurement can be more efficiently performed. The measurement temperature is preferably in a range of 10° C. to 50° C. and most preferably in a range of 20° C. to 40° C. In addition, the column and the carrier to be used can be appropriately selected according to the physical properties of a polymer compound which is a target for measurement.

[Synthesis of Polyimide Compound]

The polyimide chain constituting the crosslinked polyimide compound used in the present invention can be synthesized by performing condensation and polymerization of a bifunctional acid anhydride (tetracarboxylic dianhydride) having a specific structure and a specific diamine having a specific structure. Such methods can be performed by referring to the technique described in a general book (for example, “The Latest Polyimide—Fundamentals and Applications-” edited by Toshio Imai and Rikio Yokota, NTS Inc., Aug. 25, 2010, pp. 3 to 49) as appropriate.

At least one tetracarboxylic dianhydride serving as a raw material in synthesis of the polyimide compound used in the present invention is represented by Formula (XII). It is preferable that all tetracarboxylic dianhydrides which are the raw materials are represented by Formula (XII).

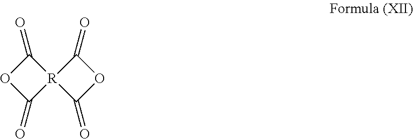

In Formula (XII), R represents a tetravalent group. R may have a structural portion represented by Formula (III). The structural portion represented by Formula (III) indicates a residue obtained by removing g hydrogen atoms from the compound represented by Formula (III), and g represents an integer of preferably 1 to 10 and more preferably 1 to 4. The structural portion represented by Formula (III) is a structure that guides the structural portion represented by Formula (I) by reacting with the following crosslinking agent.

In a case where R has a structural portion represented by Formula (III), a diamine monomer (also referred to as a diamine compound) described below which is allowed to react with this tetracarboxylic dianhydride may or may not have a structural portion represented by Formula (III). Meanwhile, in a case where R does not have a structural portion represented by Formula (III), a diamine monomer described below which is allowed to react with this tetracarboxylic dianhydride has a structural portion represented by Formula (III).

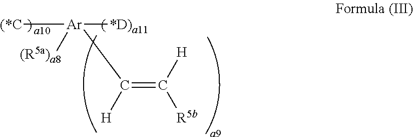

In Formula (III), Ar, R^{5a}, R^{5b}, *C, and *D each have the same definition as that for Ar, R^{1a}, R^{1b}, *A, and *B in Formula (I), and the preferred forms thereof are the same as described above.

a8 represents an integer of 0 to 20, preferably an integer of 0 to 10, more preferably an integer of 0 to 5, and still more preferably an integer of 0 to 3.

a9 represents an integer of 1 to 20, preferably an integer of 1 to 10, more preferably an integer of 1 to 5, and still more preferably an integer of 1 to 3.

a10 represents an integer of 0 to 2, and a11 represents 1 or 2. It is preferable that both of a10 and a11 represent 1 or 2.

In a case where R has a structural portion represented by Formula (III), preferred examples of the tetracarboxylic dianhydride represented by Formula (XII) include the following structures, but the present invention is not limited to these.

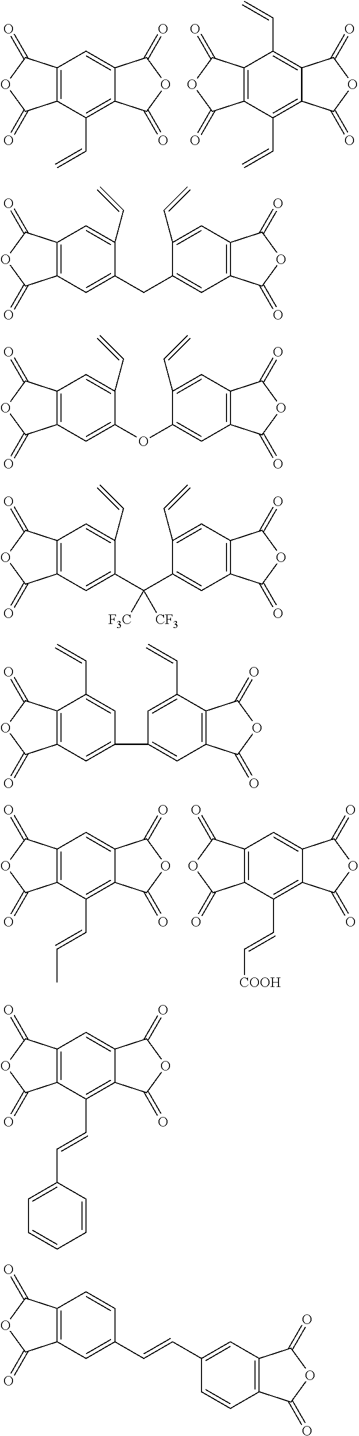

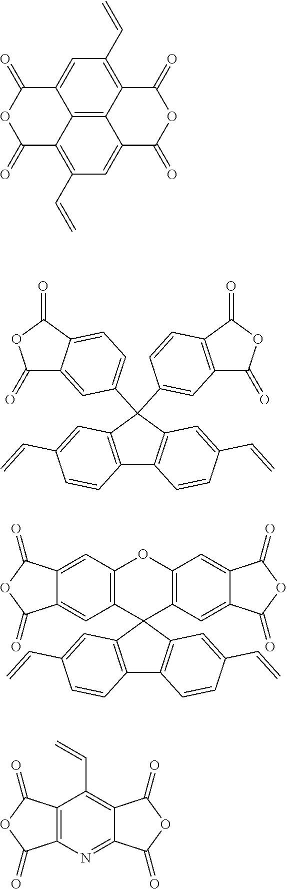 [SMILES: C=Cc1cc2c3c(c(C=C)cc4c3c1C(=O)OC4=O)C(=O)OC2=O ; C=Cc1ccc2c(c1)C(c1ccc3c(c1)C(=O)OC3=O)(c1ccc3c(c1)C(=O)OC3=O)c1cc(C=C)ccc1-2 ; C=Cc1ccc2c(c1)C1(c3cc4c(cc3Oc3cc5c(cc31)C(=O)OC5=O)C(=O)OC4=O)c1cc(C=C)ccc1-2 ; C=Cc1c2c(=O)oc(=O)c2nc2c(=O)oc(=O)c12]

Further, in a case where R does not have a structural portion represented by Formula (III), R represents a tetravalent group represented by any of Formulae (I-1) to (I-28), and the preferred forms thereof are the same as the preferred forms described above in Formulae (I-1) to (I-28).

In a case where R represents a tetravalent group which does not have a structural portion represented by Formula (III), preferred examples of the tetracarboxylic dianhydride represented by Formula (XII) include the following structures, but the present invention is not limited to these.

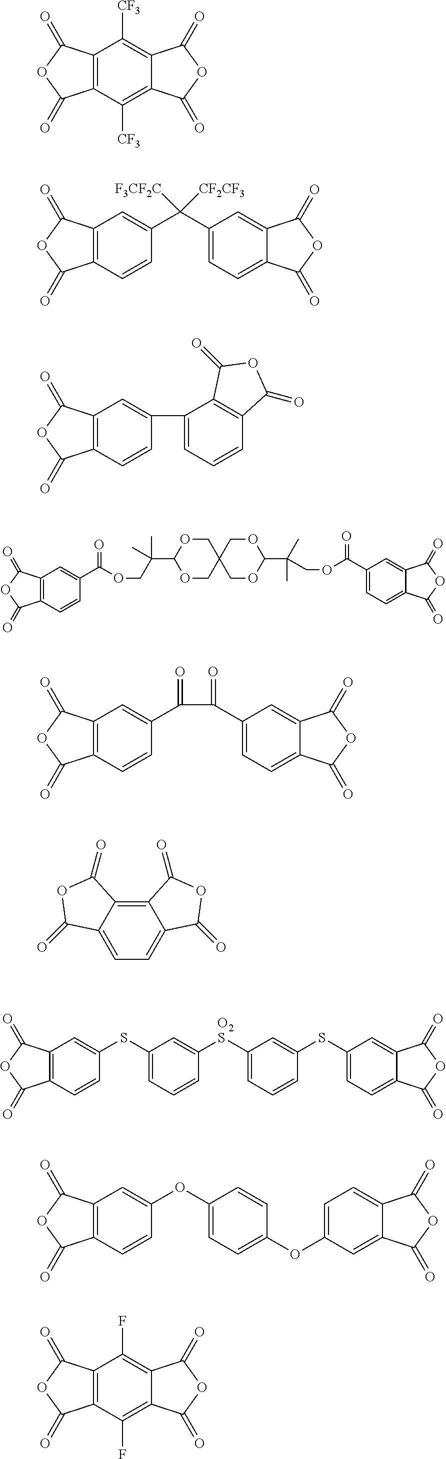

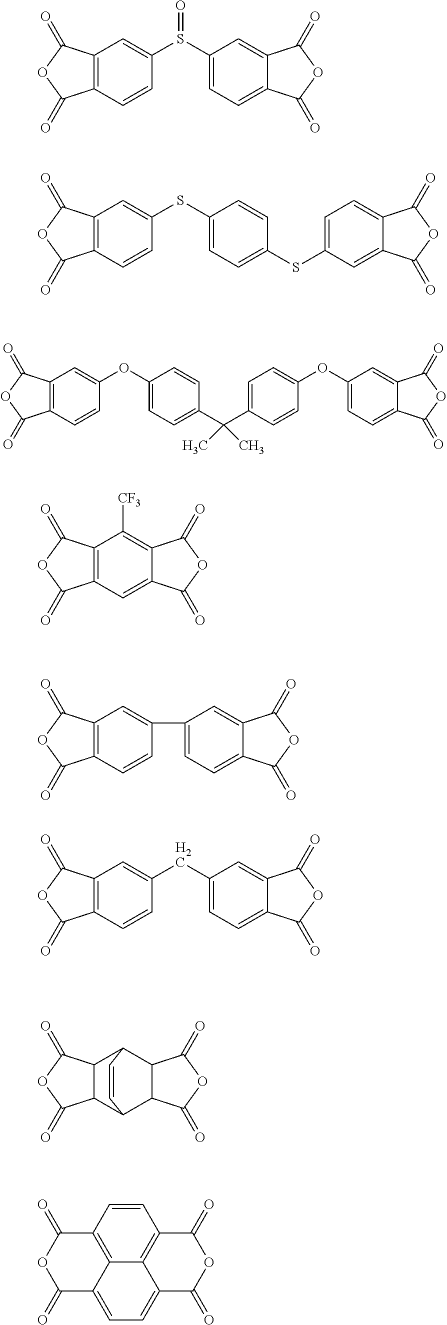

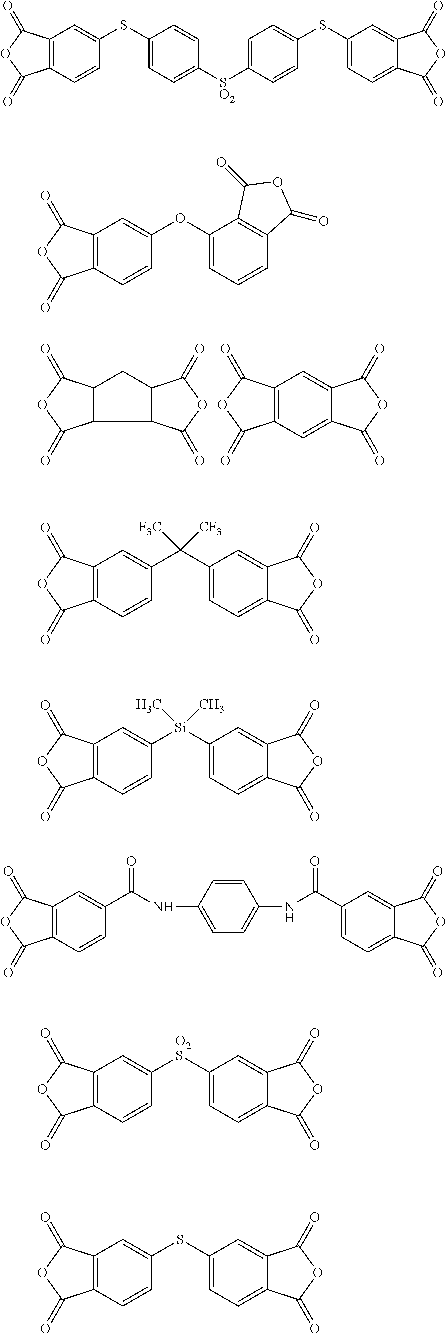

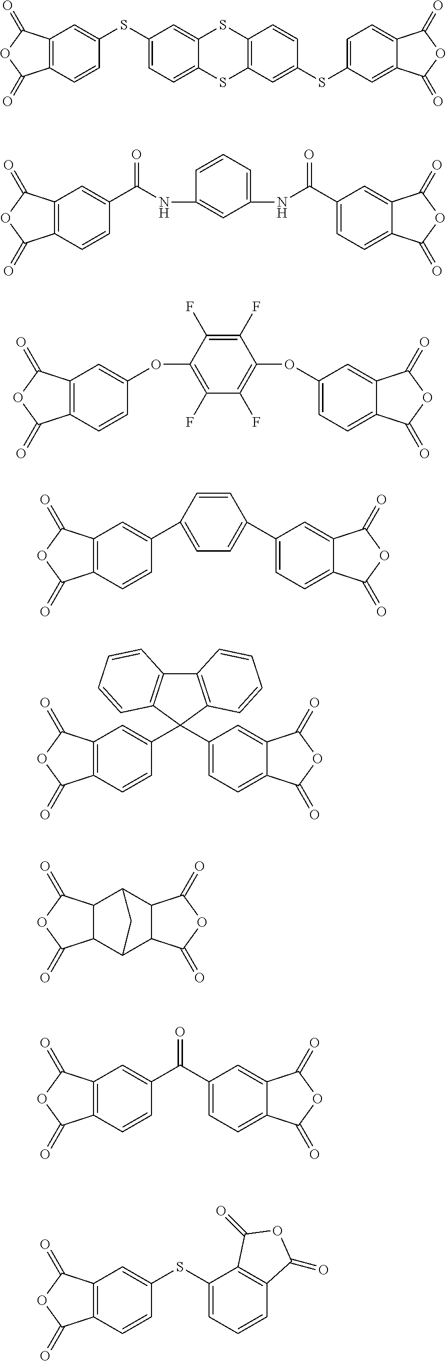

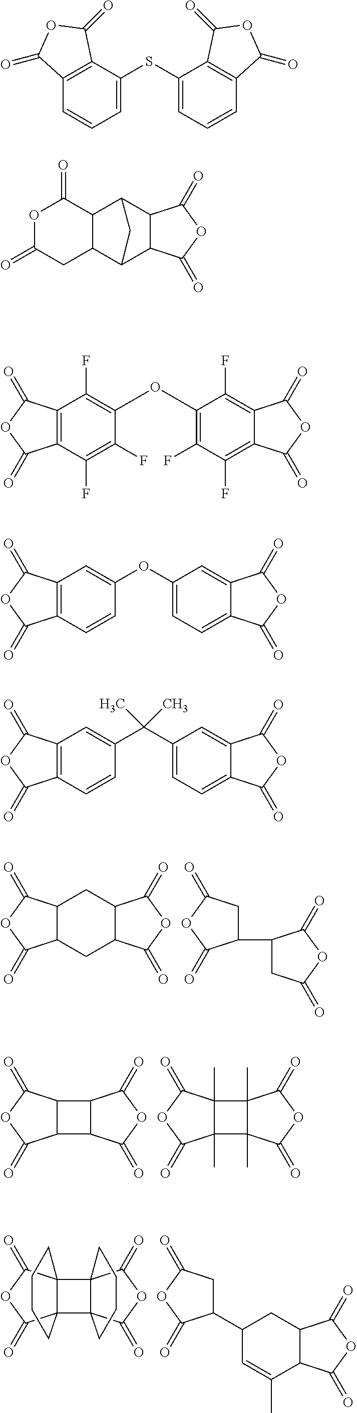

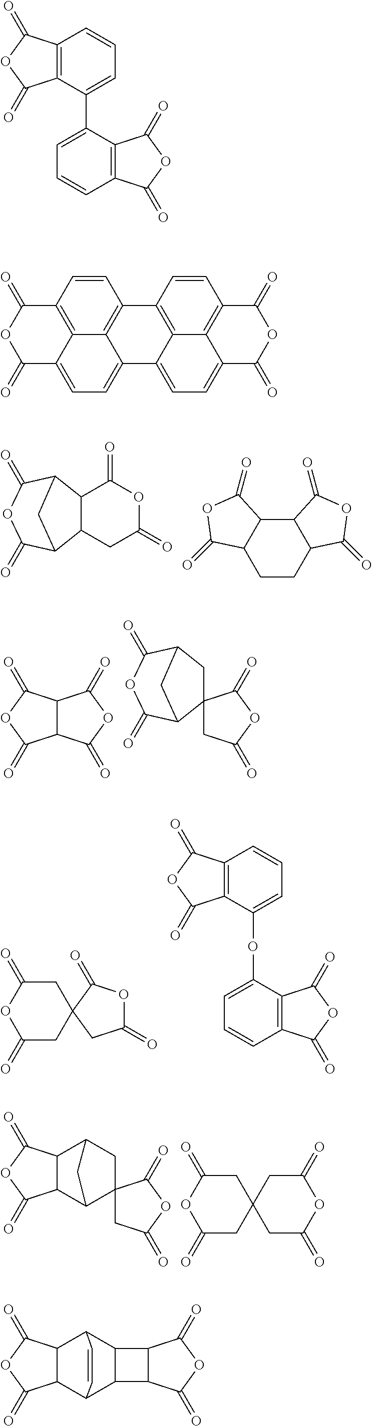

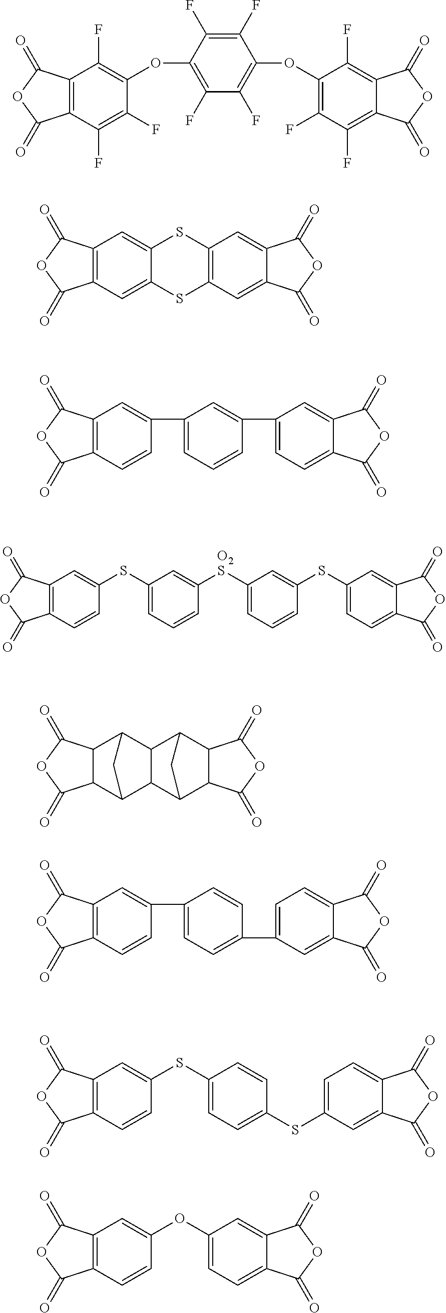

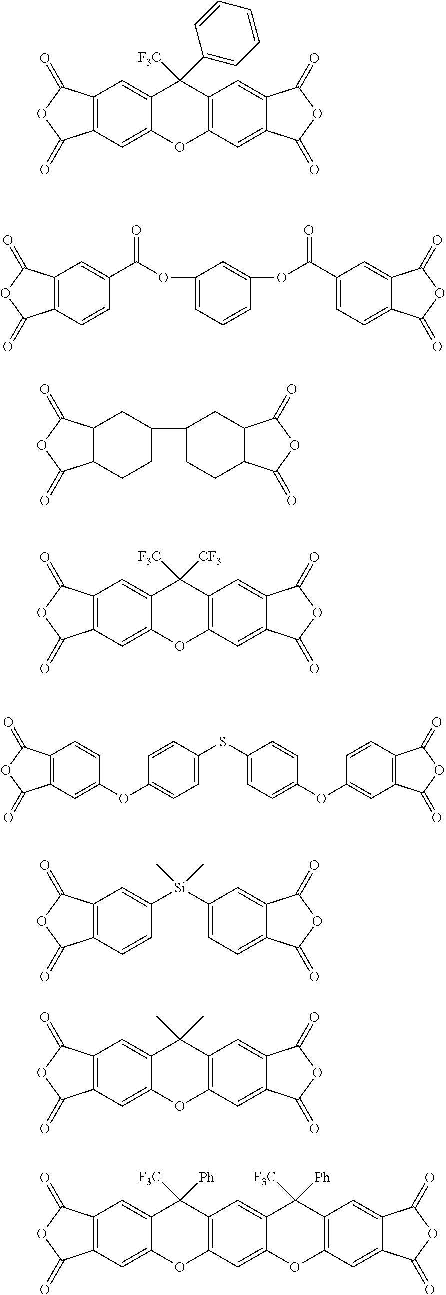

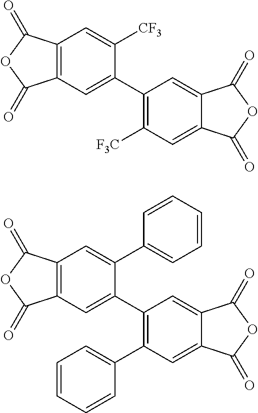 [SMILES: O=C1OC(=O)c2cc(C(F)(F)F)c(-c3cc4c(cc3C(F)(F)F)C(=O)OC4=O)cc21 ; O=C1OC(=O)c2cc(-c3cc4c(cc3-c3ccccc3)C(=O)OC4=O)c(-c3ccccc3)cc21]

In a case where a diamine compound which is another raw material in the synthesis of the polyimide compound used in the present invention has a structural portion represented by Formula (III) in the structure thereof, it is preferable that the diamine compound thereof is represented by Formula (X) or (XI).

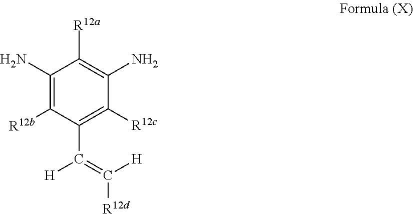

In Formula (X), R^{12a}, R^{12b}, R^{12c}, and R^{12d} each have the same definition as that for R^{10b}, R^{10c}, R^{10d}, and R^{10e} in formula (VIII), and the preferred forms are the same as described above.

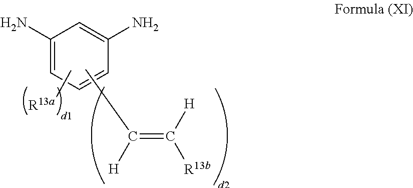

In Formula (XI), R^{13a}, R^{13b}, d1, and d2 each have the same definition as that for R^{11b}, R^{11c}, c1, and c2 in Formula (IX) and the preferred forms thereof are the same as described above.

In a case where the diamine compound has a structural portion represented by Formula (III) in the structure thereof, examples of such a case include the followings, but the present invention is not limited to these.

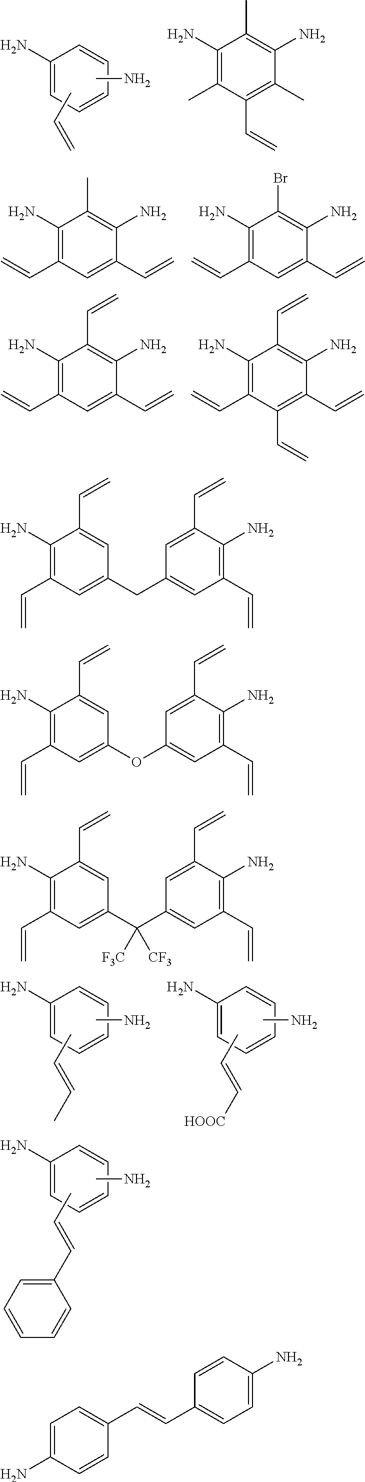

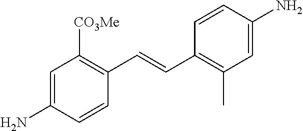

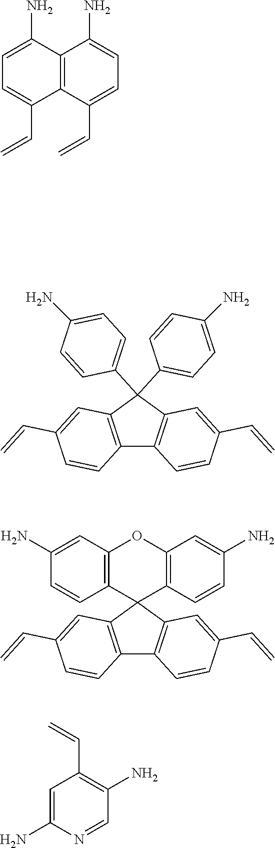

Further, in a case where the diamine compound used for synthesis of the polyimide compound used in the present invention does not have a structural portion represented by Formula (III), examples of such a case include the followings, but the present invention is not limited to these.

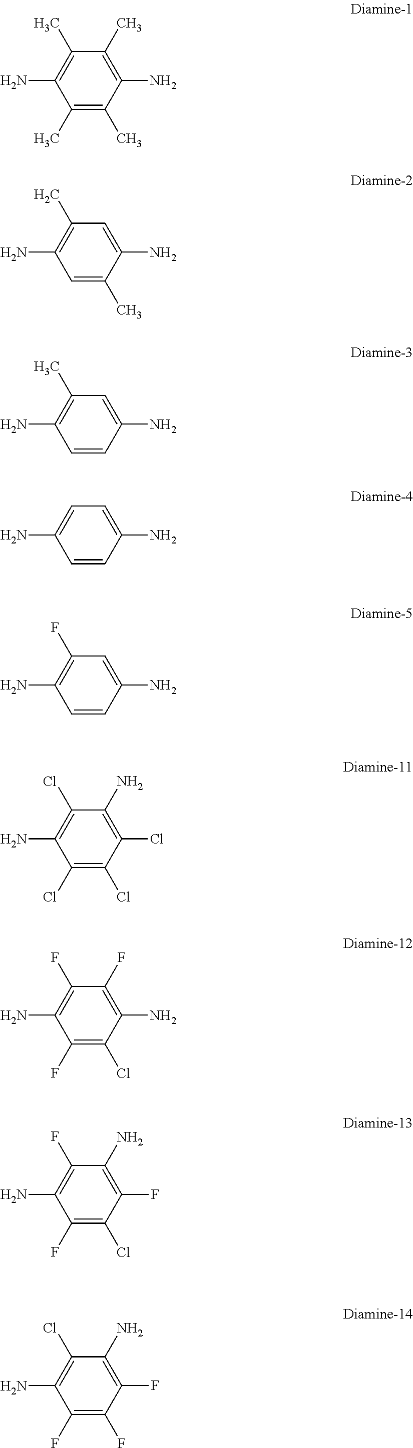

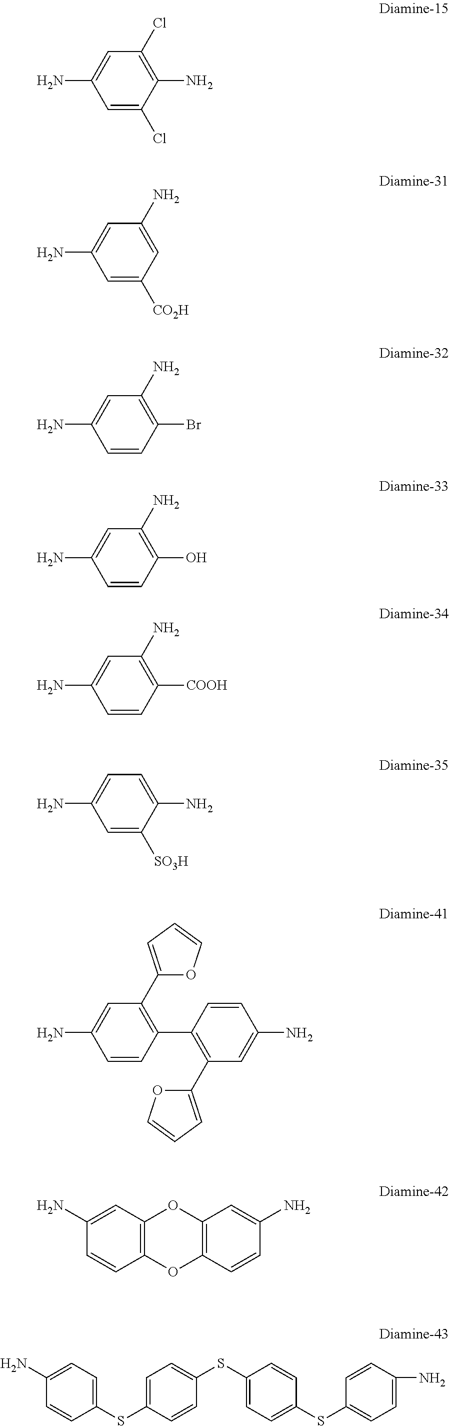

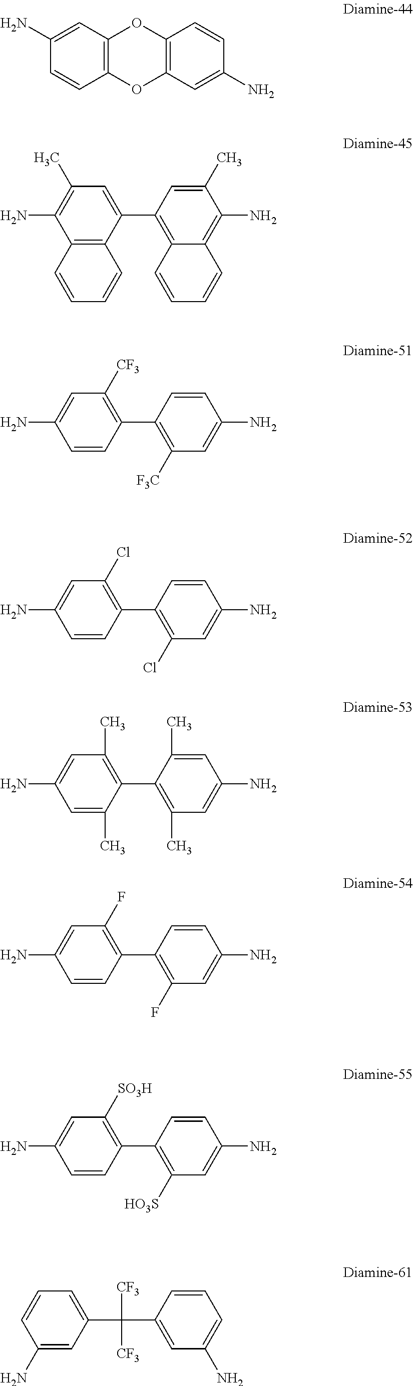

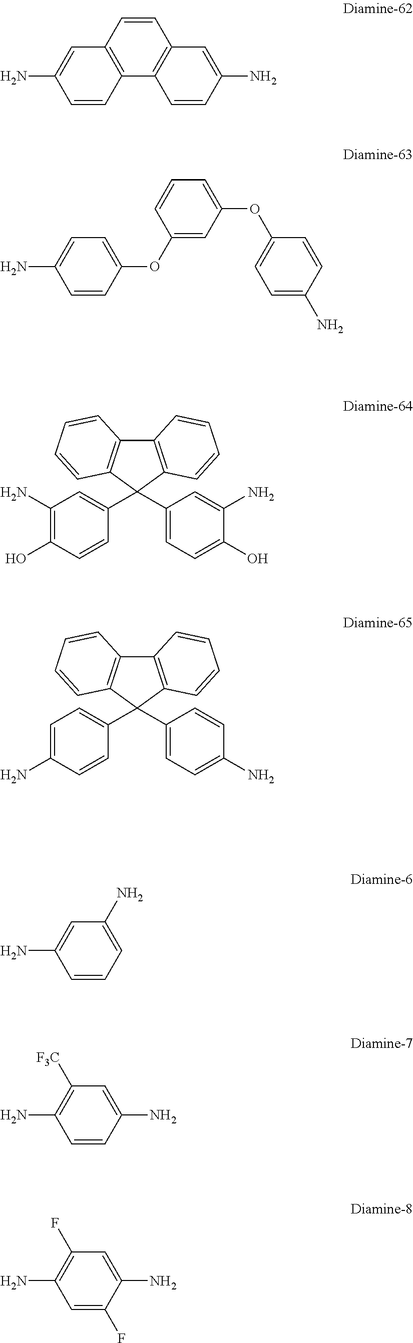

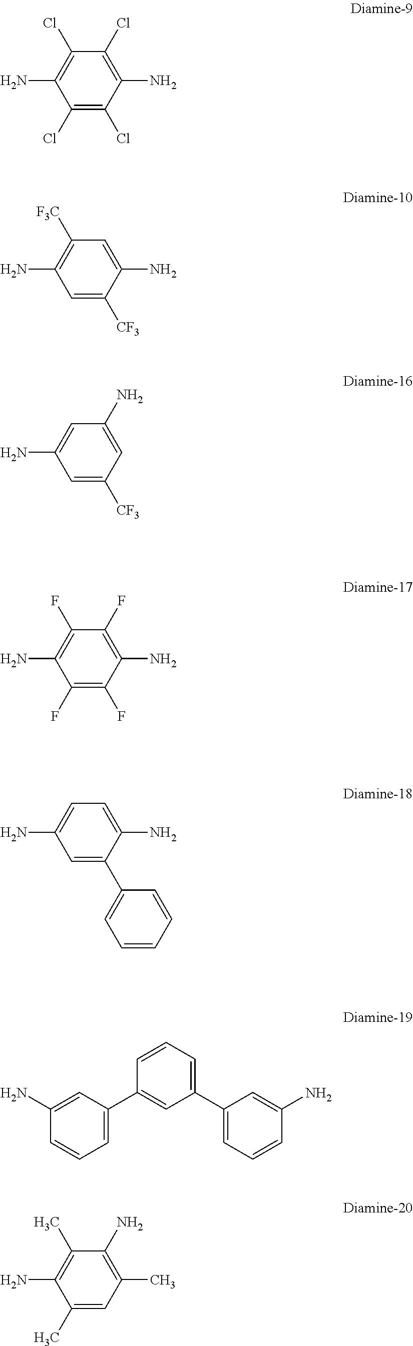

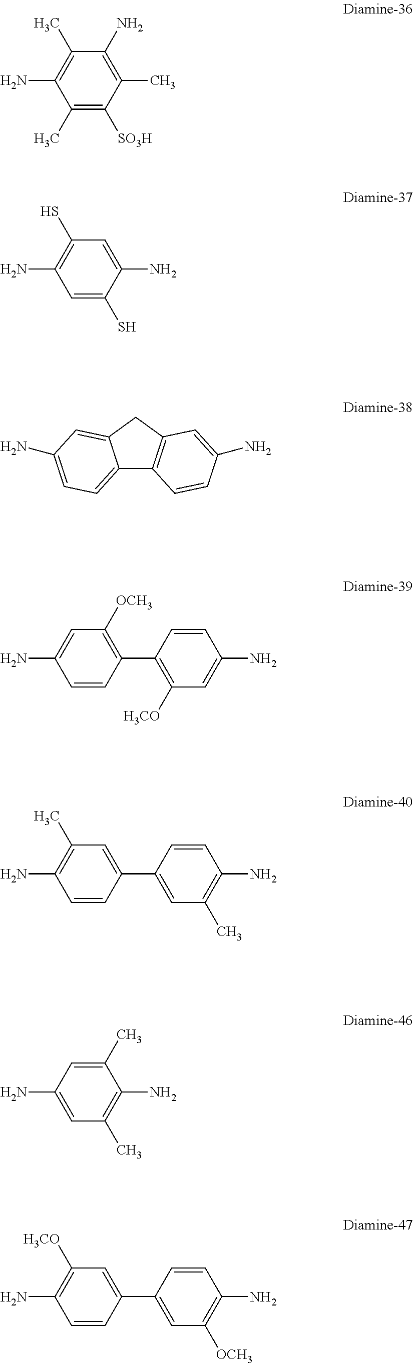

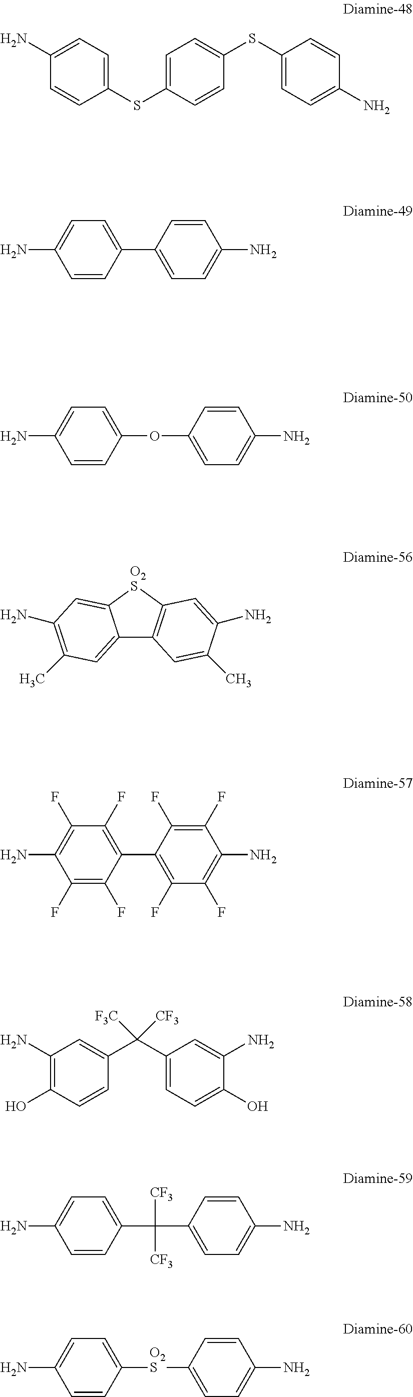

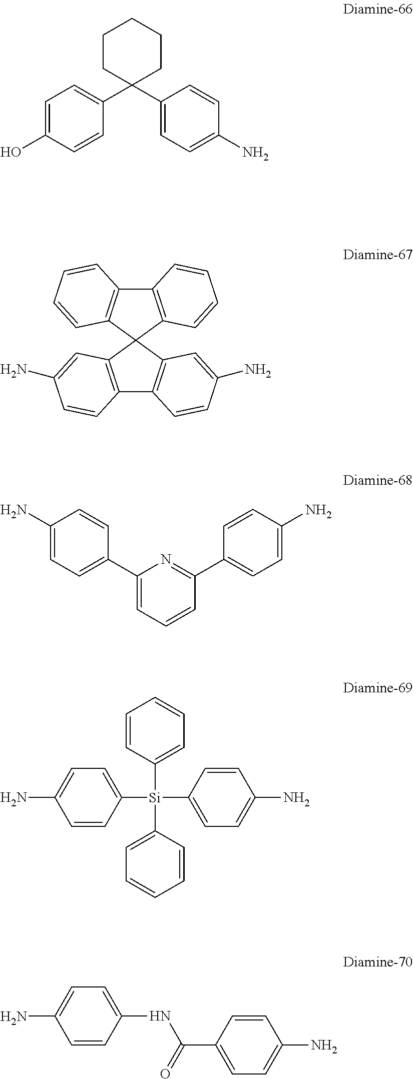 [SMILES: Nc1ccc(C2(c3ccc(O)cc3)CCCCC2)cc1 ; Nc1ccc2c(c1)C1(c3ccccc3-c3ccccc31)c1cc(N)ccc1-2 ; Nc1ccc(-c2cccc(-c3ccc(N)cc3)n2)cc1 ; Nc1ccc([Si](c2ccccc2)(c2ccccc2)c2ccc(N)cc2)cc1 ; Nc1ccc(NC(=O)c2ccc(N)cc2)cc1]

The polyimide compound used in the invention may be any of a block copolymer, a random copolymer, and a graft copolymer.

The polyimide compound used in the present invention can be obtained by mixing the above-described raw materials in a solvent and condensing and polymerizing the mixture using a typical method as described above.

The solvent is not particularly limited, and examples thereof include an ester such as methyl acetate, ethyl acetate, or butyl acetate; aliphatic ketone such as acetone, methyl ethyl ketone, methyl isobutyl ketone, diacetone alcohol, cyclopentanone, or cyclohexanone; an ether such as diethylene glycol monomethyl ether, ethylene glycol dimethyl ether, dibutyl butyl ether, tetrahydrofuran, methyl cyclopentyl ether, or dioxane; an amide such as N-methylpyrrolidone, 2-pyrrolidone, dimethylformamide, dimethylimidazolidinone, or dimethylacetamide; and a sulfur-containing organic solvent such as dimethyl sulfoxide or sulfolane. These organic solvents can be suitably selected within the range in which a tetracarboxylic dianhydride serving as a reaction substrate, a diamine compound, polyamic acid which is a reaction intermediate, and a polyimide compound which is a final product can be dissolved. Among these, an ester (preferably butyl acetate), an aliphatic ketone (preferably methyl ethyl ketone, methyl isobutyl ketone, diacetone alcohol, cyclopentanone, or cyclohexanone), an ether (preferably diethylene glycol monomethyl ether or methyl cyclopentyl ether), an amide (preferably N-methylpyrrolidone), or a sulfur-containing organic solvent (preferably dimethyl sulfoxide or sulfolane) is preferable. In addition, these can be used alone or in combination of two or more kinds thereof.

The temperature of the polymerization reaction is not particularly limited and a temperature which can be typically employed for the synthesis of the polyimide compound can be employed. Specifically, the temperature is preferably in a range of −40° C. to 250° C. and more preferably in a range of −30° C. to 180° C.

The polyimide compound can be obtained by imidizing the polyamic acid, which is generated by the above-described polymerization reaction, through a dehydration ring-closure reaction in a molecule. The method of the dehydration ring-closure can be performed by referring to the method described in a general book (for example, “The Latest Polyimide—Fundamentals and Applications—” edited by Toshio Imai and Rikio Yokota, NTS Inc., Aug. 25, 2010, pp. 3 to 49). A thermal imidization method of performing heating in a temperature range of 120° C. to 200° C. and removing water generated as a by-product to the outside of the system for a reaction or a so-called chemical imidization method in which a dehydration condensation agent such as an acetic anhydride, dicyclohexylcarbodiimide, or triphenyl phosphite is used in the coexistence of a basic catalyst such as pyridine, triethylamine, or DBU is suitably used.

In the present invention, the total concentration of the tetracarboxylic dianhydride and the diamine compound in the polymerization reaction solution of the polyimide compound is not particularly limited, but is preferably in a range of 5% to 70% by mass, more preferably in a range of 5% to 50% by mass, and still more preferably in a range of 5% to 30% by mass.

[Gas Separation Membrane]

[Gas Separation Composite Membrane]

It is preferable that the gas separation composite membrane which is a preferred form of the gas separation membrane of the present invention includes a gas permeating support layer and a gas separation layer provided on the support layer. In other words, in the gas separation composite membrane, it is preferable that the gas separation layer that contains the polyimide compound of the present invention is formed on the upper side of the support layer. It is preferable that this composite membrane is formed by coating (in the present specification, the concept “coating” includes the form of adhesion to a surface through immersion) at least a surface of a porous support with a coating solution (dope) to form the gas separation layer.

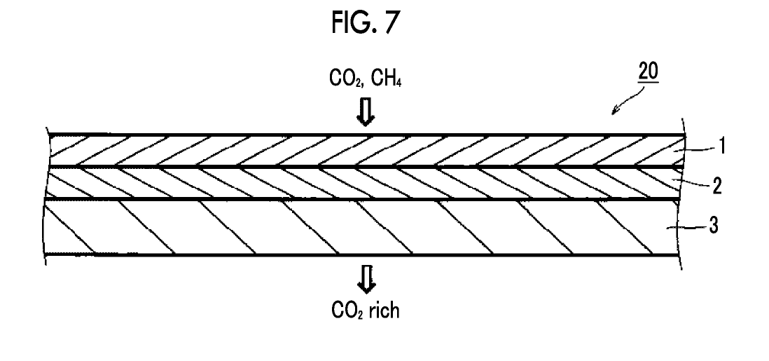

FIG. 6 is a longitudinal cross-sectional view schematically illustrating a gas separation composite membrane 10 which is a preferred embodiment of the present invention. The reference numeral 1 represents a gas separation layer and the reference numeral 2 represents a support layer formed of a porous layer. FIG. 7 is a cross-sectional view schematically illustrating a gas separation composite membrane 20 which is another preferred embodiment of the present invention. In the embodiment, a non-woven fabric layer 3 is added as a support layer in addition to the gas separation layer 1 and the porous layer 2.

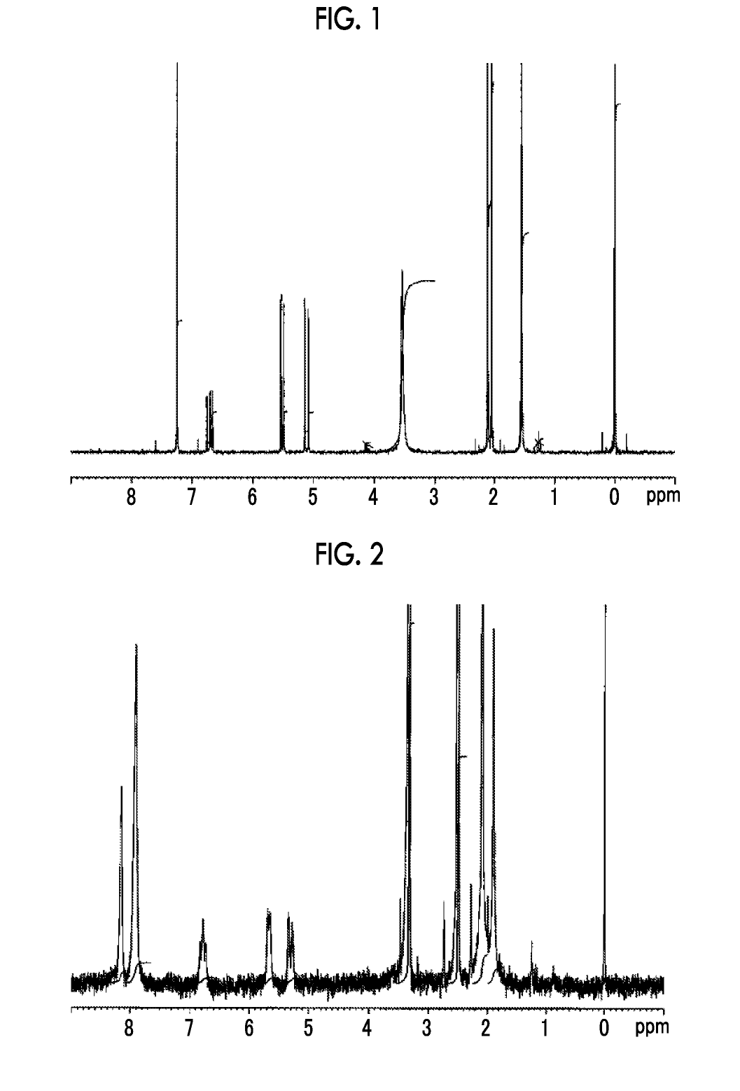

FIGS. 1 and 2 illustrate the form of making permeating gas to be rich in carbon dioxide by selective permeation of carbon dioxide from a mixed gas of carbon dioxide and methane.

The expression “on the upper side of the support layer” in the present specification means that another layer may be interposed between the support layer and the gas separation layer. Further, in regard to the expressions related to up and down, the side where gas to be separated is supplied is set as “up” and the side where the separated gas is discharged is set as “down” unless otherwise specified.

The gas separation composite membrane of the present invention may be obtained by forming and disposing a gas separation layer on a surface or internal surface of the porous support (support layer) or can be obtained by simply forming a gas separation layer on at least a surface thereof to form a composite membrane. By forming a gas separation layer on at least a surface of the porous support, a composite membrane with an advantage of having excellent gas separation selectivity, excellent gas permeability, and mechanical strength can be obtained. As the membrane thickness of the gas separation layer, it is preferable that the gas separation layer is as thin as possible under conditions of imparting excellent gas permeability while maintaining the mechanical strength and the separation selectivity.

In the gas separation composite membrane of the present invention, the thickness of the gas separation layer is not particularly limited, but is preferably in a range of 0.01 to 5.0 μm and more preferably in a range of 0.05 to 2.0 μm.

The porous support (porous layer) which is preferably applied to the support layer is not particularly limited as long as the porous support is used for the purpose of imparting the mechanical strength and the excellent gas permeability, and the porous support may be formed of either of an organic material and an inorganic material. Among these, a porous layer that contains an organic polymer is preferable. The thickness of the porous membrane is in a range of 1 to 3000 μm, preferably in a range of 5 to 500 μm, and more preferably in a range of 5 to 150 μm. The pore structure of this porous membrane has an average pore diameter of typically 10 μm or less, preferably 0.5 μm or less, and more preferably 0.2 μm or less. The porosity is preferably in a range of 20% to 90% and more preferably in a range of 30% to 80%.

Here, the support layer having the “gas permeability” means that the permeation rate of carbon dioxide is 1×10⁵ cm³ (STP)/cm²·sec·cmHg (10 GPU) or greater in a case where carbon dioxide is supplied to the support layer (membrane formed of only the support layer) by setting the temperature to 40° C. and the total pressure on the gas supply side to 4 MPa. Further, in regard to the gas permeability of the support layer, the permeation rate of carbon dioxide is preferably 3×10⁵ cm³ (STP)/cm²·sec·cmHg (30 GPU) or greater, more preferably 100 GPU or greater, and still more preferably 200 GPU or greater in a case where carbon dioxide is supplied by setting the temperature to 40° C. and the total pressure on the side to which gas is supplied to 4 MPa. Examples of the material of the porous membrane include conventionally known polymers, for example, a polyolefin-based resin such as polyethylene or polypropylene; a fluorine-containing resin such as polytetrafluoroethylene, polyvinyl fluoride, or polyvinylidene fluoride; and various resins such as polystyrene, cellulose acetate, polyurethane, polyacrylonitrile, polyphenylene oxide, polysulfone, polyether sulfone, polyimide, and polyaramid. As the shape of the porous membrane, any shape from among a flat plate shape, a spiral shape, a tabular shape, and a hollow fiber shape can be employed.

In the gas separation composite membrane of the present invention, it is preferable that a support is formed in the lower portion of the support layer that forms the gas separation layer for imparting mechanical strength. Examples of such a support include woven fabric, non-woven fabric, and a net. Among these, from the viewpoints of membrane forming properties and the cost, non-woven fabric is suitably used. As the non-woven fabric, fibers formed of polyester, polypropylene, polyacrylonitrile, polyethylene, and polyamide may be used alone or in combination of plural kinds thereof. The non-woven fabric can be produced by papermaking main fibers and binder fibers which are uniformly dispersed in water using a circular net or a long net and then drying the fibers with a dryer. Moreover, for the purpose of removing a nap or improving mechanical properties, it is preferable that thermal pressing processing is performed on the non-woven fabric by interposing the non-woven fabric between two rolls. The support layer of the gas separation composite membrane of the present invention is formed of a porous layer and non-woven fabric, and it is preferable that the gas separation layer, the porous layer, and the non-woven fabric layer are provided in this order. Further, in a case where the support layer is formed of a porous layer and a non-woven fabric layer, the thickness thereof is in a range of 1 to 3000 μm, preferably in a range of 5 to 500 μm, and more preferably in a range of 5 to 200 μm.

<Method of Producing Gas Separation Composite Membrane>

A method of producing the composite membrane of the present invention includes preferably coating the support with a composition containing the polyimide compound and a crosslinking agent with a specific structure and reacting the compound with the crosslinking agent to form a crosslinked structure.

In other words, the method of producing the composite membrane of the present invention includes coating the support with the composition for forming a gas separation layer which contains (A) and (B) described below to form a membrane and performing a heat treatment, irradiation with ultraviolet rays, a plasma treatment, an ozone treatment, or a corona treatment on the composition for forming a gas separation layer which has been applied to the coated membrane to react (A) with (B) so that a crosslinked structure is formed.

Polyimide compound (A) having structural portion represented by Formula (III)

Crosslinking agent (B) containing two or more groups selected from mercapto group, nitrile N oxide group, and azide group (—N₃) in molecule

It is preferable that the polyimide compound contained in (A) described above has a repeating unit represented by Formula (IV).

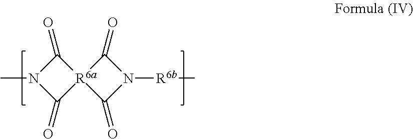

In Formula (IV), R^{6a} represents a tetravalent linking group, and R^{6b} represents a divalent linking group. Here, R^{6a} and/or R^{6b} has a structural portion represented by Formula (III).

In the compound represented by Formula (IV), it is preferable that R^{6b} has a structural portion represented by Formula (III). In this case, it is preferable that both of a10 and a11 in Formula (III) represent 1 and R^{5b} represents a hydrogen atom or a substituent.

In Formula (IV), it is preferable that R^{6a} represents a tetravalent group represented by any of Formulae (I-1) to (I-28), and the preferred forms are the same as described above in Formulae (I-1) to (I-28).

A compound represented by any of Formulae (V) to (VII) is preferable as the crosslinking agent (B).

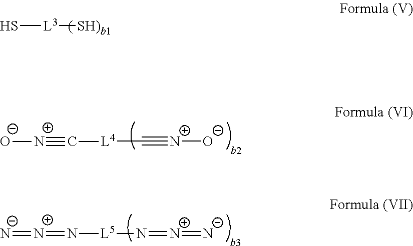

In Formulae (V) to (VII), L³ represents a (b+1)-valent linking group, L⁴ represents a (b2+1)-valent linking group, and L⁵ represents a (b3+1)-valent linking group.

All of b1 to b3 represent an integer of 1 or greater, preferably an integer of 1 to 20, more preferably an integer of 1 to 10, and still more preferably an integer of 1 to 4.

L³ to L⁵ each have a molecular weight of preferably 10 to 2000, more preferably 10 to 500, and still more preferably 10 to 200.

It is preferable that L³ to L⁵ represent a group formed by combining atoms selected from a carbon atom, an oxygen atom, a sulfur atom, a nitrogen atom, and a hydrogen atom or a salt thereof.

It is preferable that L³ to L⁵ represent a linking group represented by Formula (LA), (LB), or (LC).

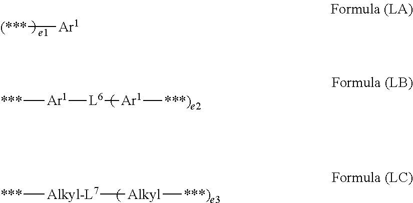

In Formulae (LA) and (LB), Ar¹ represents an aromatic ring. Ar¹ may represent an aromatic hydrocarbon ring or an aromatic heterocycle. Ar¹ represents preferably a monocyclic aromatic ring and more preferably a 5- or 6-membered aromatic ring.

e1 represents an integer of 2 or greater, more preferably an integer of 2 to 21, still more preferably an integer of 2 to 11, and still more preferably an integer of 2 to 5.

e2 represents an integer of 1 or greater, more preferably an integer of 1 to 20, still more preferably an integer of 1 to 10, and still more preferably an integer of 1 to 4.

L⁶ represents an (e2+1)-valent linking group. L⁶ has a molecular weight of preferably 10 to 1500 and more preferably 10 to 300. It is preferable that L⁶ represents a group formed by combining atoms selected from a carbon atom, an oxygen atom, a sulfur atom, a nitrogen atom, and a hydrogen atom or a salt thereof.

In Formula (LC), “Alkyl” represents an alkylene group. The number of carbon atoms of this alkylene group is preferably in a range of 1 to 10, more preferably in a range of 1 to 6, and still more preferably in a range of 1 to 3.

e3 represents an integer of 1 or greater, more preferably an integer of 1 to 20, still more preferably an integer of 1 to 10, and still more preferably an integer of 1 to 4.

L⁷ represents an (e3+1)-valent linking group. L⁷ has a molecular weight of preferably 10 to 1800 and more preferably 10 to 400. It is preferable that L⁷ represents a group formed by combining atoms selected from a carbon atom, an oxygen atom, a sulfur atom, a nitrogen atom, and a hydrogen atom or a salt thereof.

In each formula, the symbol “***” represents a linking site.

It is more preferable that the crosslinking agent (B) is a crosslinking agent containing two or more mercapto groups or nitrile N oxide groups in a molecule.

Preferred examples of the crosslinking agent (B) are described below, but the present invention is not limited to these.

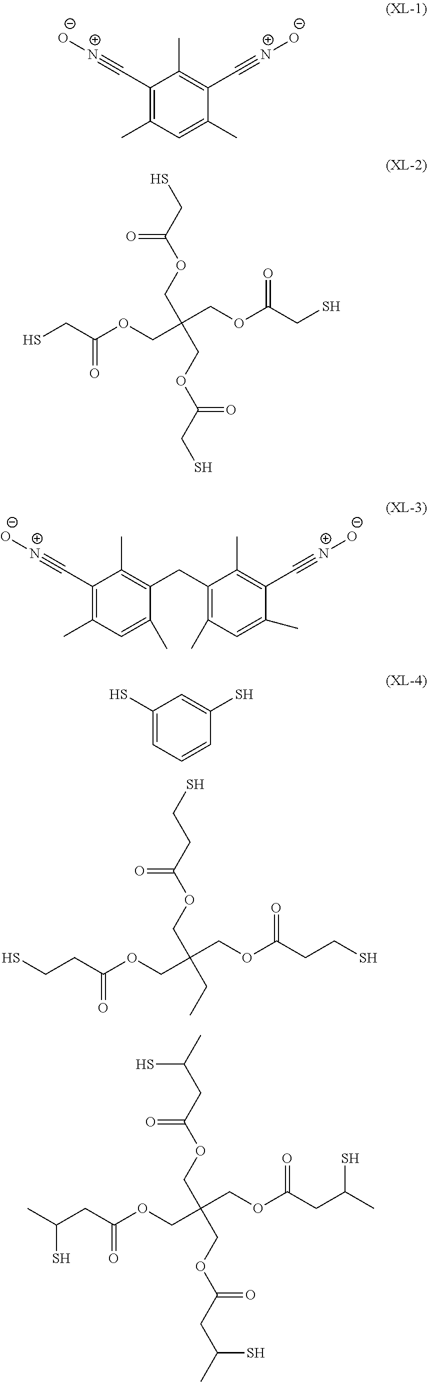

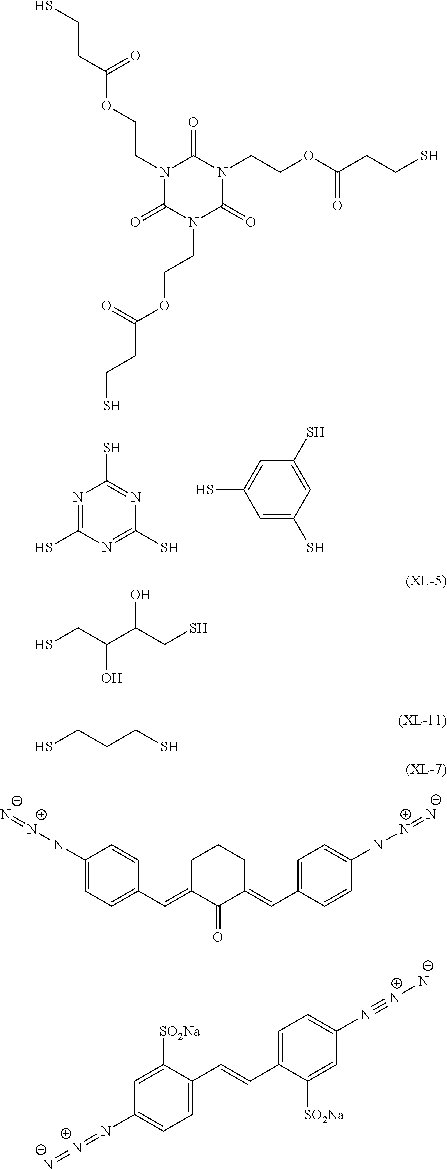

The composition for forming a gas separation layer that contains (A) and (B) described above typically contains a solvent. It is preferable that this solvent is capable of dissolving both of the polyimide (A) and the crosslinking agent (B). Such a solvent is not particularly limited, and examples thereof include a hydrocarbon such as n-hexane or n-heptane; an ester such as methyl acetate, ethyl acetate, or butyl acetate; an alcohol such as methanol, ethanol, n-propanol, isopropanol, n-butanol, isobutanol, or tert-butanol; an aliphatic ketone such as acetone, methyl ethyl ketone, methyl isobutyl ketone, diacetone alcohol, cyclopentanone, or cyclohexanone; an ether such as ethylene glycol, diethylene glycol, triethylene glycol, glycerin, propylene glycol, ethylene glycol monomethyl ether, ethylene glycol monoethyl ether, propylene glycol methyl ether, dipropylene glycol methyl ether, tripropylene glycol methyl ether, ethylene glycol phenyl ether, propylene glycol phenyl ether, diethylene glycol monomethyl ether, diethylene glycol monoethyl ether, diethylene glycol monobutyl ether, triethylene glycol monomethyl ether, triethylene glycol monoethyl ether, dibutyl butyl ether, tetrahydrofuran, methyl cyclopentyl ether, or dioxane; and N-methylpyrrolidone, 2-pyrrolidone, dimethylformamide, dimethylimidazolidinone, dimethyl sulfoxide, and dimethyl acetamide. These organic solvents are appropriately selected within the range that does not adversely affect the support through erosion or the like, and an ester (preferably butyl acetate), an alcohol (preferably methanol, ethanol, isopropanol, or isobutanol), an aliphatic ketone (preferably methyl ethyl ketone, methyl isobutyl ketone, diacetone alcohol, cyclopentanone, or cyclohexanone), and an ether (preferably ethylene glycol, diethylene glycol monomethyl ether, or methyl cyclopentyl ether) are preferable and an aliphatic ketone, an alcohol, and an ether are more preferable. Further, these may be used alone or in combination of two or more kinds thereof.

The content of the polyimide compound of the component (A) in the composition for forming a gas separation layer is not particularly limited, but is preferably in a range of 0.1% to 30% by mass and more preferably in a range of 0.5% to 10% by mass. In a case where the content of the polyimide compound is extremely small, defects are highly likely to occur in the surface layer contributing to separation because the composition easily permeates to the underlayer at the time of film formation on the porous support. In addition, in a case where the content of the polyimide compound is extremely high, there is a possibility that the permeability is degraded because holes are filled with the composition at a high concentration at the time of film formation on the porous support. The gas separation membrane of the present invention can be appropriately produced by adjusting the molecular weight, the structure, and the composition of the polymer of the separation layer and the viscosity of the solution.

Further, the ratio between the content of the component (A) and the content of the component (B) (the polyimide compound (A)/the crosslinking agent (B)) in terms of the mass ratio in the composition for forming a gas separation layer is preferably in a range of 1.5 to 20.0 and more preferably in a range of 2.5 to 5.0.

(Another Layer Between Support Layer and Gas Separation Layer)

In the gas separation composite membrane of the present invention, another layer may be present between the support layer and the gas separation layer. Preferred examples of another layer include a siloxane compound layer. By providing a siloxane compound layer, unevenness of the outermost surface of the support layer can be made to be smooth and the thickness of the gas separation layer is easily reduced. Examples of a siloxane compound that forms the siloxane compound layer include a compound in which the main chain is formed of polysiloxane and a compound having a siloxane structure and a non-siloxane structure in the main chain.

—Siloxane Compound Whose Main Chain is Formed of Polysiloxane—

As the siloxane compound which can be used for the siloxane compound layer and whose main chain is formed of polysiloxane, one or two or more kinds of polyorganopolysiloxanes represented by Formula (1) or (2) may be exemplified. Further, these polyorganopolysiloxanes may form a crosslinking reactant. As the crosslinking reactant, a compound in the form of the compound represented by Formula (1) being crosslinked by a polysiloxane compound having groups linked to each other by reacting with a reactive group X^{S} of Formula (1) at both terminals is exemplified.

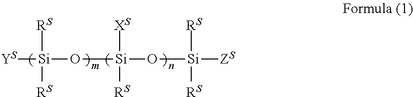

In Formula (1), R^{S} represents a non-reactive group. Specifically, it is preferable that R^{S} represents an alkyl group (an alkyl group having preferably 1 to 18 carbon atoms and more preferably 1 to 12 carbon atoms) or an aryl group (an aryl group having preferably 6 to 15 carbon atoms and more preferably 6 to 12 carbon atoms; and more preferably phenyl).

X^{S} represents a reactive group, and it is preferable that X^{S} represents a group selected from a hydrogen atom, a halogen atom, a vinyl group, a hydroxyl group, and a substituted alkyl group (an alkyl group having preferably 1 to 18 carbon atoms and more preferably 1 to 12 carbon atoms).

Y^{S} and Z^{S} are the same as R^{S} or X^{S} described above.

m represents a number of 1 or greater and preferably 1 to 100,000.

n represents a number of 0 or greater and preferably 0 to 100,000.

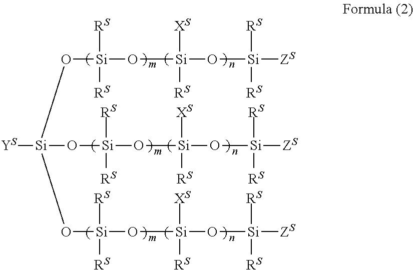

In Formula (2), X^{S}, Y^{S}, Z^{S}, R^{S}, m, and n each have the same definition as that for X^{S}, YS, Z^{S}, R^{S}, m, and n in Formula (1).

In Formulae (1) and (2), in a case where the non-reactive group R^{S} represents an alkyl group, examples of the alkyl group include methyl, ethyl, hexyl, octyl, decyl, and octadecyl. Further, in a case where the non-reactive group R represents a fluoroalkyl group, examples of the fluoroalkyl group include —CH₂CH₂CF₃, and —CH₂CH₂C₆F₁₃.

In Formulae (1) and (2), in a case where the reactive group X^{S} represents a substituted alkyl group, examples of the alkyl group include a hydroxyalkyl group having 1 to 18 carbon atoms, an aminoalkyl group having 1 to 18 carbon atoms, a carboxyalkyl group having 1 to 18 carbon atoms, a cycloalkyl group having 1 to 18 carbon atoms, a glycidoxyalkyl group having 1 to 18 carbon atoms, a glycidyl group, an epoxycyclohexylalkyl group having 7 to 16 carbon atoms, a (1-oxacyclobutane-3-yl)alkyl group having 4 to 18 carbon atoms, a methacryloxyalkyl group, and a mercaptoalkyl group.

The number of carbon atoms of the alkyl group constituting the hydroxyalkyl group is preferably an integer of 1 to 10, and examples of the hydroxyalkyl group include —CH₂CH₂CH₂OH.

The number of carbon atoms of the alkyl group constituting the aminoalkyl group is preferably an integer of 1 to 10, and examples of the aminoalkyl group include —CH₂CH₂CH₂NH₂.

The number of carbon atoms of the alkyl group constituting the carboxyalkyl group is preferably an integer of 1 to 10, and examples of the carboxyalkyl group include —CH₂CH₂CH₂COOH.

The number of carbon atoms of the alkyl group constituting the chloroalkyl group is preferably an integer of 1 to 10, and preferred examples of the chloroalkyl group include —CH₂Cl.

The number of carbon atoms of the alkyl group constituting the glycidoxyalkyl group is preferably an integer of 1 to 10, and preferred examples of the glycidoxyalkyl group include 3-glycidyloxypropyl.

The number of carbon atoms of the epoxycyclohexylalkyl group having 7 to 16 carbon atoms is preferably an integer of 8 to 12.

The number of carbon atoms of the (1-oxacyclobutane-3-yl)alkyl group having 4 to 18 carbon atoms is preferably an integer of 4 to 10.

The number of carbon atoms of the alkyl group constituting the methacryloxyalkyl group is preferably an integer of 1 to 10, and examples of the methacryloxyalkyl group include —CH₂CH₂CH₂—OOC—C(CH₃)═CH₂.

The number of carbon atoms of the alkyl group constituting the mercaptoalkyl group is preferably an integer of 1 to 10, and examples of the mercaptoalkyl group include —CH₂CH₂CH₂SH.

It is preferable that m and n represent a number in which the molecular weight of the compound is in a range of 5,000 to 1000,000.

In Formulae (1) and (2), distribution of a reactive group-containing siloxane unit (in the formulae, a constitutional unit whose number is represented by n) and a siloxane unit (in the formulae, a constitutional unit whose number is represented by m) which does not have a reactive group is not particularly limited. That is, in Formulae (1) and (2), the (Si(R^{S})(R^{S})—O) unit and the (Si(R^{S})(X^{S})—O) unit may be randomly distributed.

—Compound Having Siloxane Structure and Non-Siloxane Structure in Main Chain—

Examples of the compound which can be used for the siloxane compound layer and has a siloxane structure and a non-siloxane structure in the main chain include compounds represented by Formulae (3) to (7).

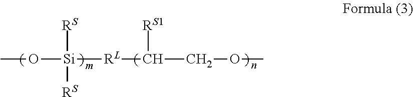

In Formula (3), R^{S}, m, and n each have the same definition as that for R^{S}, m, and n in Formula (1). R^{L} represents —O— or —CH₂— and R^{S1} represents a hydrogen atom or methyl. It is preferable that both terminals of Formula (3) are formed of an amino group, a hydroxyl group, a carboxy group, a trimethylsilyl group, an epoxy group, a vinyl group, a hydrogen atom, or a substituted alkyl group.

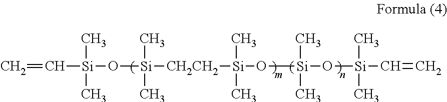

In Formula (4), m and n each have the same definition as that for m and n in Formula (1).

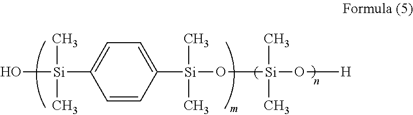

In Formula (5), m and n each have the same definition as that for m and n in Formula (1).

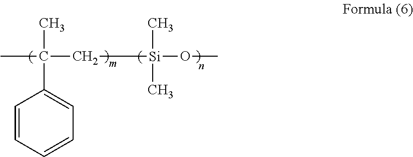

In Formula (6), m and n each have the same definition as that for m and n in Formula (1). It is preferable that both terminals of Formula (6) are bonded to an amino group, a hydroxyl group, a carboxy group, a trimethylsilyl group, an epoxy group, a vinyl group, a hydrogen atom, or a substituted alkyl group.

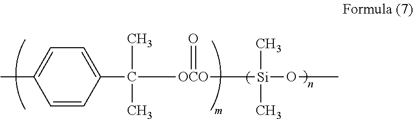

In Formula (7), m and n each have the same definition as that for m and n in Formula (1). It is preferable that both terminals of Formula (7) are bonded to an amino group, a hydroxyl group, a carboxy group, a trimethylsilyl group, epoxy, a vinyl group, a hydrogen atom, or a substituted alkyl group.

In Formulae (3) to (7), distribution of a siloxane structural unit and a non-siloxane structural unit may be randomly distributed.

It is preferable that the compound having a siloxane structure and a non-siloxane structure in the main chain contains 50% by mole or greater of the siloxane structural unit and more preferable that the compound contains 70% by mole or greater of the siloxane structural unit with respect to the total molar amount of all repeating structural units.

From the viewpoint of achieving the balance between durability and reduction in membrane thickness, the weight-average molecular weight of the siloxane compound used for the siloxane compound layer is preferably in a range of 5,000 to 1,000,000. The method of measuring the weight-average molecular weight is as described above.

Further, preferred examples of the siloxane compound constituting the siloxane compound layer are as follows.

Preferred examples thereof include one or two or more selected from organopolysiloxane, polydimethylsiloxane, polymethylphenylsiloxane, polydiphenylsiloxane, a polysulfone/polyhydroxystyrene/polydimethyl siloxane copolymer, a dimethylsiloxane/methylvinylsiloxane copolymer, a dimethylsiloxane/diphenylsiloxane-methylvinylsiloxane copolymer, a methyl-3,3,3-trifluoropropylsiloxane/methylvinylsiloxane copolymer, a dimethylsiloxane/methylphenylsiloxane/methylvinylsiloxane copolymer, a vinyl terminated diphenylsiloxane/dimethylsiloxane copolymer, vinyl terminated polydimethylsiloxane, H terminated polydimethylsiloxane, and a dimethylsiloxane/methylhydroxysiloxane copolymer. Further, these compounds also include the forms of forming crosslinking reactants.

In the composite membrane of the present invention, from the viewpoints of smoothness and gas permeability, the thickness of the siloxane compound layer is preferably in a range of 0.01 to 5 μm and more preferably in a range of 0.05 to 1 μm.

Further, the gas permeability of the siloxane compound layer at 40° C. and 4 MPa is preferably 100 GPU or greater, more preferably 300 GPU or greater, and still more preferably 1000 GPU or greater in terms of the permeation rate of carbon dioxide.

[Gas Separation Asymmetric Membrane]

The gas separation membrane of the present invention may be an asymmetric membrane. This asymmetric membrane can be formed according to a phase inversion method using the composition for forming a gas separation layer, and the gas separation membrane of the present invention in an asymmetric membrane form can be obtained by performing a heat treatment, irradiation with ultraviolet rays, a plasma treatment, an ozone treatment, or a corona treatment on the formed asymmetric membrane to react the component (A) with the component (B) described above so that a crosslinked structure is formed. The phase inversion method is a known method of allowing a polymer solution to be brought into contact with a coagulating liquid for phase inversion to form a membrane, and a so-called dry-wet method is suitably used in the present invention. The dry-wet method is a method of forming a porous layer by evaporating a solution on the surface of a polymer solution which is made to have a membrane shape to form a thin compact layer, immersing the compact layer in a coagulating liquid (a solvent which is compatible with a solvent of a polymer solution and in which a polymer is insoluble), and forming fine pores using a phase separation phenomenon that occurs at this time, and this method is suggested by Loeb and Sourirajan (for example, the specification of U.S. Pat. No. 3,133,132A).

In the gas separation asymmetric membrane of the present invention, the thickness of the surface layer contributing to gas separation, which is referred to as a compact layer or a skin layer, is not particularly limited, but is preferably in a range of 0.01 to 5.0 μm and more preferably in a range of 0.05 to 1.0 μm from the viewpoint of imparting practical gas permeability. In addition, the porous layer positioned in the lower portion of the compact layer plays a role of decreasing gas permeability resistance and imparting the mechanical strength at the same time, and the thickness thereof is not particularly limited as long as self-supporting properties as an asymmetric membrane are imparted, but is preferably in a range of 5 to 500 μm, more preferably in a range of 5 to 200 μm, and still more preferably in a range of 5 to 100 μm.

The gas separation asymmetric membrane of the present invention may be a flat membrane or a hollow fiber membrane. An asymmetric hollow fiber membrane can be produced by a dry-wet spinning method. The dry-wet spinning method is a method of producing an asymmetric hollow fiber membrane by applying a dry-wet method to a polymer solution which is discharged from a spinning nozzle in a target shape which is a hollow fiber shape. More specifically, the dry-wet spinning method is a method in which a polymer solution is discharged from a nozzle in a target shape which is a hollow fiber shape and passes through air or a nitrogen gas atmosphere immediately after the discharge. Thereafter, an asymmetric structure is formed through immersion in a coagulating liquid which does not substantially dissolve a polymer and is compatible with a solvent of the polymer solution. Further, the membrane is dried and subjected to a heat treatment as necessary, thereby producing a separation membrane.

The solution viscosity of the composition for forming a gas separation layer to be discharged from a nozzle is in a range of 2 to 17000 Pa-s, preferably 10 to 1500 Pa-s, and particularly preferably in a range of 20 to 1000 Pa·s at the discharge temperature (for example, 10° C.) from a viewpoint of stably obtaining the shape after the discharge such as a hollow fiber shape or the like. It is preferable that immersion of a membrane in a coagulating liquid is carried out by immersing the membrane in a primary coagulating liquid to be solidified to the extent that the shape of a membrane such as a hollow fiber shape can be maintained, winding the membrane around a guide roll, immersing the membrane in a secondary coagulating liquid, and sufficiently solidifying the whole membrane. It is effective that the solidified membrane is dried after the coagulating liquid is substituted with a solvent such as hydrocarbon. It is preferable that the heat treatment for drying the membrane is performed at a temperature lower than the softening point or the secondary transition point of the used polyimide compound.

[Use and Properties of Gas Separation Membrane]

The gas separation membrane (the composite membrane and the asymmetric membrane) of the present invention can be suitably used according to a gas separation recovery method and a gas separation purification method. For example, a gas separation membrane which is capable of efficiently separating specific gas from a gas mixture containing gas, for example, hydrocarbon such as hydrogen, helium, carbon monoxide, carbon dioxide, hydrogen sulfide, oxygen, nitrogen, ammonia, a sulfur oxide, a nitrogen oxide, methane, or ethane; unsaturated hydrocarbon such as propylene; or a perfluoro compound such as tetrafluoroethane can be obtained. Particularly, it is preferable that a gas separation membrane selectively separating carbon dioxide from a gas mixture containing carbon dioxide and hydrocarbon (methane) is obtained.

In addition, in a case where gas subjected to a separation treatment is a mixed gas of carbon dioxide and methane, the permeation rate of the carbon dioxide at 40° C. and 5 MPa is preferably 20 GPU or greater, more preferably 30 GPU or greater, and still more preferably in a range of 35 GPU to 500 GPU. The ratio between permeation rates of carbon dioxide and methane (R_{CO2}/R_{CH4}) is preferably 15 or greater, and more preferably 20 or greater. R_{CO2} represents the permeation rate of carbon dioxide and R_{CH4} represents the permeation rate of methane.

Further, 1 GPU is 1×10⁻⁶ cm³ (STP)/cm²·cm·sec·cmHg.

[Other Components and the Like]

Various polymer compounds can also be added to the gas separation layer of the gas separation membrane of the present invention in order to adjust the physical properties of the membrane. As the polymer compounds, an acrylic polymer, a polyurethane resin, a polyamide resin, a polyester resin, an epoxy resin, a phenol resin, a polycarbonate resin, a polyvinyl butyral resin, a polyvinyl formal resin, shellac, a vinyl-based resin, an acrylic resin, a rubber-based resin, waxes, and other natural resins can be used. Further, these may be used in combination of two or more kinds thereof.

Further, a non-ionic surfactant, a cationic surfactant, or an organic fluoro compound can be added to the gas separation membrane of the present invention in order to adjust the physical properties of the liquid.

Specific examples of the surfactant include anionic surfactants such as alkyl benzene sulfonate, alkyl naphthalene sulfonate, higher fatty acid salts, sulfonate of higher fatty acid ester, sulfuric ester salts of higher alcohol ether, sulfonate of higher alcohol ether, alkyl carboxylate of higher alkyl sulfonamide, and alkyl phosphate; non-ionic surfactants such as polyoxyethylene alkyl ether, polyoxyethylene alkyl phenyl ether, polyoxyethylene fatty acid ester, sorbitan fatty acid ester, an ethylene oxide adduct of acetylene glycol, an ethylene oxide adduct of glycerin, and polyoxyethylene sorbitan fatty acid ester; and amphoteric surfactants such as alkyl betaine and amide betaine; a silicon-based surfactant; and a fluorine-based surfactant, and the surfactant can be suitably selected from known surfactants and derivatives thereof in the related art.

Further, a polymer dispersant may be included, and specific examples of the polymer dispersant include polyvinyl pyrrolidone, polyvinyl alcohol, polyvinyl methyl ether, polyethylene oxide, polyethylene glycol, polypropylene glycol, and polyacrylamide. Among these, polyvinyl pyrrolidone is preferably used.

The conditions of forming the gas separation membrane of the present invention are not particularly limited. The temperature thereof is preferably in a range of −30° C. to 100° C., more preferably in a range of −10° C. to 80° C., and particularly preferably in a range of 5° C. to 50° C.

In the present invention, gas such as air or oxygen may be allowed to coexist during membrane formation, and it is desired that the membrane is formed under an inert gas atmosphere.

In the gas separation membrane of the present invention, the content of the polyimide compound in the gas separation layer is not particularly limited as long as desired gas separation performance can be obtained. From the viewpoint of further improving gas separation performance, the content of the polyimide compound in the gas separation layer is preferably 20% by mass or greater, more preferably 40% by mass or greater, still more preferably 60% by mass or greater, and particularly preferably 70% by mass or greater. Further, the content of the polyimide compound in the gas separation layer may be 100% by mass and is typically 99% by mass or less.

[Method of Separating Gas Mixture]

The gas separation method of the present invention is a method of separating specific gas from a mixed gas containing two or more components using the gas separation membrane of the present invention. The gas separation method of the present invention is a method that includes selectively permeating carbon dioxide from the mixed gas containing carbon dioxide and methane. The gas pressure at the time of gas separation is preferably in a range of 0.5 MPa to 10 MPa, more preferably in a range of 1 MPa to 10 MPa, and still more preferably in a range of 2 MPa to 7 MPa. Further, the temperature for separating gas is preferably in a range of −30° C. to 90° C. and more preferably in a range of 15° C. to 70° C. In the mixed gas containing carbon dioxide and methane gas, the mixing ratio of carbon dioxide to methane gas is not particularly limited. The mixing ratio thereof (carbon dioxide:methane gas) is preferably in a range of 1:99 to 99:1 (volume ratio) and more preferably in a range of 5:95 to 90:10.

[Gas Separation Module and Gas Separator]

A gas separation membrane module can be prepared using the gas separation membrane of the present invention. Examples of the module include a spiral type module, a hollow fiber type module, a pleated module, a tubular module, and a plate and frame type module.

Moreover, it is possible to obtain a gas separator having means for performing separation and recovery of gas or performing separation and purification of gas by using the gas separation composite membrane of the present invention or the gas separation membrane module. The gas separation composite membrane of the present invention may be applied to a gas separation and recovery device which is used together with an absorption liquid described in JP2007-297605A according to a membrane/absorption hybrid method.

### EXAMPLES

Hereinafter, the present invention will be described in detail with reference to examples, but the present invention is not limited these examples.

### Synthesis Example

All constitutional units of polyimide compounds synthesized in the following synthesis examples are shown below. In each polyimide compound, a to d represent a molar ratio of each constitutional unit shown below. The symbol “*” represents a linking site.

In the following synthesis examples, P-101 to P-105 represent polyimide obtained by setting the molar ratio of each constitutional unit in P-100 to the ratio as listed in Table 1.

Further, P-201, P-301, P-401, P-501, C-101, and C-201 represent polyimide obtained by setting the molar ratio of each constitutional unit in P-200, P-300, P-400, P-500, C-100, and C-200 to the ratio as listed in Table 1.

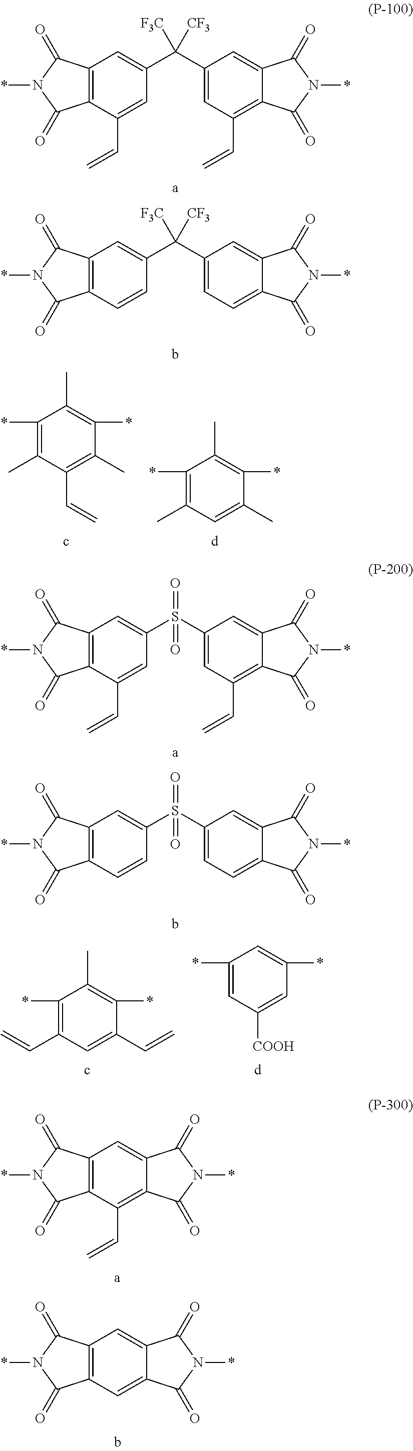

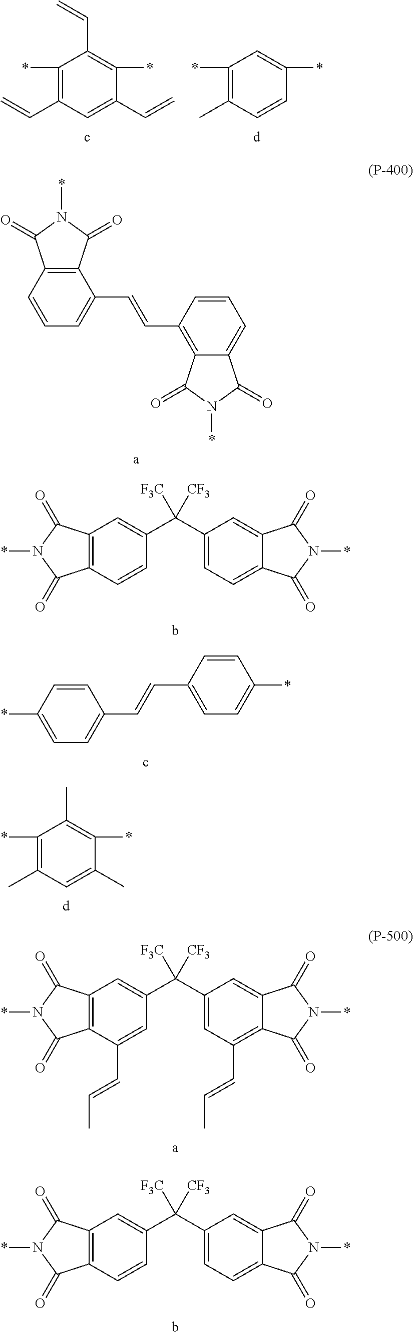

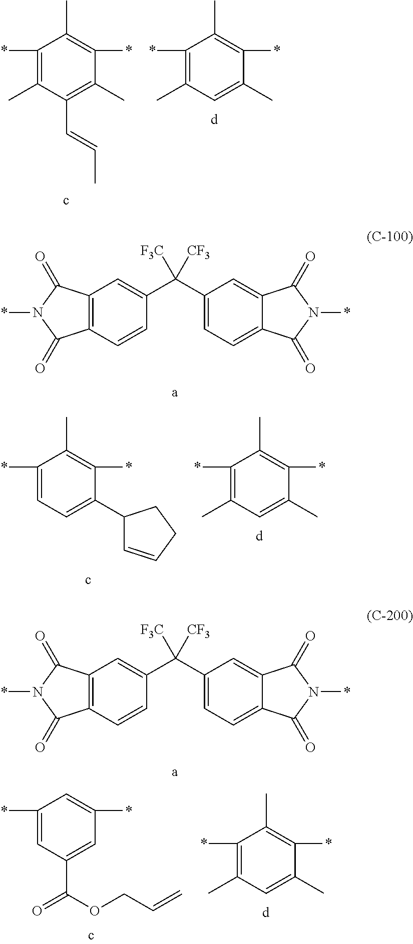

[Synthesis of Polyimide P-101]

A diamine 1 was synthesized according to the following scheme and then polyimide P-101 formed of the following repeating unit was synthesized.

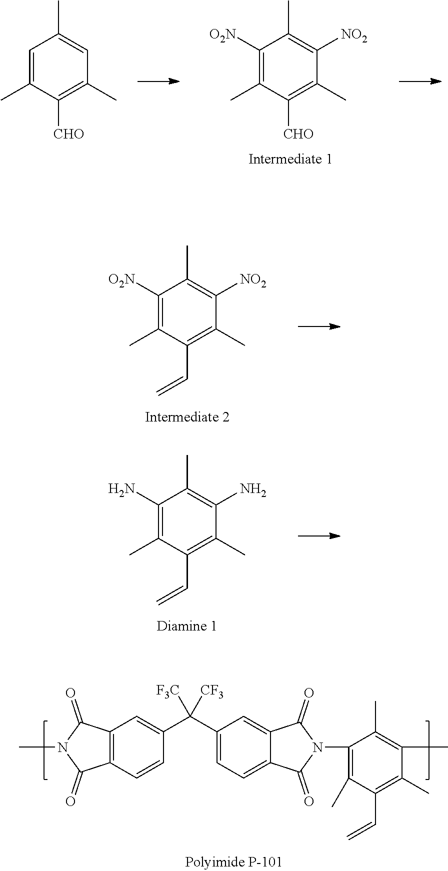

<Synthesis of Intermediate 1>

Sulfuric acid (manufactured by Wako Pure Chemical Industries, Ltd.) (100 ml) was added to a 1 L flask and nitric acid (1.42, manufactured by Wako Pure Chemical Industries, Ltd.) (100 ml) and 2,4,6-trimethylbenzaldehyde (manufactured by Tokyo Chemical Industry Co., Ltd.) (22.5 g) was carefully added dropwise thereto under an ice cooling condition for a reaction at room temperature for 6 hours. The reaction solution was poured into ice water and purified, thereby obtaining an intermediate 1 (35 g).

<Synthesis of Intermediate 2>

Toluene (manufactured by Wako Pure Chemical Industries, Ltd.) (250 ml) and the intermediate 1 (30 g) were added to a 100 mL flask. A Tebbe's reagent (approximately 0.5 mol/L toluene solution, manufactured by Tokyo Chemical Industry Co., Ltd.) (250 ml) was carefully added dropwise thereto under an ice cooling condition for a reaction for 1 hour. The reaction solution was concentrated and purified, thereby obtaining an intermediate 2 (30 g).

<Synthesis of Diamine 1>

Reduced iron (manufactured by Wako Pure Chemical Industries, Ltd.) (40 g), ammonium chloride (manufactured by Wako Pure Chemical Industries, Ltd.) (4 g), isopropanol (manufactured by Wako Pure Chemical Industries, Ltd.) (200 mL), and water (50 mL) were added to a 1 L flask and heated and refluxed for 10 minutes. Acetic acid (manufactured by Wako Pure Chemical Industries, Ltd.) (4 mL) and the intermediate 2 (30 g) were added thereto and heated and refluxed for 30 minutes. The reaction solution was concentrated and purified, thereby obtaining a diamine 1 (9 g). The results of 1H NMR (deuterated solvent: DMSO-d6) of the diamine 1 are shown in FIG. 1.

<Synthesis of Polyimide P-101>

N-methylpyrrolidone (manufactured by Wako Pure Chemical Industries, Ltd.) (70 g), the diamine 1 (5.289 g), and 6FDA (4,4′-(hexafluoroisopropylidene)diphthalic anhydride) (manufactured by Tokyo Chemical Industry Co., Ltd.) (13.33 g) were added to a 300 mL flask for a reaction at 40° C. for 6 hours. Next, pyridine (manufactured by Wako Pure Chemical Industries, Ltd.) (0.71 g) and acetic anhydride (manufactured by Wako Pure Chemical Industries, Ltd.) (10 g) were added thereto for a reaction at 80° C. for 3 hours. After the reaction solution was cooled, the reaction solution was diluted with acetone (manufactured by Wako Pure Chemical Industries, Ltd.), and methanol (manufactured by Wako Pure Chemical Industries, Ltd.) was added to the solution to obtain a polymer as a solid. The same re-precipitation was repeated twice, and the resultant was dried at 80° C., thereby obtaining polyimide P-101 (16 g).

The results of 1H NMR (deuterated solvent: DMSO-d6) of the polyimide P-101 are shown in FIG. 2.

[Synthesis of Polyimide P-201]

A diamine 2 was synthesized according to the following scheme and then polyimide P-201 formed of the following repeating unit was synthesized.

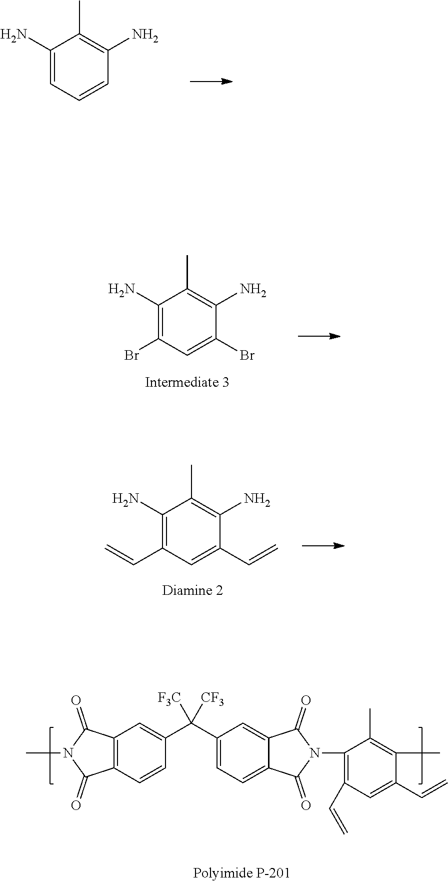

<Synthesis of Intermediate 3>

1,3-Diaminotoluene (manufactured by Wako Pure Chemical Industries, Ltd.) (30 g), acetic acid (manufactured by Wako Pure Chemical Industries, Ltd.) (240 ml), and hydrochloric acid (manufactured by Wako Pure Chemical Industries, Ltd.) (36 ml) were added to a 1 L flask, bromine (manufactured by Tokyo Chemical Industry Co., Ltd.) (86 g) was carefully added dropwise thereto under an ice cooling condition for a reaction for 1 hour. The reaction solution was poured into water and purified, thereby obtaining an intermediate 3 (60 g).

<Synthesis of Diamine 2>

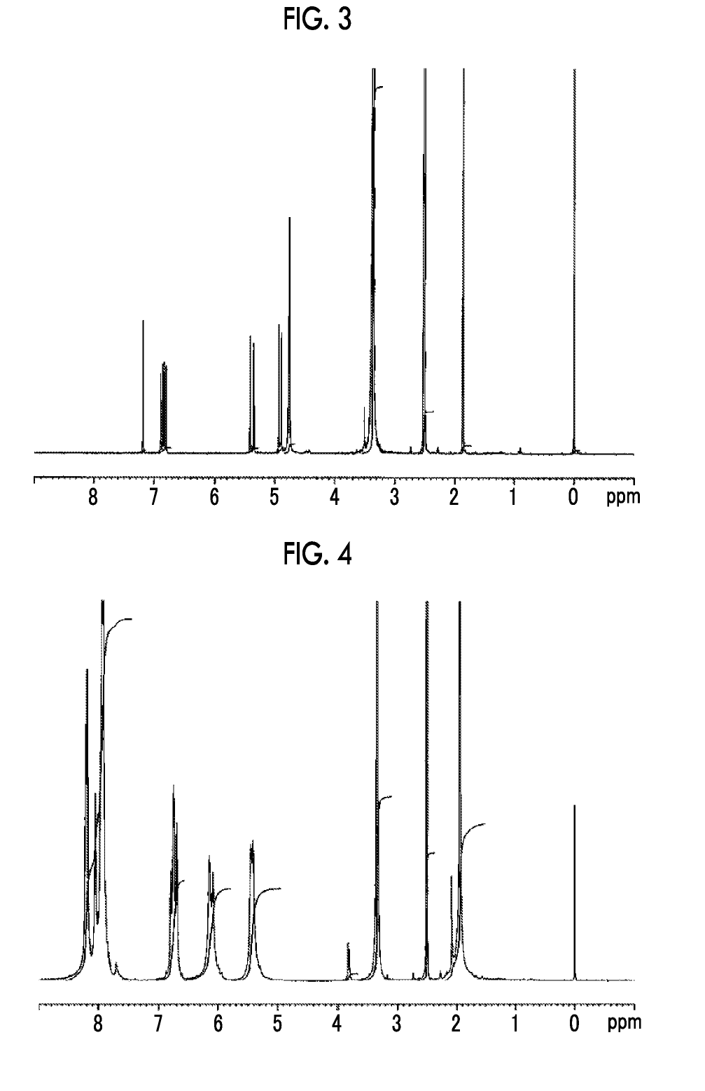

The intermediate 3 (20 g), dimethyl formamide (manufactured by Wako Pure Chemical Industries, Ltd.) (120 ml), lithium chloride (manufactured by Wako Pure Chemical Industries, Ltd.) (4 g), tris(dibenzylideneacetone)dipalladium (0) (manufactured by Tokyo Chemical Industry Co., Ltd.) (0.7 g), 2-dicyclohexylphosphino-2′,6′-dimethoxybiphenyl (manufactured by Sigma-Aldrich Co., LLC.) (1 g), and tributyl vinyl tin (manufactured by Tokyo Chemical Industry Co., Ltd.) (50 mL) were added to a 500 mL flask for a reaction at 80° C. for 2 hours. The reaction solution was concentrated and purified, thereby obtaining a diamine 2 (4 g). The results of 1H NMR (deuterated solvent: DMSO-d6) of the diamine 2 are shown in FIG. 3.

<Synthesis of Polyimide P-201>

Polyimide P-201 was obtained in the same manner as in the synthesis of the polyimide P-101. The results of 1H NMR (deuterated solvent: DMSO-d6) of the polyimide P-201 are shown in FIG. 4.

[Synthesis of Polyimide P-301]

Polyimide P-301 formed of the following repeating unit was synthesized according to the following scheme.

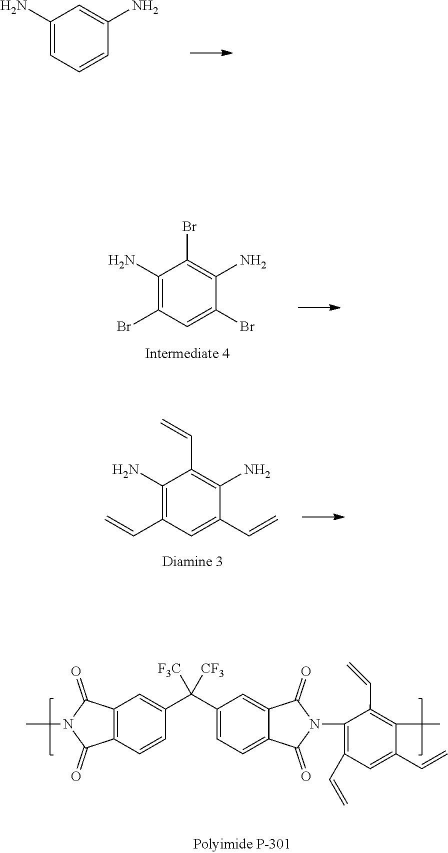

<Synthesis of Intermediate 4>

m-Phenylenediamine (manufactured by Wako Pure Chemical Industries, Ltd.), (30 g), acetic acid (manufactured by Wako Pure Chemical Industries, Ltd.) (400 ml), and hydrochloric acid (manufactured by Wako Pure Chemical Industries, Ltd.) (60 ml) were added to a 1 L flask, bromine (manufactured by Tokyo Chemical Industry Co., Ltd.) (150 g) was carefully added dropwise thereto under an ice cooling condition for a reaction for 1 hour. The reaction solution was poured into water and purified, thereby obtaining an intermediate 4 (42 g).

<Synthesis of Diamine 3>

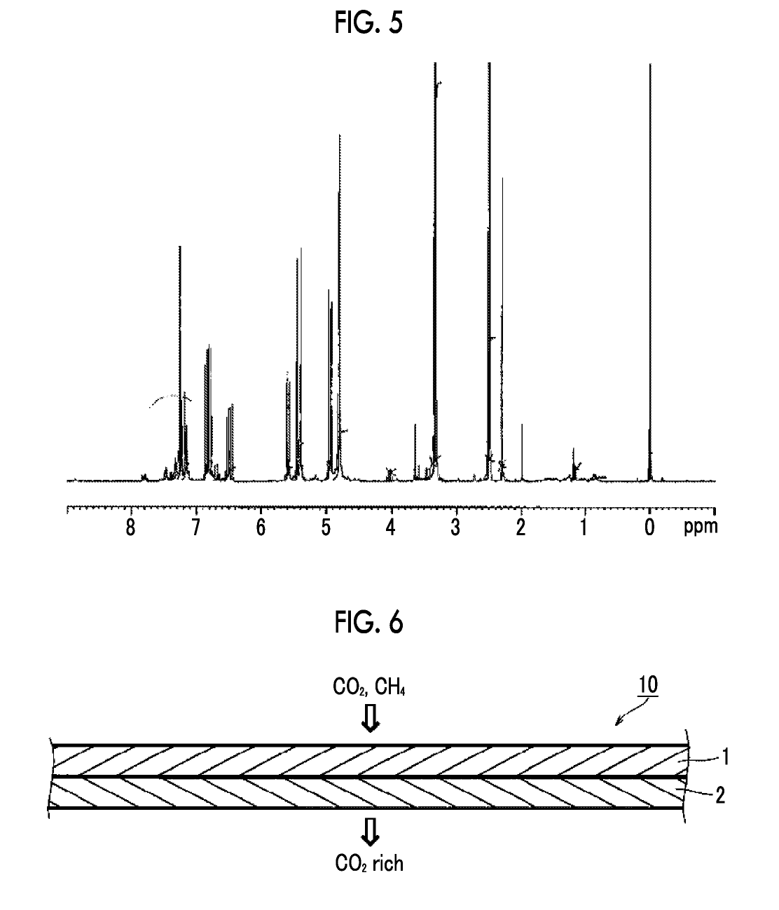

The intermediate 4 (14 g), dimethyl formamide (manufactured by Wako Pure Chemical Industries, Ltd.) (120 ml), lithium chloride (manufactured by Wako Pure Chemical Industries, Ltd.) (4 g), tris(dibenzylideneacetone)dipalladium (0) (manufactured by Tokyo Chemical Industry Co., Ltd.) (0.7 g), 2-dicyclohexylphosphino-2′,6′-dimethoxybiphenyl (manufactured by Sigma-Aldrich Co., LLC.) (1 g), and tributyl vinyl tin (manufactured by Tokyo Chemical Industry Co., Ltd.) (50 mL) were added to a 500 mL flask for a reaction at 80° C. for 2 hours. The reaction solution was concentrated and purified, thereby obtaining a diamine 3 (2 g). The results of 1H NMR (deuterated solvent: DMSO-d6) of the diamine 3 are shown in FIG. 5.

<Synthesis of Polyimide P-301>

Polyimide P-301 was obtained in the same manner as in the synthesis of the polyimide P-101.

[Synthesis of Polyimides P-102 to P-105, P-202, P-401, P-501, and C-201]

Monomers to be used were changed as listed in Table 1, and polyimides P-102 to P-105, P-202, P-401, P-501, and C-201 were synthesized in the same manner as in the synthesis of the polyimides P-101, P-201, and P-301.

[Synthesis of Polyimide C-101]

After a polyamide solution was synthesized in the same manner as in Example 5 of JP1991-127616A (JP-H03-127616A), the solution was allowed to react at 180° C. for 3 hours. After the reaction solution was cooled, the reaction solution was diluted with acetone (manufactured by Wako Pure Chemical Industries, Ltd.), and methanol (manufactured by Wako Pure Chemical Industries, Ltd.) was added to the solution to obtain a polymer as a solid. The same re-precipitation was repeated twice, and the resultant was dried at 80° C., thereby obtaining polyimide C-101.

### [Example 1] Preparation of Composite Membrane

<Preparation of PAN Porous Membrane Provided with Smooth Layer>

(Preparation of Radiation-Curable Polymer Containing Dialkylsiloxane Group)

39 g of UV9300 (manufactured by Momentive Performance Materials Inc.), 10 g of X-22-162C (manufactured by Shin-Etsu Chemical Co, Ltd.), and 0.007 g of DBU (1,8-diazabicyclo[5.4.0]undeca-7-ene) were added to a 150 mL three-neck flask and dissolved in 50 g of n-heptane. The state of the solution was maintained at 950 for 168 hours, thereby obtaining a radiation-curable polymer solution (viscosity at 25° C. was 22.8 mPa·s) containing a poly(siloxane) group.

(Preparation of Polymerizable Radiation-Curable Composition)

5 g of the obtained radiation-curable polymer solution was cooled to 20° C. and diluted with 95 g of n-heptane. 0.5 g of UV9380C (manufactured by Momentive Performance Materials Inc.) serving as a photopolymerization initiator and 0.1 g of ORGATIX TA-10 (manufactured by Matsumoto Fine Chemical Co., Ltd.) were added to the obtained solution, thereby preparing a polymerizable radiation-curable composition.

(Coating of Porous Support with Polymerizable Radiation-Curable Composition and Formation of Smooth Layer)

The polyacrylonitrile (PAN) porous membrane (the polyacrylonitrile porous membrane was present on the non-woven fabric, the membrane thickness including the thickness of the non-woven fabric was approximately 180 μm) was used as the support and spin-coated with the polymerizable radiation-curable composition, subjected to a UV treatment (Light Hammer 10, D-valve, manufactured by Fusion UV System, Inc.) under UV treatment conditions of a UV intensity of 24 kW/m for a treatment time of 10 seconds, and then dried. In this manner, a smooth layer containing a dialkylsiloxane group and having a thickness of 1 μm was formed on the porous support.

<Preparation of Composite Membrane>

A gas separation composite membrane illustrated in FIG. 7 was prepared (a smooth layer is not illustrated in FIG. 7).

0.08 g of the polyimide P-101, 0.024 g of XL-1 (manufactured by Sigma-Aldrich Co., LLC.) as a crosslinking agent, and 7.92 g of tetrahydrofuran were mixed in a 30 ml brown vial bottle and then stirred for 30 minutes, thereby preparing a composition for forming a gas separation layer. The PAN porous membrane to which the smooth layer was imparted was spin-coated with the composition for forming a gas separation layer. The thickness of the formed polyimide P-101 layer was approximately 100 nm, and the thickness of the polyacrylonitrile porous membrane including the non-woven fabric was approximately 180 m.

Further, a polyacrylonitrile porous membrane having a molecular weight cutoff of 100,000 or less was used. Further, the carbon dioxide permeability of the porous membrane at 40° C. and 5 MPa was 25000 GPU.

(Heat Crosslinking Treatment)

The composite membrane was put into a blast dryer at 90° C. and aged for 7 days to proceed the crosslinking reaction, thereby obtaining a gas separation composite membrane including a gas separation layer formed of a crosslinked polyimide compound.

### Example 2

A composite membrane was prepared in the same manner as in Example 1 by preparing the crosslinking agent used in the composition for forming a gas separation layer as listed in Table 1 and performing the crosslinking treatment as listed in Table 1, in Example 1.

The crosslinking reaction in Example 2 was carried out by performing the following plasma treatment.

—Plasma Crosslinking Treatment—

The entire support having the membrane formed of the composition for forming a gas separation layer was put into a desktop vacuum plasma device (manufactured by U-TEC Corporation), and a plasma treatment was performed thereon under carrier gas conditions of an oxygen flow rate of 20 cm³ (STP)/min, an argon flow rate of 100 cm³ (STP)/min, a vacuum degree of 30 Pa, an input power of 100 W, and a treatment time of 20 seconds to proceed the crosslinking reaction.

### Examples 3 to 15 and Comparative Example 1 to 4

Each composite membrane was prepared in the same manner as in Example 1 by preparing polyimide used in the composition for forming a gas separation layer as listed in Table 1 and preparing the crosslinking agent and the crosslinking treatment as listed in the following table.

In addition, a UV crosslinking treatment in Comparative Example 2 is a treatment of performing irradiation with UV for 5 minutes using the method described in JP1991-127616A (JP-H03-127616A).

### Comparative Examples 5 and 6

Comparative Example 5 is an example in which a gas separation layer was formed using the polyimide compound P-101 which did not have a crosslinked structure.

Comparative Example 6 is an example in which a crosslinked structure was formed by performing radical polymerization on the polyimide compound P-101 constituting the gas separation layer without using a crosslinking agent. CXL-1 is a radical polymerization initiator. Further, the density of the crosslinking point in Comparative Example 6 listed in Table 1 is the density of a radically polymerized vinyl group.

In each example and each comparative example, the structures of the polyimide compounds or the crosslinked polyimide compounds constituting the gas separation layer are collectively listed in Table 1. In Table 1, the density of the crosslinking point of the crosslinked polyimide was determined as described below.

300 MHz 1H NMR (deuterated solvent: DMSO-d6) of the polyimide compound before crosslinking was measured using mesitylene (manufactured by Tokyo Chemical Industry Co., Ltd.) as an internal standard, and the density d_{VINYL} [mmol/g] of the vinyl group in the polyimide compound before crosslinking was calculated.

Next, the peak integrated value (C═C—H bending variation band at 1322 cm⁻¹ is typically used, and the peak position varies due to the substituent in some cases) of the vinyl group in the polyimide compound before crosslinking and the peak integrated value of the vinyl group in the polyimide compound after crosslinking were respectively calculated by performing RT-IR measurement (FT-IR Nicolet 670, manufactured by Thermo Fisher Scientific Inc., ATR-IR), and a reaction rate R_{VINYL} [%] of the vinyl group was calculated using the following equation.

R_{VINYL} [%]={(peak integrated value of vinyl group before crosslinking)−(peak integrated value of vinyl group after crosslinking)}/(peak integrated value of vinyl group before crosslinking)×100

Next, the density of the crosslinking point of the crosslinked polyimide was calculated using the following equation.

Density of crosslinking point [mmol/g]=d_{VINYL} [mmol/g]×R_{VINYL} [%]×100

Further, the density of the crosslinking point in the crosslinked polyimide compound can be determined by measuring the density of a C—S—C bond, a C═N—O bond, or an N═N—N bond in the crosslinked polyimide compound according to Raman spectroscopy or X-ray photoelectron spectroscopy (XPS).

TABLE 1

| | | | | | | | | | | | Density of |
|---|---|---|---|---|---|---|---|---|---|---|---|
| | | Molar ratio of | | | | | Crosslinking agent | | | | crosslinking |
| | | constitutional unit | | | | | | Addition amount with | | | point of |
| | | Acid | | | | Weight-average | | respect to 100 parts by | Crosslinking treatment | | crosslinked |
| | | anhydride | | Diamine | | molecular | | mass of polyimide | Treatment | | polyimide |
| | Polyimide | a | b | C | d | weight | Type | (parts by mass) | method | Conditions | (mmol/g) |
| Example 1 | P-101 | 0 | 100 | 100 | 0 | 86000 | XL-1 | 30 | Heat | 90° C., 7 day | 1.3 |
| Example 2 | P-101 | 0 | 100 | 100 | 0 | 86000 | XL-1 | 15 | Vacuum | 100 W, 20 sec. | 0.9 |
| | | | | | | | | | plasma | | |
| Example 3 | P-101 | 0 | 100 | 100 | 0 | 86000 | XL-2 | 10 | Heat | 90° C., 4 day | 0.7 |
| Example 4 | P-102 | 100 | 0 | 0 | 100 | 92000 | XL-3 | 30 | Heat | 90° C., 7 day | 1.4 |
| Example 5 | P-103 | 100 | 0 | 100 | 0 | 85000 | XL-4 | 50 | Heat | 90° C., 7 day | 3.0 |
| Example 6 | P-104 | 0 | 100 | 60 | 40 | 111000 | XL-1 | 30 | Heat | 90° C., 7 day | 1.0 |
| Example 7 | P-105 | 0 | 100 | 20 | 80 | 104000 | XL-1 | 30 | Heat | 90° C., 7 day | 0.3 |
| Example 8 | P-101 | 0 | 100 | 100 | 0 | 86000 | XL-5 | 30 | Heat | 90° C., 7 day | 0.6 |
| Example 9 | P-101 | 0 | 100 | 100 | 0 | 86000 | XL-6 | 30 | Heat | 90° C., 7 day | 0.6 |
| Example 10 | P-101 | 0 | 100 | 100 | 0 | 86000 | XL-7 | 30 | Heat | 90° C., 7 day | 0.4 |
| Example 11 | P-201 | 0 | 100 | 100 | 0 | 110000 | XL-1 | 30 | Heat | 90° C., 10 day | 2.3 |
| Example 12 | P-202 | 50 | 50 | 50 | 50 | 107000 | XL-1 | 30 | Heat | 90° C., 5 day | 2.3 |
| Example 13 | P-301 | 50 | 50 | 50 | 50 | 105000 | XL-1 | 30 | Heat | 90° C., 5 day | 0.9 |
| Example 14 | P-401 | 50 | 50 | 50 | 50 | 95000 | XL-1 | 30 | Heat | 90° C., 5 day | 0.3 |
| Example 15 | P-501 | 50 | 50 | 50 | 50 | 165000 | XL-1 | 30 | Heat | 90° C., 5 day | 0.3 |
| Comparative | C-101 | 100 | 0 | 50 | 50 | 99000 | | | | | 0.0 |
| Example 1 | | | | | | | | | | | |
| Comparative | C-101 | 100 | 0 | 50 | 50 | 99000 | | | UV | 5 min. | 0.0 |
| Example 2 | | | | | | | | | | | |
| Comparative | C-101 | 100 | 0 | 50 | 50 | 99000 | XL-1 | 30 | Heat | 90° C., 7 day | 0.1 |
| Example 3 | | | | | | | | | | | |
| Comparative | C-201 | 100 | 0 | 50 | 50 | 75000 | XL-2 | 30 | Heat | 90° C., 7 day | 0.1 |
| Example 4 | | | | | | | | | | | |
| Comparative | P-101 | 0 | 100 | 100 | 0 | 86000 | | | | | 0.0 |
| Example 5 | | | | | | | | | | | |
| Comparative | P-101 | 0 | 100 | 100 | 0 | 86000 | CXL-1 | 30 | Heat | 90° C., 7 day | 0.2 |
| Example 6 | | | | | | | | | | | |

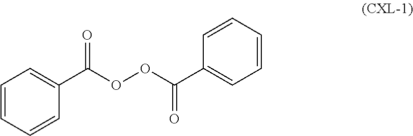 [SMILES: O=C(OOC(=O)c1ccccc1)c1ccccc1]

### Test Example 1

Measurement of toluene swelling ratio (weight change rate after exposure for 12 hours in toluene saturated atmosphere)

After each polyimide (0.2 g) and tetrahydrofuran (19.8 g) synthesized in the synthesis examples described above were mixed, the mixture was casted on a clean petri dish (10 cmϕ). The mixture was dried at 25° C. for 12 hours and annealed at 90° C. for 7 days to prepare a polyimide single membrane (10 cmϕ, thickness of 20 μm), and the polyimide membrane was taken out from the petri dish. The weight of the obtained polyimide single membrane was measured, and the weight thereof after being exposed to saturated toluene vapor was measured. More specifically, a 100 mL beaker was put into a metallic container which was covered by a toluene solvent and was able to be sealed by a lid, and the container was sealed by a lid and then allowed to stand for 12 hours. Subsequently, the polyimide single membrane was put into the beaker, the container was sealed by a lid and allowed to stand at a temperature of 25° C. for 12 hours, the polyimide single membrane was taken out from the container, and then the weight thereof was measured.

The toluene swelling ratio was calculated according to the following equation.

Toluene swelling ratio (%)=100×{[weight (g) after exposure to toluene]−[weight (g) before exposure to toluene]}/[weight (g) before exposure to toluene]

### [Test Example 2] Evaluation of Gas Separation Performance

The gas separation performance of each gas separation composite membrane prepared in each example and each comparative example was evaluated based on the evaluation results of the gas permeability and the gas separation selectivity carried out in the following manner.

Permeation test samples were prepared by cutting the gas separation composite membranes including the porous support (support layer) such that the diameter of each membrane became 3 cm. These permeation test samples were placed in a SUS316 stainless steel cell (manufactured by DENISSEN Ltd.) having high pressure resistance, and the temperature of the cell was adjusted to 30° C. A mixed gas in which the volume ratio of carbon dioxide (CO₂) to methane (CH₄) was 10:90 was adjusted and supplied into the cell such that the total pressure on the gas supply side became 5 MPa (partial pressure of CO₂: 0.5 MPa) and the flow rate thereof became 130 mL/min. The gas permeabilities of CO₂ and CH₄ were measured using TCD (official name: Thermal Conductivity Detector) detection type gas chromatography. The gas permeabilities of the gas separation composite membranes prepared in each example and each comparative example were compared to each other by calculating gas permeation rates as the gas permeability (Permeance). The unit of the gas permeability (gas permeation rate) was expressed by the unit of GPU [1 GPU=1×10⁻⁶ cm³ (STP)/cm²·sec·cmHg]. The gas separation selectivity was calculated as the ratio (R_{CO2}/R_{CH4}) of the permeation rate R_{CH4} of CH₄ to the permeation rate R_{CO2} of CO₂ of the membrane. The evaluation standard of the gas separation performance is as described below.

[Evaluation Standard of Gas Separation Performance]

AA: The gas permeability (R_{CO2}) was 100 GPU or greater and the gas separation selectivity (R_{CO2}/R_{CH4}) was 20 or greater.

A: The gas permeability (R_{CO2}) was 80 GPU or greater and less than 100 GPU and the gas separation selectivity (R_{CO2}/R_{CH4}) was 20 or greater.

B: The gas permeability (R_{CO2}) was 50 GPU or greater and less than 80 GPU and the gas separation selectivity (R_{CO2}/R_{CH4}) was 20 or greater or the gas permeability (R_{CO2}) was 50 GPU or greater and the gas separation selectivity (R_{CO2}/R_{CH4}) was 15 or greater and less than 20.

C: The gas permeability (R_{CO2}) was less than 50 GPU and the gas separation selectivity (R_{CO2}/R_{CH4}) was 15 or greater or the gas separation selectivity (R_{CO2}/R_{CH4}) was 10 or greater and less than 15.

D: The gas separation selectivity was less than 10 or the test was not able to be carried out because the pressure was not applied.

### [Test Example 3] Evaluation of Gas Separation Performance after Exposure to Toluene

A 100 ml beaker was put into a metallic container which was covered by a toluene solvent and was able to be sealed by a lid, and the container was sealed by a lid and then allowed to stand for 12 hours. Subsequently, the permeation test sample of the gas separation composite membrane prepared in the same manner as in Test Example 2 was put into the beaker, the container was sealed by a lid and allowed to stand under a temperature condition of 25° C. for 10 minutes, and the sample was exposed to toluene. Next, the gas separation performance was evaluated in the same manner as in Test Example 2.

By exposing the sample to toluene, the plasticity resistance of the gas separation membrane with respect to impurities such as benzene, toluene, and xylene can be evaluated.

The results are listed in the following table.

TABLE 2

| | | | | | Gas separation | |
|---|---|---|---|---|---|---|
| | | | Density of | Toluene | performance | Gas separation |
| | Polyimides | Structure | crosslinking | swelling | (before | performance |
| | before | of XL | point | ratio | exposure to | (after exposure |
| | crosslinking | (formula) | (mmol/g) | (%) | toluene) | to toluene) |
| Example 1 | P-101 | (I-b) | 1.3 | 7 | AA | AA |
| Example 2 | P-101 | (I-b) | 0.9 | 12 | A | A |
| Example 3 | P-101 | (I-a) | 0.7 | 22 | A | B |
| Example 4 | P-102 | (I-b) | 1.4 | 27 | A | A |
| Example 5 | P-103 | (I-a) | 3.0 | 7 | A | A |
| Example 6 | P-104 | (I-b) | 1.0 | 22 | A | B |
| Example 7 | P-105 | (I-b) | 0.3 | 36 | A | C |
| Example 8 | P-101 | (I-a) | 0.6 | 27 | A | B |
| Example 9 | P-101 | (I-a) | 0.6 | 25 | A | B |
| Example 10 | P-101 | (I-b) | 0.4 | 37 | A | C |
| Example 11 | P-201 | (I-b) | 2.3 | 8 | AA | AA |
| Example 12 | P-202 | (I-b) | 2.3 | 21 | AA | A |
| Example 13 | P-301 | (I-b) | 0.9 | 16 | A | A |
| Example 14 | P-401 | (I-b) | 0.3 | 26 | A | B |
| Example 15 | P-501 | (I-b) | 0.3 | 27 | A | B |
| Comparative | C-101 | | 0.0 | 40 | C | D |
| Example 1 | | | | | | |
| Comparative | C-101 | | 0.0 | 38 | C | D |
| Example 2 | | | | | | |
| Comparative | C-101 | (I-b) | 0.1 | 28 | C | D |
| Example 3 | | | | | | |
| Comparative | C-201 | (I-a) | 0.1 | 29 | C | D |
| Example 4 | | | | | | |
| Comparative | P-101 | | 0.0 | 35 | B | D |
| Example 5 | | | | | | |
| Comparative | P-101 | | 0.2 | 37 | C | D |
| Example 6 | | | | | | |

As listed in Table 2, the gas separation membrane including the gas separation layer formed of the polyimide compound that did not have a crosslinked structure had degraded gas separation performance, was likely to be swollen due to exposure to toluene, and the gas separation performance thereof after being exposed to toluene was significantly degraded (Comparative Examples 1, 2, and 5).

Further, in a case where the gas separation layer was formed of the polyimide compound having an ethylenically unsaturated bond and the ethylenically unsaturated bond had a styrene structure, the crosslinking reaction rate was low, the gas separation performance was degraded, the gas separation membrane was likely to be swollen due to exposure to toluene, and the gas separation performance after being exposed to toluene was significantly degraded (Comparative Examples 3 and 4).

On the contrary, in the gas separation membrane including the gas separation layer formed of crosslinked polyimide having a structural portion represented by Formula (I) defined in the present invention, both of excellent gas permeability and gas separation selectivity were achieved, the gas separation membrane was unlikely to be swollen even in a case of being exposed to toluene, and the gas separation performance was unlikely to be degraded even in a case of being exposed to toluene (Examples 1 to 15).

Further, as shown from the results listed in Table 2, it was understood that the gas separation performance was excellent, the gas separation membrane was unlikely to be swollen even in a case of being exposed to toluene, and the plasticity resistance was excellent as the density of the crosslinking point of the crosslinked polyimide compound was increased.

Further, in a case where the bridged structure of the crosslinked polyimide compound was the structure represented by Formula (I-b), it was understood that excellent results excellent results for the gas separation performance and the plasticity resistance were likely to be obtained.

Based on the results described above, it was understood that an excellent gas separation method, an excellent gas separation module, and a gas separator provided with this gas separation module can be provided by applying the gas separation membrane of the present invention.

### EXPLANATION OF REFERENCES

1: gas separation layer
2: porous layer
3: non-woven fabric layer
10, 20: gas separation composite membrane

What is claimed is:

1. A gas separation membrane comprising:
a gas separation layer which contains a crosslinked polyimide compound,
wherein the crosslinked polyimide compound has a structural portion represented by Formula (I), 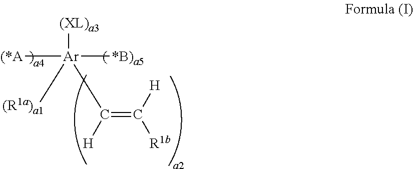
in Formula (I), Ar represents an aromatic ring or a structure formed by two or more aromatic rings being linked through a single bond or a divalent group,
R^{1a} represents a substituent other than —CH═CHR^{1b}, a1 represents an integer of 0 to 20, R^{1b} represents a hydrogen atom or a substituent, a2 represents an integer of 0 to 20, R^{1a} and —CH═CHR^{1b} are directly bonded to a ring-constituting atom of an aromatic ring in Ar,
A and *B represent a linking site for being incorporated in a polyimide chain constituting the crosslinked polyimide compound, a4 represents an integer of 0 to 2, a5 represents 1 or 2, and
XL represents a crosslinked structure that links polyimide chains represented by Formula (I-a) or (I-b) to one another, a3 represents an integer of 1 to 20, and XL is directly bonded to a ring-constituting atom of an aromatic ring in Ar, 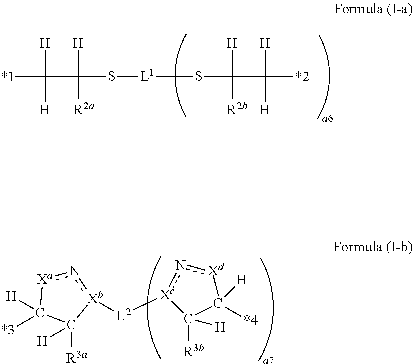
in Formula (I-a), R^{2a} and R^{2b} represent a hydrogen atom, a substituent, or a polyimide residue,
L¹ represents an (a6+1)-valent linking group, a6 represents an integer of 1 or greater, and *1 and *2 represent a site directly bonded to a ring-constituting atom of an aromatic ring in Ar represented by Formula (I), and
in Formula (I-b), R^{3a} and R^{3b} represent a hydrogen atom, a substituent, or a polyimide residue, L² represents an (a7+1)-valent linking group, a7 represents an integer of 1 or greater, X^{a} and X^{d} represent O or N, X^{b} and X^{c} represent N or C, and *3 and *4 represent a site directly bonded to a ring-constituting atom of an aromatic ring in Ar represented by Formula (I).

2. The gas separation membrane according to claim 1,
wherein the polyimide chain constituting the crosslinked polyimide compound has a repeating unit represented by Formula (II), 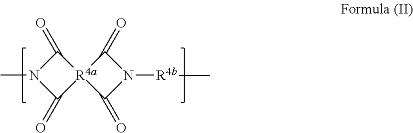
in Formula (II), R^{4a} represents a tetravalent linking group, and R^{4b} represents a divalent linking group, where R^{4a} and/or R^{4b} has a structural portion represented by Formula (I).

3. The gas separation membrane according to claim 2,
wherein both of a4 and a5 in Formula (I) represent 1, and the structural portion represented by Formula (I) is present as R^{4b} in Formula (II).

4. The gas separation membrane according to claim 2,
wherein R^{4a} in Formula (II) is represented by any of Formulae (I-1) to (I-28), 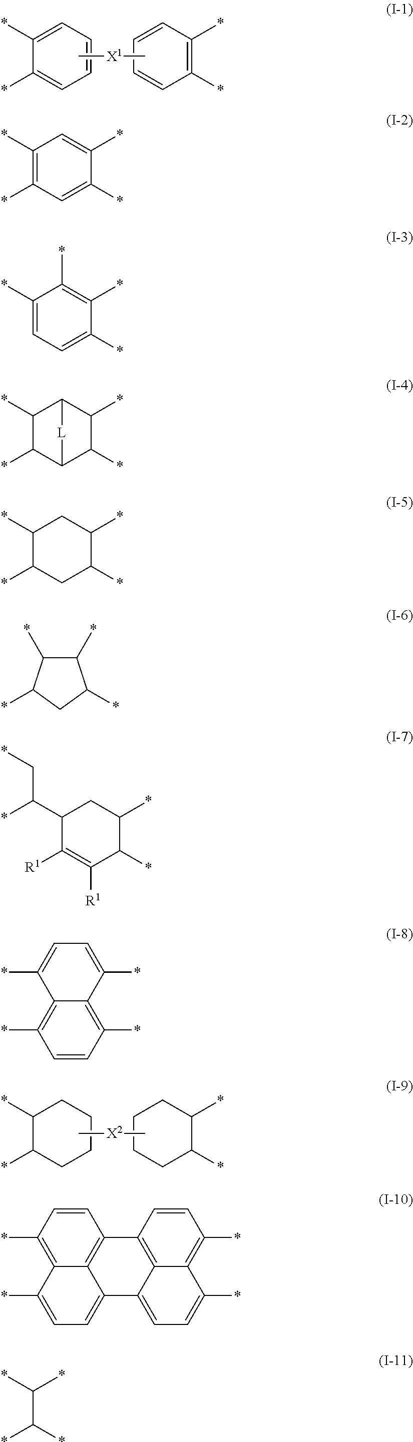 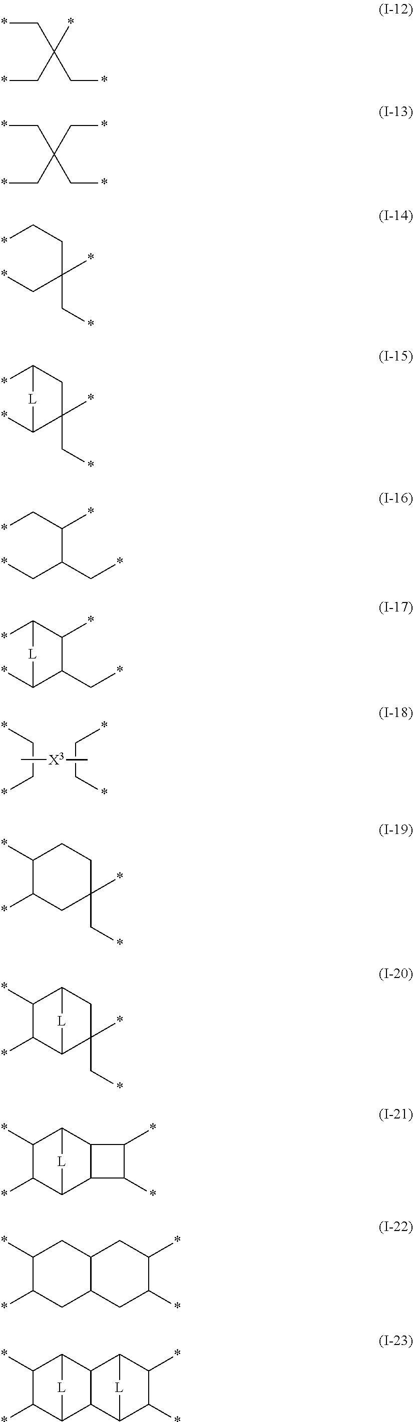 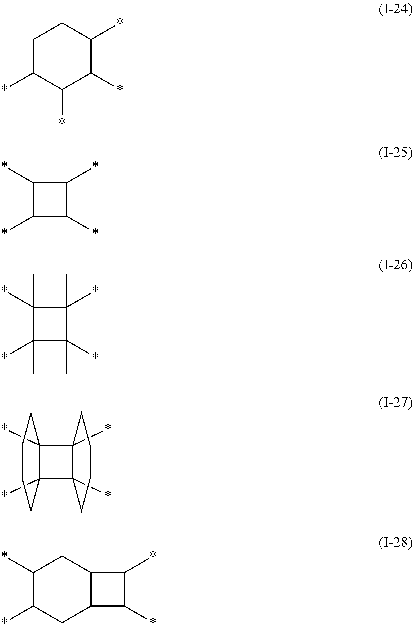
X¹ to X³ represent a single bond or a divalent linking group, L represents —CH═CH— or —CH₂—, R¹ and R² represent a hydrogen atom or a substituent that does not have an ethylenically unsaturated bond, and * represents a bonding site with respect to a carbonyl group in Formula (II).

5. The gas separation membrane according to claim 1,
wherein Ar in Formula (I) represents a benzene ring or a structure formed by two benzene rings being linked through a single bond or a divalent group.

6. The gas separation membrane according to claim 1,
wherein a density of a crosslinking point in the crosslinked polyimide compound is 0.5 mmol/g or greater.

7. The gas separation membrane according to claim 1,
wherein a toluene swelling ratio of the crosslinked polyimide compound is 35% or less.

8. The gas separation membrane according to claim 1,
wherein the gas separation membrane is a gas separation composite membrane which includes a support layer having a gas permeability and the gas separation layer provided on the support layer.

9. The gas separation membrane according to claim 8,
wherein the support layer includes a porous layer and a non-woven fabric layer, and
the gas separation layer, the porous layer, and the non-woven fabric layer are provided in this order.

10. The gas separation membrane according to claim 1,
wherein the gas separation membrane allows carbon dioxide to permeate from gas containing carbon dioxide and methane.

11. A gas separation module comprising:
the gas separation membrane according to claim 1.

12. A gas separator comprising:
the gas separation module according to claim 11.

13. A gas separation method which is performed by using the gas separation membrane according to claim 1.

14. A composition for forming a gas separation layer which is formed by containing (A) and (B) shown below, the composition comprising:
a polyimide compound (A) which has a structural portion represented by Formula (III), 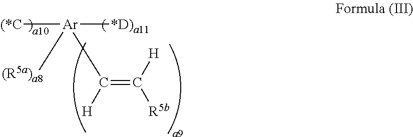
in Formula (III), Ar represents an aromatic ring or a structure formed by two or more aromatic rings being linked through a single bond or a divalent group,
R^{5a} represents a substituent other than —CH═CHR^{5b}, a8 represents an integer of 0 to 20, R^{5b} represents a hydrogen atom, a substituent, or a linking site for being incorporated in a polyimide compound, a9 represents an integer of 1 to 20, R^{5a} and —CH═CHR^{5b} are directly bonded to a ring-constituting atom of an aromatic ring in Ar,
C and *D represent a linking site for being incorporated in a polyimide compound, a10 represents an integer of 0 to 2, and a11=represents 1 or 2; and
a crosslinking agent (B) which contains two or more groups selected from a mercapto group, a nitrile N oxide group, and an azide group, in a molecule.

15. The composition for forming a gas separation layer according to claim 14,
wherein the polyimide compound has a repeating unit represented by Formula (IV), 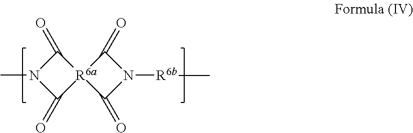
in Formula (IV), R^{6a} represents a tetravalent linking group, and R^{6b} represents a divalent linking group, where R^{6a} and/or R^{6b} has a structural portion represented by Formula (III).

16. The composition for forming a gas separation layer according to claim 15,
wherein both of a10 and a11 in Formula (III) represent 1, R^{5b} represents a hydrogen atom or a substituent, and the structural portion represented by Formula (III) is present as R^{6b} in Formula (IV).

17. The composition for forming a gas separation layer according to claim 15,
wherein R^{6a} in formula (IV) is represented by any of Formulae (I-1) to (I-28), 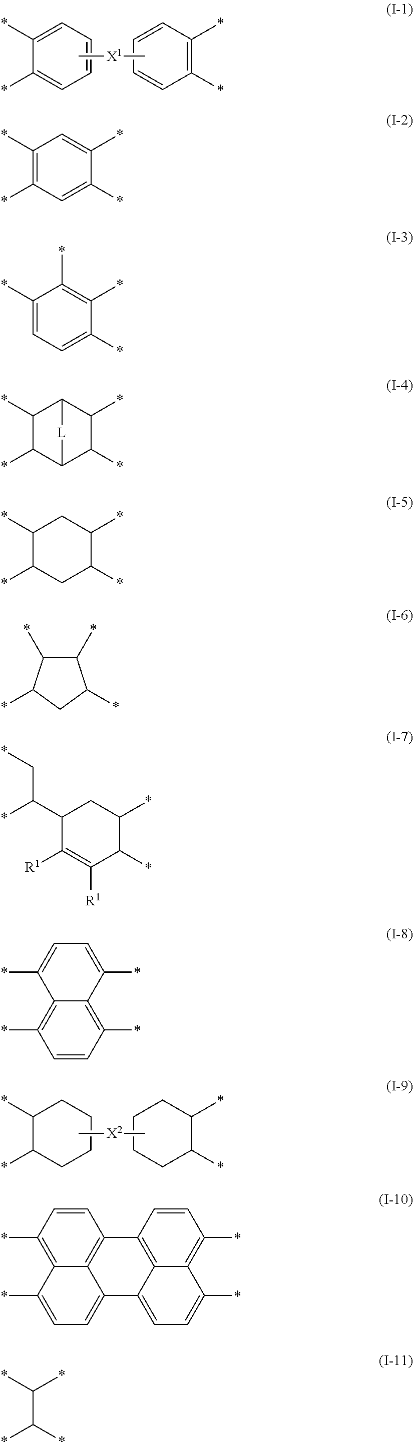 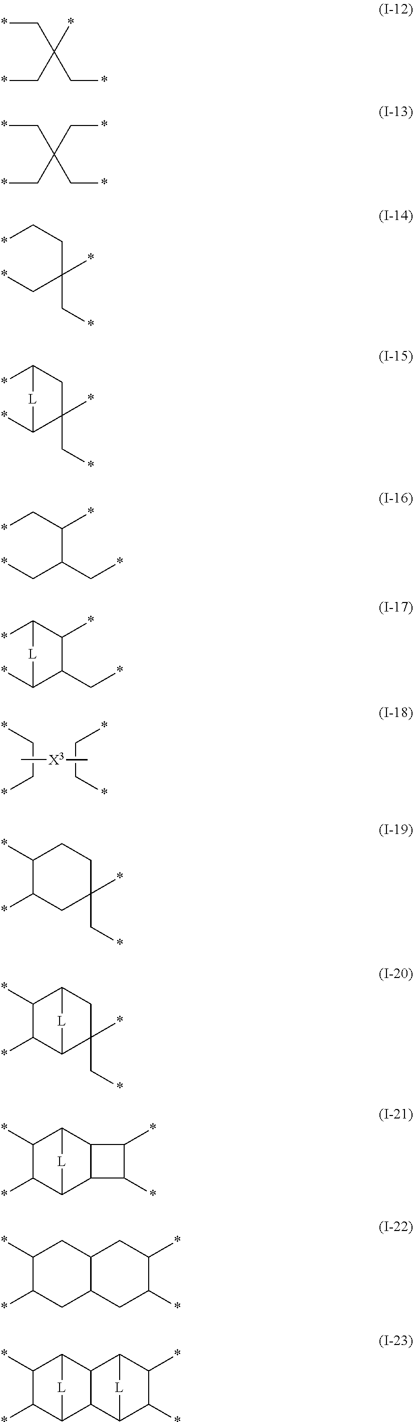 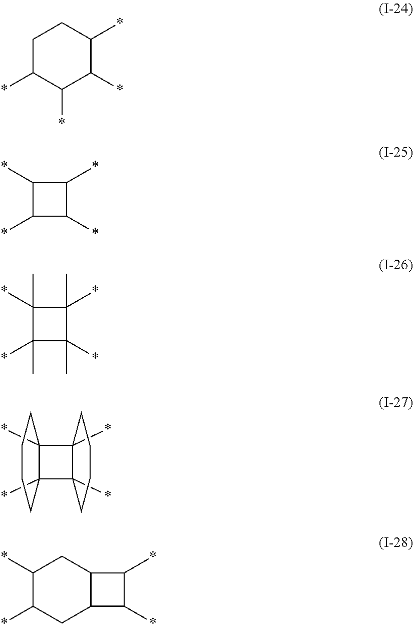
X¹ to X³ represent a single bond or a divalent linking group, L represents —CH═CH— or —CH₂—, R¹ and R² represent a hydrogen atom or a substituent that does not have an ethylenically unsaturated bond, and the * represents a bonding site with respect to a carbonyl group in Formula (IV).

18. The composition for forming a gas separation layer according to claim 14,
wherein the crosslinking agent is at least one compound represented by Formulae (V) to (VII), 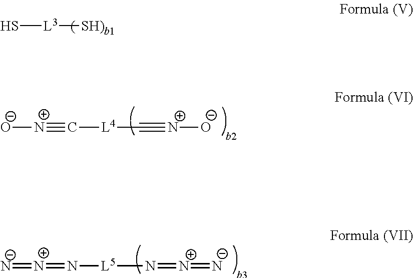
in Formulae (V) to (VII), L³ represents a (b1+1)-valent linking group, L⁴ represents a (b2+1)-valent linking group, L⁵ represents a (b3+1)-valent linking group, and b1 to b3 represent an integer of 1 or greater.

19. A method of producing a gas separation membrane comprising:
applying the composition for forming a gas separation layer according to claim 14 to form a membrane; and
performing a heat treatment, irradiation with ultraviolet rays, a plasma treatment, an ozone treatment, or a corona treatment on the composition for forming a gas separation layer which has been applied to the coated membrane to form a crosslinked structure.

20. A polyimide compound comprising:
a repeating unit represented by Formula (VIII), 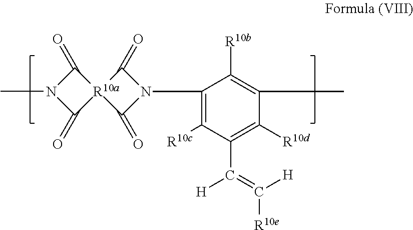
in Formula (VIII), R^{10b}, R^{10c}, and R^{10d} represent a substituent other than —CH═CHR^{10e}, R^{10e} represents a hydrogen atom or a substituent, and
R^{10a} represents a tetravalent group represented by any of Formulae (I-1) to (I-28). 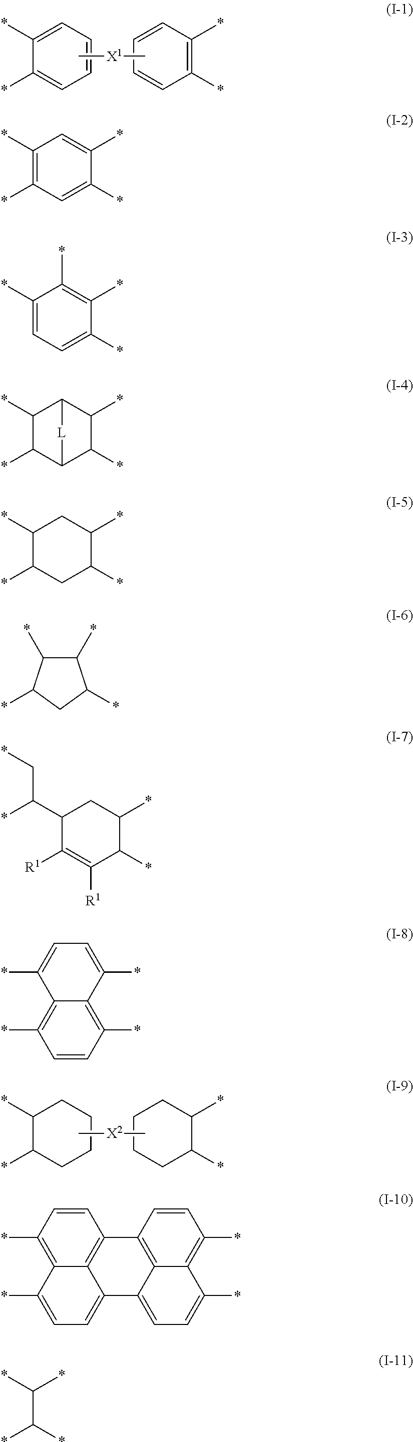 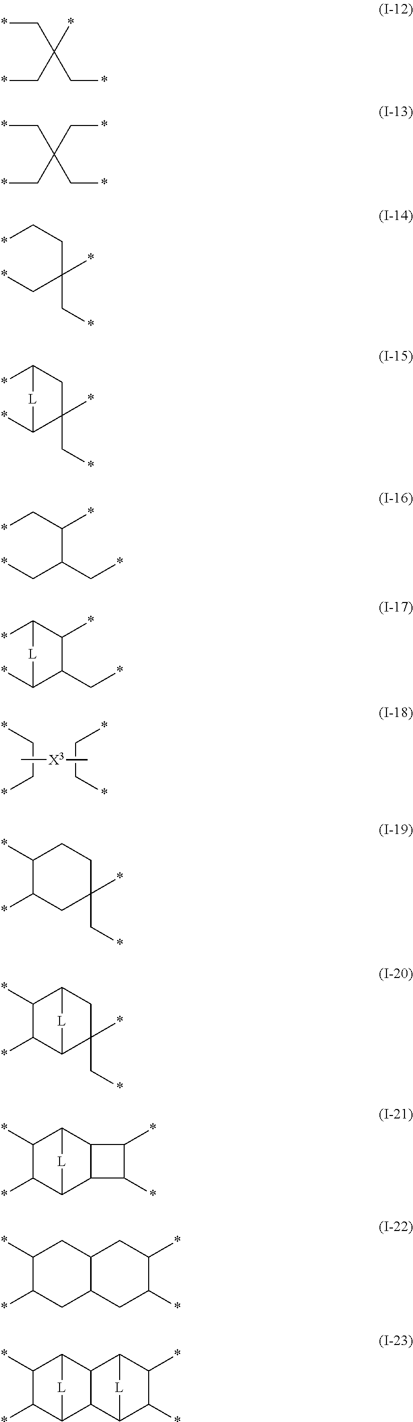 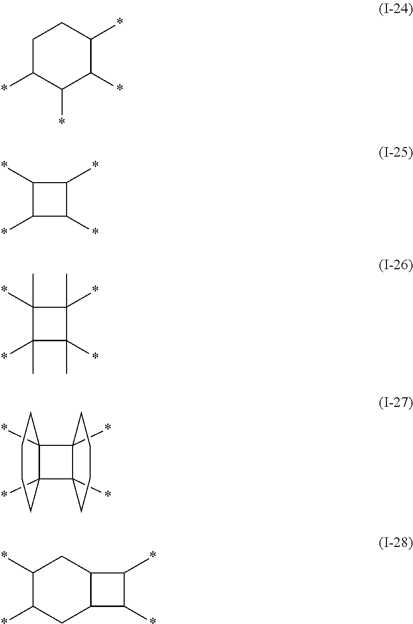
X¹ to X³ represent a single bond or a divalent linking group, L represents —CH═CH— or —CH₂—, R¹ and R² represent a hydrogen atom or a substituent that does not have an ethylenically unsaturated bond, and * represents a bonding site with respect to a carbonyl group in Formula (VIII).
